(19) United States
(12) Patent Application Publication
(10) Pub. No.: US 2011/0109591 A1
(43) Pub. Date: May 12, 2011

(54) TOUCH PANEL AND DRIVING METHOD OF TOUCH PANEL

(75) Inventors: Yoshiyuki KUROKAWA, Sagamihara (JP); Takayuki IKEDA, Atsugi (JP); Hikaru TAMURA, Zama (JP); Shunpei YAMAZAKI, Tokyo (JP)

(73) Assignee: SEMICONDUCTOR ENERGY LABORATORY CO., LTD., Atsugi-shi (JP)

(21) Appl. No.: 12/914,626

(22) Filed: Oct. 28, 2010

(30) Foreign Application Priority Data
Nov. 6, 2009 (JP) 2009-255461

(51) Int. Cl. G06F 3/042

(52) U.S. Cl. 345/175

(57) ABSTRACT

Disclosed is a touch panel including a plurality of pixels each including a display element and a photosensor. The display element includes a transistor having an oxide semiconductor layer. The photosensor includes a photodiode, a first transistor, and a second transistor, and the first and second transistors include an oxide semiconductor layer. A driving method of the touch panel is also disclosed by which high-speed imaging is realized.

### TECHNICAL FIELD

The present invention relates to a touch panel including a photosensor and a driving method thereof. In particular, the present invention relates to a touch panel including a plurality of pixels each of which is provided with a photosensor and relates to a driving method thereof. Further, the present invention relates to electronic devices including the touch panel.

### BACKGROUND ART

In recent years, a display device provided with a touch sensor has attracted attention. The display device provided with the touch sensor is called a touch panel, a touch screen, and the like (hereinafter simply referred to as a “touch panel”). Examples of the touch sensor include a resistive touch sensor, a capacitance touch sensor, and an optical touch sensor, depending on its operation principle. In any of the sensors, when an object to be detected is in contact with a display device or in the vicinity of the display device, data can be inputted.

By providing a sensor (also referred to as a “photosensor”) that detects light as an optical touch sensor to a display portion, for example, a touch panel in which display portion serves as an input region is fabricated. As an example of a device including such an optical touch sensor, a display device having an image capturing function as a contact type area sensor that captures an image, is given (e.g., see Patent Document 1). In the case of a touch panel including an optical touch sensor, light is emitted from the touch panel, and part of the light is reflected by an object to be detected. A photosensor (also referred to as a “photoelectric conversion element”) which can detect light is provided in a pixel of the touch panel, and the photosensor detects the reflected light, so that the existence of the object to be detected in the region where light is detected can be recognized.

It has been investigated to provide a touch panel to an electronic device such as a mobile phone or a portable information terminal to add a personal authentication function thereto (e.g., see Patent Document 2). A fingerprint, a face, a handprint, a palm print, a pattern of a hand vein, and the like are used for personal authentication. In the case where a portion different from the display portion has a personal authentication function, the number of components increases, and the weight or price of the electronic device could possibly increase.

In touch sensor systems, a technique for selecting an image processing method by which the position of a finger-tip is detected in accordance with brightness of external light has been known (e.g., see Patent Document 3).

### REFERENCE

### Patent Document

[Patent Document 1] Japanese Published Patent Application No. 2001-292276
[Patent Document 2] Japanese Published Patent Application No. 2002-033823
[Patent Document 3] Japanese Published Patent Application No. 2007-183706

### DISCLOSURE OF INVENTION

When a touch panel is used for an electronic device having a personal authentication function or the like, electrical signals which are generated by photosensors provided in respective pixels of the touch panel by detecting light are collected and image processing is performed. Therefore, a circuit including a transistor is provided for the touch panel.

When a transistor including single crystal silicon is used, the size of an area sensor is limited by the size of a single crystal silicon substrate. In other words, formation of a large area sensor or a large area sensor also serving as a display device using a single crystal silicon substrate is costly and impractical.

On the other hand, the size of a substrate can be easily increased when a thin film transistor (TFT) including amorphous silicon is employed. However, field-effect mobility of an amorphous silicon thin film is low; thus, there is a limit on a circuit design; therefore, an area occupied by a circuit is increased.

Polycrystalline silicon has greater field-effect mobility than amorphous silicon. However, the thin film transistors including polycrystalline silicon are formed in many cases by employing a crystallization method using excimer laser annealing and therefore vary in their characteristics because of excimer laser annealing. Therefore, it is difficult to convert intensity distribution of detected light into electrical signals with high reproducibility with a photosensor using circuits including thin film transistors which vary in their characteristics.

An object of an embodiment of the present invention is to provide a touch panel including a photosensor which can be mass-produced over a large substrate and has uniform and stable electric characteristics.

Another object of an embodiment of the present invention is to provide a highly functional touch panel capable of high-speed response.

Further, another object of an embodiment of the present invention is to provide a touch panel in which a frame frequency of imaging can be improved by controlling reset operation and readout operation of a photosensor independently.

A touch panel including a photosensor or a display device provided with a touch sensor is provided with a circuit having a transistor formed using an oxide semiconductor layer.

However, a difference from the stoichiometric composition in the oxide semiconductor arises in a thin film formation process thereof. For example, electric conductivity of the oxide semiconductor changes after the film formation due to the excess or deficiency of oxygen. Further, hydrogen or moisture that enters the oxide semiconductor thin film during the formation of the thin film forms an oxygen (O)-hydrogen (H) bond and serves as an electron donor, which is a factor of changing electric conductivity. Furthermore, since the O—H bond has a polarity, it serves as a factor of varying the characteristics of an active device such as a thin film transistor manufactured using an oxide semiconductor.

In order to prevent variation in electric characteristics of the thin film transistor formed using an oxide semiconductor layer, which is disclosed in this specification, impurities such as hydrogen, moisture, a hydroxyl group, or a hydride (also referred to as a hydrogen compound) which cause the variation are intentionally removed from the oxide semiconductor layer. Additionally, the oxide semiconductor layer is highly purified to become i-type (intrinsic) by supplying oxygen which is a major component of the oxide semiconductor layer and is simultaneously reduced in a step of removing impurities.

Therefore, it is preferable that the oxide semiconductor contains hydrogen and carriers as little as possible. In the thin film transistor disclosed in this specification, a channel formation region is formed in the oxide semiconductor layer, in which hydrogen contained in the oxide semiconductor is set less than or equal to 5×10¹⁹/cm³, preferably, less than or equal to 5×10¹⁸/cm³, more preferably, less than or equal to 5×10¹⁷/cm³ or less than 5×10¹⁶/cm³; hydrogen contained in the oxide semiconductor is removed as much as possible to be close to 0; and the carrier concentration is less than 5×10¹⁴/cm³, preferably, less than or equal to 5×10¹²/cm³.

It is preferable that an off-state current be as small as possible in reverse characteristics of a thin film transistor. An off-state current (also referred to as a leakage current) is a current that flows between a source and a drain of a thin film transistor in the case where a gate voltage between −1 V to −10 V is applied. A current value per 1 μm in a channel width (w) of a thin film transistor formed using the oxide semiconductor, which is disclosed in this specification, is less than or equal to 100 aA/μm, preferably, less than or equal to 10 aA/μm, more preferably, less than or equal to 1 aA/μm. Further, since there is no pn junction and no hot carrier degradation, electric characteristics of the thin film transistor is not adversely affected.

The concentration of hydrogen can be estimated by secondary ion mass spectrometry (SIMS) or on the basis of data of SIMS. The carrier concentration can be measured by Hall effect measurement. As an example of an equipment used for Hall effect measurement, the specific resistance/hole measuring system ResiTest 8310 (manufactured by TOYO Corporation) can be given. With the specific resistance/hole measuring system ResiTest 8310, the direction and strength of a magnetic field are changed in a certain cycle and in synchronization therewith, only a Hall electromotive voltage caused in a sample is detected, so that AC (alternate current) Hall measurement can be performed. Even in the case of a material with low field-effect mobility and high resistivity, a Hall electromotive voltage can be detected.

As the oxide semiconductor layer used in this specification, any of a four-component metal oxide such as an In—Sn—Ga—Zn—O film, a three-component metal oxide such as an In—Ga—Zn—O film, an In—Sn—Zn—O film, an In—Al—Zn—O film, a Sn—Ga—Zn—O film, an Al—Ga—Zn—O film, and a Sn—Al—Zn—O film, or a two-component metal oxide such as an In—Zn—O film, a Sn—Zn—O film, an Al—Zn—O film, a Zn—Mg—O film, a Sn—Mg—O film, an In—Mg—O film, an In—O film, a Sn—O film, and a Zn—O film can be used. Further, SiO₂ may be contained in the above oxide semiconductor layer.

Note that as the oxide semiconductor layer, a thin film expressed by InMO₃(ZnO)ₘ (m>0) can be used. Here, M represents one or more metal elements selected from Ga, Al, Mn, and Co. For example, M can be Ga, Ga and Al, Ga and Mn, Ga and Co, or the like. An oxide semiconductor layer whose composition formula is represented by InMO₃ (ZnO)ₘ (m>0), which includes Ga as M, is referred to as the In—Ga—Zn—O oxide semiconductor described above, and a thin film of the In—Ga—Zn—O oxide semiconductor is also referred to as an In—Ga—Zn—O-based non-single-crystal film.

A touch panel according to an embodiment of the present invention includes a plurality of pixels each including a display element and a photosensor, and a control circuit which can control a reset operation and a readout operation of the photosensor independently. The control circuit performs the reset operation and the readout operation of the photosensor so that both of the operations do not overlap with each other. Note that a thin film transistor including an oxide semiconductor layer is used for the photosensor.

One embodiment of the present invention is a touch panel including a plurality of pixels each including a display element and a photosensor, and a control circuit which can control a reset operation and a readout operation of the photosensor independently. The photosensor includes a photodiode and a transistor including an oxide semiconductor layer. The control circuit performs the reset operation and the readout operation of the photosensor so that both of the operations are not performed simultaneously.

Another embodiment of the present invention is a touch panel including a plurality of pixels each including a display element and a photosensor, and a control circuit which can control a reset operation and a readout operation of the photosensor independently. The photosensor includes a photodiode including an amorphous semiconductor layer and a transistor including an oxide semiconductor layer. The control circuit performs the reset operation and the readout operation of the photosensor so that both of the operations do not overlap with each other.

In the above structures, the oxide semiconductor layer of the thin film transistor can contain indium, gallium, or zinc.

Another embodiment of the present invention is a method for driving a touch panel comprising a plurality of pixels which each include a photosensor including a photodiode, a first transistor including an oxide semiconductor layer, and a second transistor including an oxide semiconductor layer. Each of the plurality of pixels performs the following operations: a first operation for setting a potential of an output signal line of the photosensor, which is electrically connected to one of a source and a drain of the second transistor, to a reference potential; a second operation for changing a potential of a gate of the first transistor by a photocurrent of the photodiode; and a third operation for changing the potential of the output signal line of the photosensor in accordance with the photocurrent by changing a potential of a gate of the second transistor so that the output signal line of the photosensor and a reference signal line of the photosensor, which is electrically connected to one of a source and a drain of the first transistor, are electrically connected to each other through the first transistor and the second transistor.

Another embodiment of the present invention is a method for driving a touch panel comprising a plurality of pixels which each include a photosensor including a photodiode, a first transistor, and a second transistor. Each of the plurality of pixels performs the following operations: a first operation for setting a potential of an output signal line of the photosensor, which is electrically connected to one of a source and a drain of the first transistor, to a reference potential; a second operation for changing a potential of a gate of the first transistor by a photocurrent of the photodiode; and a third operation for changing the potential of the output signal line of the photosensor in accordance with the photocurrent by changing a potential of a gate of the second transistor so that the output signal line of the photosensor and a reference signal line of the photosensor, which is electrically connected to one of a source and a drain of the second transistor, are electrically connected to each other through the first transistor and the second transistor.

In the above methods for driving a touch panel according to embodiments of the present invention, simultaneously with the first operation in one of the plurality of pixels, the third operation in another one of the plurality of pixels is performed.

In the above methods for driving a touch panel according to embodiments of the present invention, between the first operation in one of the plurality of pixels and the first operation in a pixel adjacent to the pixel in the row direction, the third operation in another one of the plurality of pixels is performed.

In the above methods for driving a touch panel according to embodiments of the present invention, between the third operation in one of the plurality of pixels and the third operation in a pixel adjacent to the pixel in the row direction, the first operation in another one of the plurality of pixels is performed.

With an embodiment of the present invention, it is possible to provide a touch panel capable of high-speed imaging.

In addition, with an embodiment of the present invention, it is possible to provide a method for driving a touch panel capable of high-speed imaging with an operation time of a photosensor secured.

Further, with an embodiment of the present invention, it is possible to provide a method for driving a touch panel capable of high-speed imaging with stable operation of a photosensor.

Furthermore, according to an embodiment of the present invention, it is possible to provide a highly functional touch panel capable of high-speed response with a thin film transistor formed using an oxide semiconductor layer.

### BRIEF DESCRIPTION OF DRAWINGS

In the accompanying drawings:

FIG. 1 illustrates an example of a structure of a touch panel;

FIG. 2 illustrates an example of a circuit diagram of a pixel;

FIG. 3 illustrates an example of a structure of a photosensor readout circuit;

FIG. 4 is a timing chart of an example of readout operation of a photosensor;

FIG. 5 illustrates an example of a cross section of a touch panel;

FIG. 6 illustrates an example of a cross section of a touch panel;

FIG. 7 is a timing chart of an example of operation of a touch panel;

FIG. 8 illustrates a perspective view of an example of a structure of a liquid crystal display device including a touch panel;

FIGS. 9A to 9D each illustrate an example of an electronic device to which a touch panel is applied;

FIG. 10 is a timing chart of an example of operation of a touch panel;

FIG. 11 is a timing chart of an example of operation of a touch panel;

FIGS. 12A to 12E illustrate a thin film transistor and a method for manufacturing the thin film transistor;

FIGS. 13A to 13E illustrate a thin film transistor and a method for manufacturing the thin film transistor;

FIGS. 14A to 14D illustrate a thin film transistor and a method for manufacturing the thin film transistor;

FIGS. 15A to 15D illustrate a thin film transistor and a method for manufacturing the thin film transistor;

FIG. 16 illustrates a thin film transistor;

FIG. 17 illustrates a thin film transistor;

FIG. 18 is a longitudinal cross-sectional view of an inverted staggered thin film transistor formed using an oxide semiconductor;

FIG. 19A is an energy band diagram (schematic diagram) of a cross section along A-A′ in FIG. 18, and FIG. 19B is an energy band diagram at the time when a voltage is applied;

FIG. 20A is an energy band diagram illustrating a state in which positive potential (+VG) is applied to a gate (G1), and FIG. 20B is an energy band diagram illustrating a state in which negative potential (−VG) is applied to a gate (G1);

FIG. 21 is an energy band diagram illustrating relationships between a vacuum level and a work function of a metal (φM) and between the vacuum level and electron affinity (χ) of an oxide semiconductor; and

FIG. 22 is a graph showing a relationship between field-effect mobility of a transistor and a frequency of imaging, which is obtained by calculation.

### BEST MODE FOR CARRYING OUT THE INVENTION

Hereinafter, embodiments will be described in detail with reference to the accompanying drawings. However, since embodiments described below can be embodied in many different modes, it is easily understood by those skilled in the art that the mode and the detail can be variously changed without departing from the scope of the present invention. Therefore, the disclosed invention should not be interpreted as being limited to the following description of the embodiments. In the drawings for describing the embodiments, the same parts or parts having a similar function are denoted by the same reference numerals, and description of such parts is not repeated.

### Embodiment 1

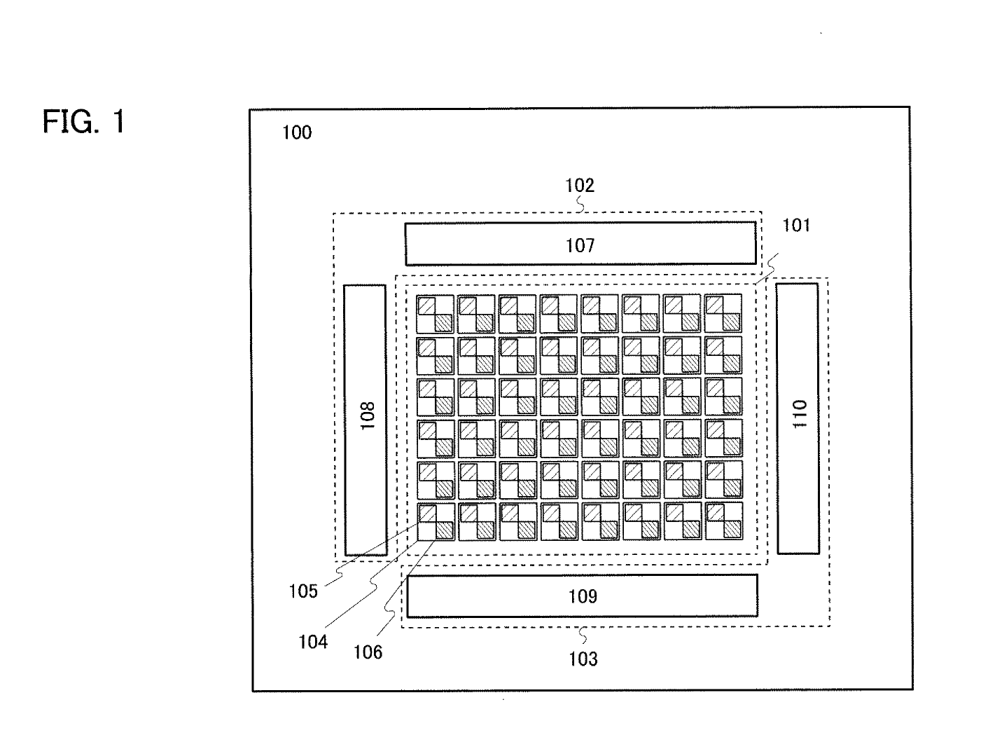

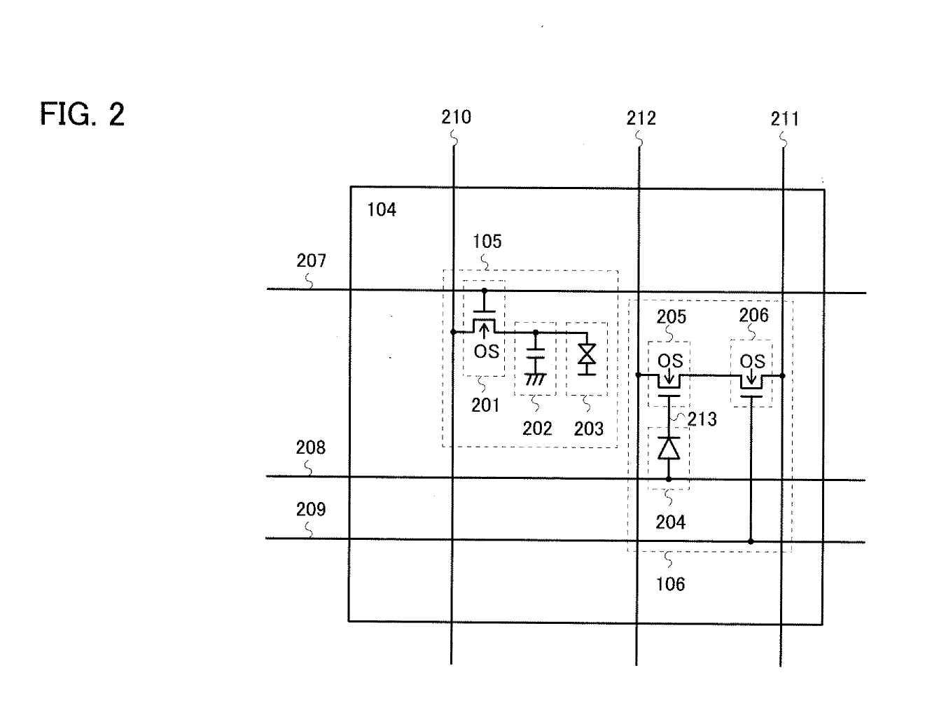

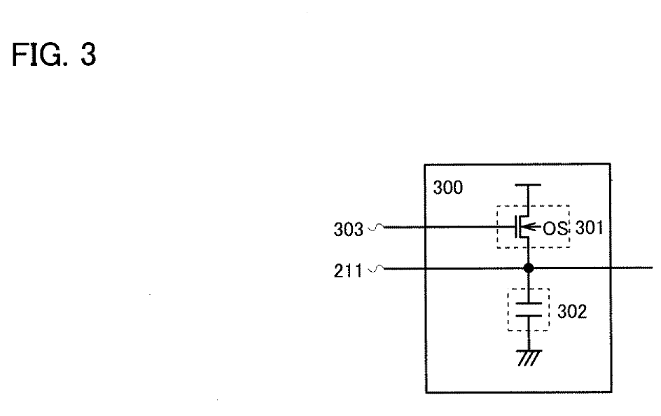

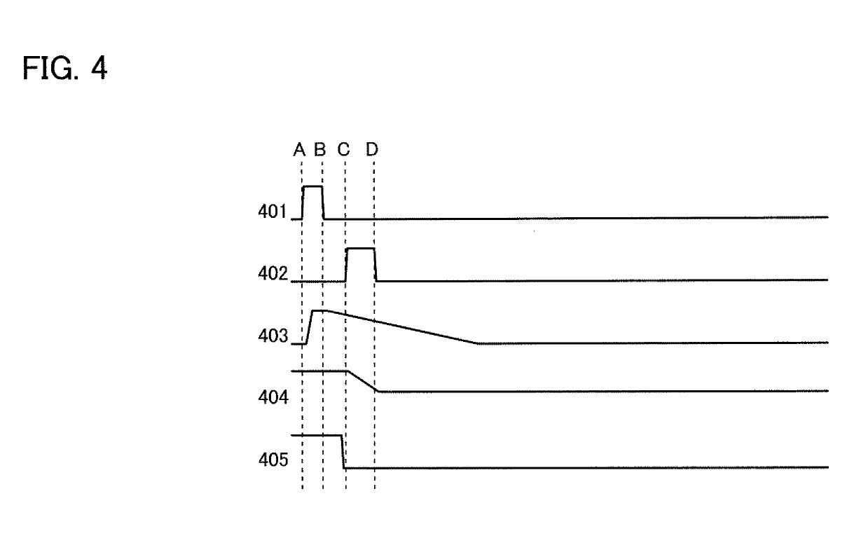

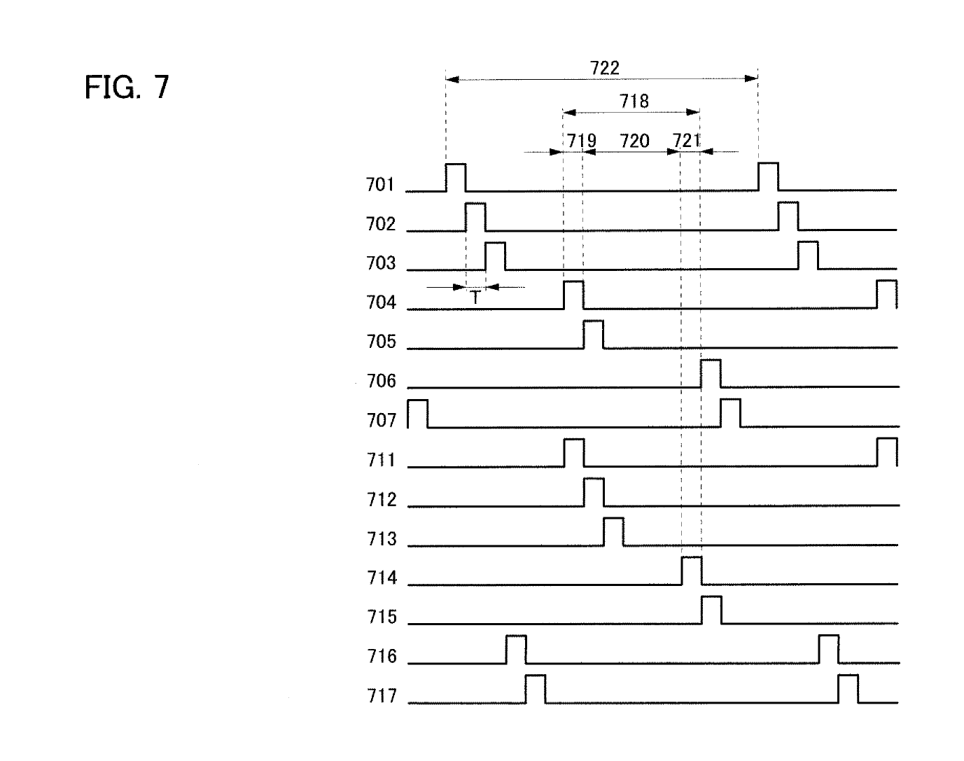

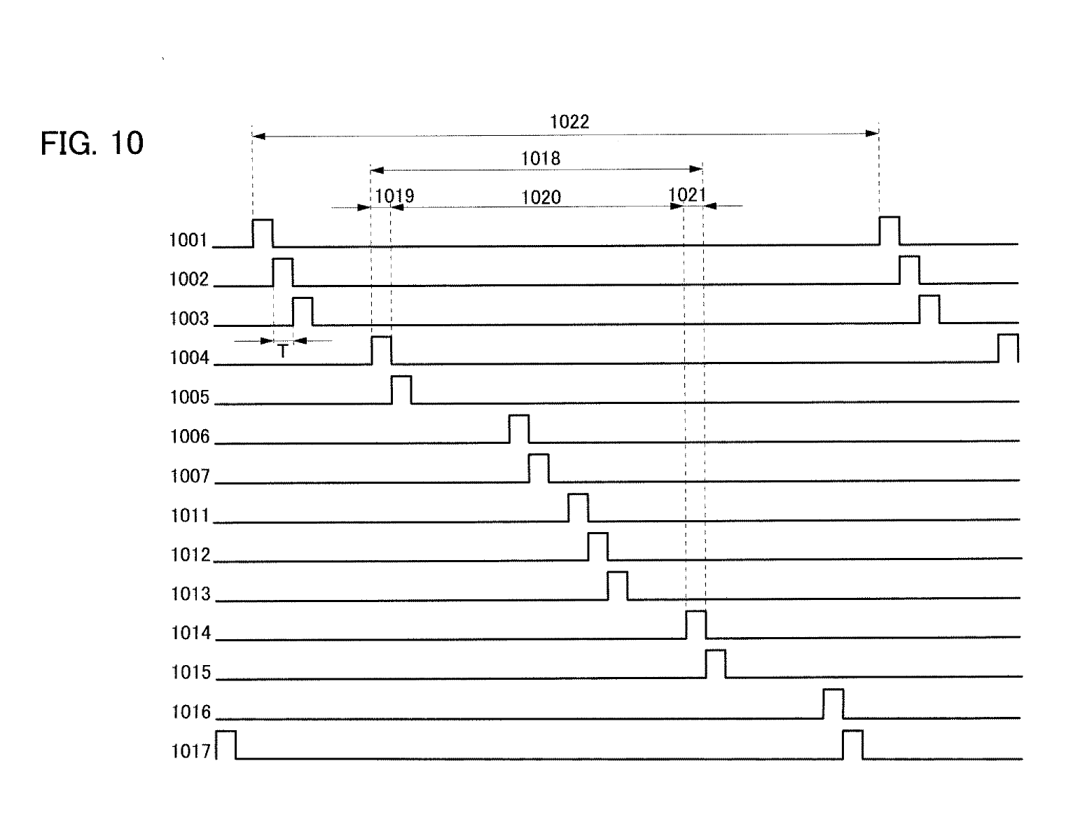

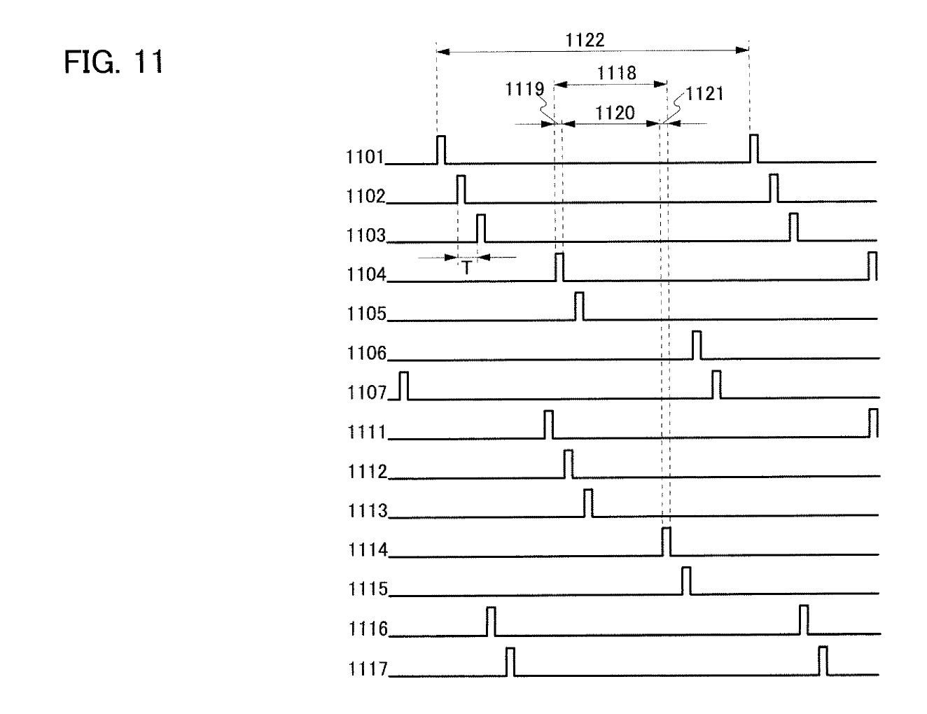

In this embodiment, a structure of a touch panel according to an embodiment of the present invention and a driving method thereof will be described with reference to FIG. 1, FIG. 2, FIG. 3, FIG. 4, FIG. 7, FIG. 10, and FIG. 11.

An example of the structure of the touch panel is described with reference to FIG. 1. A touch panel 100 includes a pixel circuit 101, a display element control circuit 102, and a photosensor control circuit 103. The pixel circuit 101 includes a plurality of pixels 104 arranged in a matrix of rows and columns. Each of the pixels 104 includes a display element 105 and a photosensor 106.

Each of the display elements 105 includes a thin film transistor (TFT), a storage capacitor, a liquid crystal element including a liquid crystal layer, and the like. The thin film transistor has a function of controlling injection or ejection of charge to/from the storage capacitor. The storage capacitor has a function of holding charge which corresponds to voltage applied to the liquid crystal layer. Taking advantage of the change in the direction of a polarization due to a voltage application to the liquid crystal layer, tone of light passing through the liquid crystal layer is made (gray scale display is performed), so that image display is realized. Light which is emitted form a light source (a backlight) located on the rear side of a liquid crystal display device is used as the light passing through the liquid crystal layer.

Note that methods of displaying color images include a method in which a color filter is used, that is, a color filter method. This method makes it possible to perform the gray scale display of a particular color (e.g., red (R), green (G), or blue (B)) when light that has passed through the liquid crystal layer passes through a color filter. Here, when the color filter method is employed, the pixel 104 that has the function of emitting red (R) light, the pixel 104 that has the function of emitting green (G) light, and the pixel 104 that has the function of emitting blue (B) light are called an R pixel, a G pixel, and a B pixel, respectively.

Methods of displaying color images also include a method in which respective light sources of particular colors (e.g., red (R), green (G), and blue (B)) are used as a backlight, and are sequentially lit, that is, a field-sequential method. In the field-sequential method, the gray scale display of each of the colors can be performed by making the tone of light passing through the liquid crystal layer while the light source thereof is turned on.

Note that the case where the display elements 105 include liquid crystal elements is described; however, other elements such as light-emitting elements may be included. The light-emitting element is an element in which the luminance is controlled by current or voltage. Specifically, a light emitting diode, an EL element (organic EL element (organic light emitting diode (OLED)) or an inorganic EL element), and the like are given.

The photosensors 106 each include an element such as a photodiode, which has a function of generating an electrical signal when receiving light, and a thin film transistor. Note that as light which is received by the photosensors 106, reflected light obtained when light from a backlight is delivered to an object to be detected is used.

The display element control circuit 102 controls the display elements 105 and includes a display element driver circuit 107 and a display element driver circuit 108. The display element driver circuit 107 inputs a signal to the display elements 105 through signal lines (also referred to as “source signal lines”) such as video data signal lines. The display element driver circuit 108 inputs a signal to the display elements 105 through scan lines (also referred to as “gate signal lines”). For example, the display element driver circuit 108 for driving the scan lines has a function of selecting display elements 105 included in the pixels placed in a particular row. Further, the display element driver circuit 107 for driving the signal lines has a function of giving a predetermined potential to the display elements 105 included in the pixels placed in the selected row. Note that in the display elements to which the display element driver circuit 108 for driving the scan lines gives a high potential, the thin film transistors are brought into conduction and charges given by the display element driver circuit 107 for driving the signal lines are supplied to the display elements.

The photosensor control circuit 103 controls the photosensor 106 and includes a photosensor readout circuit 109 connected to a photosensor output signal line and a photosensor reference signal line, and a photosensor driver circuit 110. The photosensor driver circuit 110 has a function of performing reset operation and selecting operation on the photosensors 106 included in the pixels placed in a particular row, which are described below. The photosensor readout circuit 109 has a function of taking out output signals of the photosensors 106 included in the pixels in the selected row. Note that the photosensor readout circuit 109 may have a system in which an output, which is an analog signal, of the photosensor is extracted as an analog signal to the outside of the touch panel by an OP amplifier; or a system in which the output is converted into a digital signal by an A/D converter circuit and then extracted to the outside of the touch panel.

The touch panel 100 including a photosensor is provided with a circuit having a transistor formed using an oxide semiconductor layer.

In order to prevent variation in electric characteristics of the thin film transistor formed using an oxide semiconductor layer, which is included in the touch panel 100 including a photosensor, impurities such as hydrogen, moisture, a hydroxyl group, or a hydride (also referred to as a hydrogen compound) which cause the variation are intentionally removed from the oxide semiconductor layer. Additionally, the oxide semiconductor layer is highly purified to become i-type (intrinsic) by supplying oxygen which is a major component of the oxide semiconductor layer, which is simultaneously reduced in a step of removing impurities.

Therefore, it is preferable that the oxide semiconductor contains hydrogen and carriers as little as possible. In the thin film transistor disclosed in this specification, a channel formation region is formed in the oxide semiconductor layer, in which hydrogen contained in the oxide semiconductor is set less than or equal to 5×10¹⁹/cm³, preferably, less than or equal to 5×10¹⁸/cm³, more preferably, less than or equal to 5×10¹⁷/cm³ or less than 5×10¹⁶/cm³; hydrogen contained in the oxide semiconductor is removed as much as possible to be close to 0; and the carrier concentration is less than 5×10¹⁴/cm³, preferably, less than or equal to 5×10¹²/cm³.

It is preferable that an off-state current be as small as possible in reverse characteristics of a thin film transistor. An off-state current is a current that flows between a source and a drain of a thin film transistor in the case where a gate voltage between −1 V to −10 V is applied. A current value per 1 μm in a channel width (w) of a thin film transistor formed using the oxide semiconductor, which is disclosed in this specification, is less than or equal to 100 aA/μm, preferably, less than or equal to 10 aA/μm, more preferably, less than or equal to 1 aA/μm. Further, since there is no pn junction and no hot carrier degradation, electric characteristics of the thin film transistor is not adversely affected.

An example of a circuit diagram of the pixel 104 is described with reference to FIG. 2. The pixel 104 includes the display element 105 including a transistor 201, a storage capacitor 202, and a liquid crystal element 203; and the photosensor 106 including a photodiode 204, a transistor 205, and a transistor 206. In FIG. 2, the transistor 201, the transistor 205, and the transistor 206 are each a thin film transistor formed using an oxide semiconductor layer.

A gate of the transistor 201 is electrically connected to a gate signal line 207, one of a source and a drain of the transistor 201 is electrically connected to a video data signal line 210, and the other of the source and the drain of the transistor 201 is electrically connected to one electrode of the storage capacitor 202 and one electrode of the liquid crystal element 203. The other electrode of the storage capacitor 202 and the other electrode of the liquid crystal element 203 are each held at a certain potential. The liquid crystal element 203 is an element including a pair of electrodes and a liquid crystal layer interposed between the pair of electrodes.

When a potential at a high level “H” is applied to the gate signal line 207, the transistor 201 applies the potential of the video data signal line 210 to the storage capacitor 202 and the liquid crystal element 203. The storage capacitor 202 holds the applied potential. The liquid crystal element 203 changes light transmittance in accordance with the applied potential.

Since the off-state currents of the transistors 201, 205, and 206 which are each a thin film transistor formed using an oxide semiconductor layer are extremely small, a storage capacitor can be extremely small or is not necessarily provided.

One electrode of the photodiode 204 is electrically connected to a photodiode reset signal line 208, and the other electrode of the photodiode 204 is electrically connected to a gate of the transistor 205 through a gate signal line 213. One of a source and a drain of the transistor 205 is electrically connected to a photosensor reference signal line 212, and the other of the source and the drain of the transistor 205 is electrically connected to one of a source and a drain of the transistor 206. A gate of the transistor 206 is electrically connected to a gate signal line 209, and the other of the source and the drain of the transistor 206 is electrically connected to a photosensor output signal line 211.

Note that the arrangement of the transistor 205 and the transistor 206 is not limited to the configuration in FIG. 2. It is acceptable to employ the following configuration: one of the source and the drain of the transistor 206 is electrically connected to the photosensor reference signal line 212, the other of the source and the drain of the transistor 206 is electrically connected to one of the source and the drain of the transistor 205, and the gate of the transistor 205 is electrically connected to the gate signal line 209, and the other of the source and the drain of the transistor 205 is electrically connected to the photosensor output signal line 211.

Next, an example of a configuration of the photosensor readout circuit 109 is described with reference to FIG. 3. In FIG. 3, a circuit 300 which corresponds to one column of the pixels and is included in the photosensor readout circuit 109 includes a transistor 301 and a storage capacitor 302. In addition, the reference numeral 211 denotes the photosensor output signal line which corresponds to the column of pixels, and reference numeral 303 denotes a precharge signal line.

Note that in the circuit configurations in this specification, a thin film transistors formed using an oxide semiconductor layer are each denoted by a symbol “OS” so that they can be identified as a thin film transistors formed using an oxide semiconductor layer. In FIG. 3, the transistor 301 is a thin film transistor formed using an oxide semiconductor layer.

In the circuit 300 which corresponds to one column of the pixels and is included in the photosensor readout circuit 109, the potential of the photosensor output signal line 211 is set to a reference potential before operation of the photosensor in the pixel. The reference potential set for the photosensor output signal line 211 may be a high potential or a low potential. In FIG. 3, by setting a potential of the precharge signal line 303 at a high level “H”, the potential of the photosensor output signal line 211 can be set to a high potential which is a reference potential. Note that the storage capacitor 302 is not necessarily provided in the case where the parasitic capacitance of the photosensor output signal line 211 is large.

Next, an example of readout operation of the photosensor in a touch panel is described with reference to a timing chart of FIG. 4. In FIG. 4, a signal 401, a signal 402, a signal 403, and a signal 404 respectively correspond to the potential of the photodiode reset signal line 208, the potential of the gate signal line 209 to which the gate of the transistor 206 is connected, the potential of the gate signal line 213 to which the gate of the transistor 205 is connected, and the potential of the photosensor output signal line 211 in FIG. 2. In addition, a signal 405 corresponds to the potential of the precharge signal line 303 in FIG. 3.

In a time A, the potential of the photodiode reset signal line 208 (the signal 401) is set at the potential “H”, in other words, the potential of the photodiode reset signal line 208 which is electrically connected to the photodiode is set so that a forward bias is applied to the photodiode (reset operation). The photodiode 204 is brought into conduction and the potential of the gate signal line 213 (the signal 403) to which the gate of the transistor 205 is connected is set at the potential “H”. The potential of the precharge signal line 303 (the signal 405) is set at the potential “H”, and the potential of the photosensor output signal line 211 (the signal 404) is precharged to the potential “H”.

In a time B, the potential of the photodiode reset signal line 208 (the signal 401) is set at the potential “L” (accumulating operation), and the potential of the gate signal line 213, that is, a gate potential of the transistor 205, to which the gate of the transistor 205 is connected (the signal 403) begins to be lowered due to a photocurrent of the photodiode 204. The photocurrent of the photodiode 204 increases when light is delivered; therefore, the potential of the gate signal line 213 to which the gate of the transistor 205 is connected (the signal 403) varies in accordance with the amount of light. That is, a current between the source and the drain of the transistor 205 varies.

In a time C, the potential of the gate signal line 209 (the signal 402) is set at the potential “H” (selecting operation). The transistor 206 is brought into conduction, and the photosensor reference signal line 212 and the photosensor output signal line 211 are brought into conduction through the transistor 205 and the transistor 206. Then, the potential of the photosensor output signal line 211 (the signal 404) begins to be lowered. Note that before the time C, the potential of the precharge signal line 303 (the signal 405) is set at the potential “L” and precharge of the photosensor output signal line 211 is completed. Here, the rate of decrease in the potential of the photosensor output signal line 211 (the signal 404) depends on the current between the source and the drain of the transistor 205. That is, the potential of the photosensor output signal line 211 (the signal 404) varies in accordance with the amount of light which is delivered to the photodiode 204.

In a time D, the potential of the gate signal line 209 (the signal 402) is set at the potential “L”, and the transistor 206 is turned off, whereby the potential of the photosensor output signal line 211 (the signal 404) is kept constant after the time D. Here, the potential of the photosensor output signal line 211 depends on the amount of light which is delivered to the photodiode 204. Therefore, the amount of light which is delivered to the photodiode 204 can be determined by the potential of the photosensor output signal line 211.

As described above, for the photosensors, the reset operation, the accumulating operation, and the selecting operation are individually repeated. In order to realize high-speed imaging of a touch panel, it is required to perform the reset operation, the accumulating operation, and the selecting operation of all the pixels at high speed.

To put it simply, by performing the accumulating operation of all the pixels after the reset operation of all the pixels, and then the selecting operation of all the pixels as illustrated in the timing chart of FIG. 10, desired imaging can be realized. FIG. 10 is a timing chart of an example of operation of a touch panel. In the timing chart of FIG. 10, a signal 1001, a signal 1002, a signal 1003, a signal 1004, a signal 1005, a signal 1006, and a signal 1007 correspond to the photodiode reset signal lines in a first row, a second row, a third row, an m^{th} row, an (m+1)^{th} row, an (n−1)^{th} row, and an n^{th} row, respectively. In the timing chart, a signal 1011, a signal 1012, a signal 1013, a signal 1014, a signal 1015, a signal 1016, and a signal 1017 correspond to the gate signal lines in the first row, the second row, the third row, the m^{th} row, the (m+1)^{th} row, the (n−1)^{th} row, and the n^{th} row, respectively. A period 1018 is a period during which the photosensor in the m^{th} row is operated, and a period 1019, a period 1020, and a period 1021 are a period during which the reset operation is performed, a period during which the accumulating operation is performed, and a period during which the selecting operation is performed, respectively. A period 1022 is a period which is needed for one-time imaging in all the pixels. Note that m and n are natural numbers and satisfy 1≦m≦n. Here, a period T illustrated in FIG. 10 indicates a period from the time when reset operation in a row starts until the time when reset operation in a next row starts.

Here, by employing a driving method illustrated in a timing chart of FIG. 7, high-speed imaging can be easily performed with operation time of individual photosensors secured.

FIG. 7 is a timing chart of an example of operation of a touch panel. In the timing chart of FIG. 7, a signal 701, a signal 702, a signal 703, a signal 704, a signal 705, a signal 706, and a signal 707 correspond to the photodiode reset signal lines in a first row, a second row, a third row, an m^{th} row, an (m+1)^{th} row, an (n−1)^{th} row, and an n^{th} row, respectively. In the timing chart, a signal 711, a signal 712, a signal 713, a signal 714, a signal 715, a signal 716, and a signal 717 correspond to the gate signal lines in the first row, the second row, the third row, the m^{th} row, the (m+1)^{th} row, the (n−1)^{th} row, and the n^{th} row, respectively. A period 718 is a period during which the photosensor in the m^{th} row is operated, and a period 719, a period 720, and a period 721 are a period during which the reset operation is performed, a period during which the accumulating operation is performed, and a period in which the selecting operation is performed, respectively. A period 722 is a period which is needed for one-time imaging in all the pixels. Note that m and n are natural numbers and satisfy 1≦m≦n. Here, a period T illustrated in FIG. 7 indicates a period from the time when reset operation in a row starts until the time when reset operation in a next row starts.

In the driving method illustrated in the timing chart of FIG. 7, the reset operation, the accumulating operation, and the selecting operation are performed simultaneously using different rows. For example, simultaneously with reset operation in a row, selecting operation is performed in another row. In FIG. 7, the reset operation in the m^{th} row and the selecting operation in the first row are performed simultaneously.

Here, in the case where a period of reset operation and selecting operation of photosensors in each row in the timing chart of FIG. 7 is set in the same value as that in the timing chart of FIG. 10, a period needed for one-time imaging in the whole screen (the period 722) in the timing chart of FIG. 7 can be shorter than that of FIG. 10 (the period 1022). Therefore, with the driving method illustrated in the timing chart of FIG. 7, the frame frequency of imaging and the speed for imaging can be higher than that with the driving method illustrated in the timing chart of FIG. 10.

Therefore, by employing the driving method illustrated in the timing chart of FIG. 7, with an operation time for individual photosensor secured, high-speed imaging can be performed, which is contributed by increase in the frame frequency of imaging.

Note that in order to realize the driving method illustrated in the timing chart of FIG. 7, it is preferable that the photosensor driver circuit 110 include a driver circuit for controlling reset operation and a driver circuit for controlling selecting operation independently. For example, it is preferable that the driver circuit for controlling reset operation be formed using a first shift register and that the driver circuit for controlling selecting operation be formed using a second shift register.

Further, by employing the driving method of the timing chart illustrated in FIG. 11, stable operation of the photosensors can be achieved.

In the timing chart of FIG. 11, a signal 1101, a signal 1102, a signal 1103, a signal 1104, a signal 1105, a signal 1106, and a signal 1107 correspond to the photodiode reset signal line in a first row, a second row, a third row, an m^{th} row, an (m+1)^{th} row, an (n−1)^{th} row, and an n^{th} row, respectively. In the timing chart, a signal 1111, a signal 1112, a signal 1113, a signal 1114, a signal 1115, a signal 1116, and a signal 1117 correspond to the gate signal line in the first row, the second row, the third row, the m^{th} row, the (m+1)^{th} row, the (n−1)^{th} row, and the n^{th} row, respectively. A period 1118 is a period in which the photosensor in the m^{th} row is operated, and a period 1119, a period 1120, and a period 1121 are a period during which the reset operation is performed, a period during which the accumulating operation is performed, and a period during which the selecting operation is performed, respectively. A period 1122 is a period which is needed for one-time imaging in all the pixels. Here, a period T illustrated in FIG. 11 indicates a period from the time when reset operation in a row starts until the time when reset operation in a next row starts. In the timing chart of FIG. 10, selecting operation is not made for all rows during the period T; however, in the timing chart of FIG. 11, selecting operation is made for other rows during the period T of a certain row. For instance, as shown in FIG. 11, during the period from starting reset operation in a m^{th} row until starting reset operation in the (m+1)^{th} row, selecting operation is performed in the second row.

In the driving method illustrated in the timing chart of FIG. 11, reset operation of a row and selecting operation of a different row are not performed simultaneously without a change in operation frequency of the driver circuit for controlling reset operation and the driver circuit for controlling selecting operation. For example, during interval between the end of reset operation in a row and the start of reset operation in an adjacent row, selecting operation in another row is performed, and reset operation and selecting operation are not performed simultaneously. For example, in FIG. 11, during interval between the end of reset operation in the m^{th} row and the start of reset operation in the (m+1)^{th} row, selecting operation in the second row is performed. In a similar way, during interval between the end of selecting operation in a row and the start of selecting operation in an adjacent row, reset operation in another row is performed, and reset operation and selecting operation are not performed. In FIG. 11, during interval between the end of selecting operation in the first row and the start of selecting operation in the second row, reset operation in the m^{th} row is performed.

By employing the driving method illustrated in the timing chart of FIG. 11, an influence of change in a potential of the photosensor output signal line, which is caused by photosensors in the row where selecting operation is performed, on reset operation of a photosensor in another row can be significantly reduced. Therefore, by employing the driving method illustrated in the timing chart of FIG. 11, stable operation of photosensors can be achieved.

Here, the influence on reset operation is attributed to leakage current that flows from the photosensor output signal line 211 to the photosensor reference signal line 212 through the transistor 205 due to off-state leakage current of the transistor 206 in FIG. 2. Due to the influence on reset operation, malfunctions of photosensor operation could possibly be caused, such as the case where the gate voltage of the transistor 205 does not reach a desired voltage during reset operation or the case where a potential of the photosensor output signal line 211 and a potential of the photosensor reference signal line 212 become unstable by the leakage current.

However, in the invention disclosed in this specification, the transistor 206 is formed using a thin film transistor formed using an oxide semiconductor layer and thus has an extremely small off-state current; therefore, possibility of the above malfunctions can be reduced.

Further, by employing the driving method illustrated in the timing chart of FIG. 11, with stable operation of the photosensor, high-speed imaging is possible by enhancing the frame frequency of imaging.

Note that in the driving method illustrated in the timing chart of FIG. 11, it is also effective to set a potential of the photosensor output signal line to the same level as a potential of the photosensor reference signal line during a reset period.

Note that in order to realize the driving method illustrated in the timing chart of FIG. 11, it is preferable that the photosensor driver circuit 110 includes a driver circuit for controlling reset operation and a driver circuit for controlling selecting operation independently. For example, it is effective that the driver circuit for controlling reset operation is formed using a first shift register, the driver circuit for controlling selecting operation is formed using a second shift register, and that control signals in each row are generated by logical sum of a signal for setting the potential “H” only during a desired period with respect to output of each shift register.

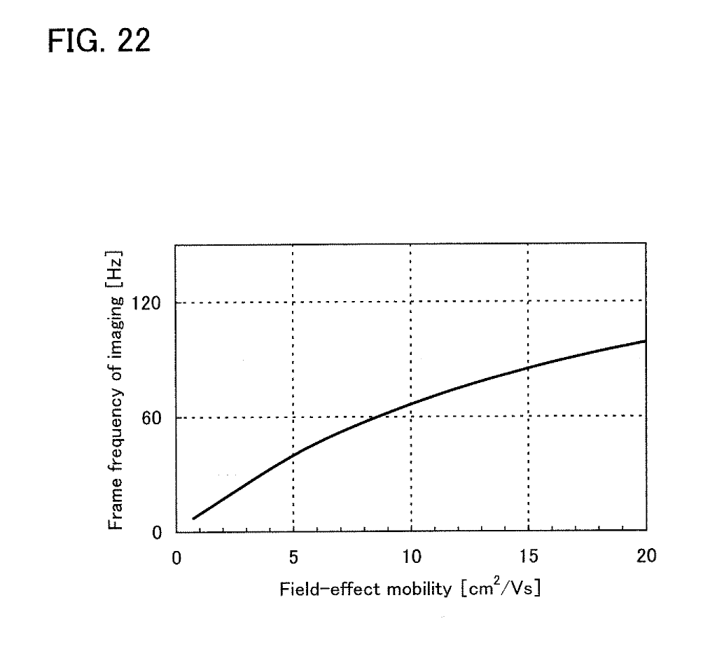

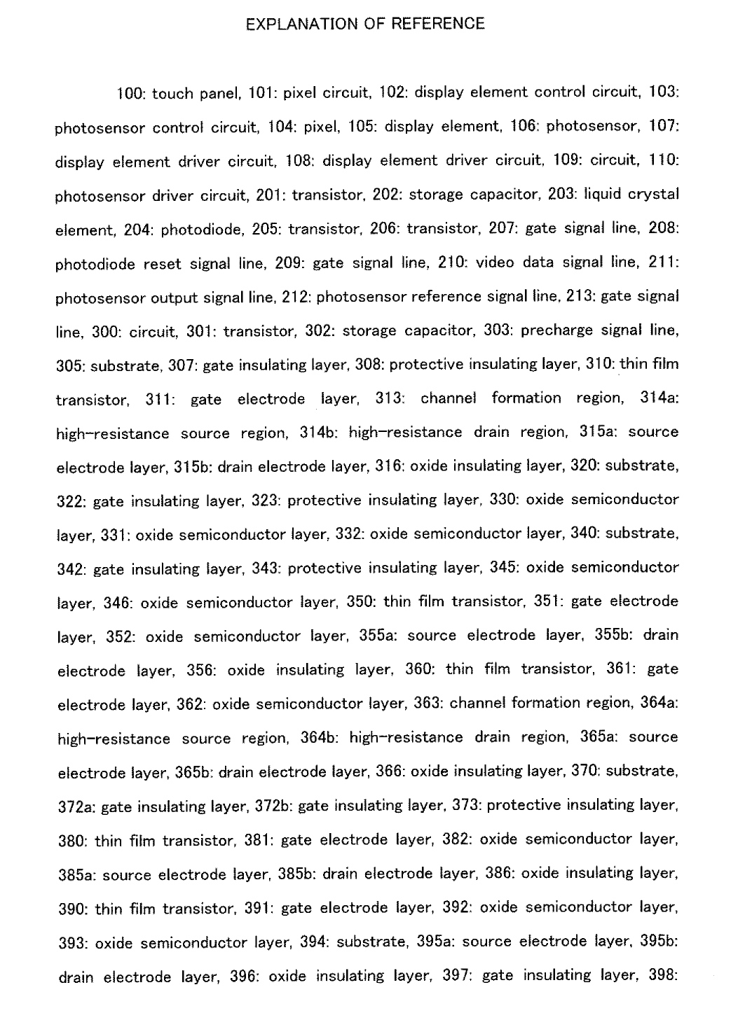

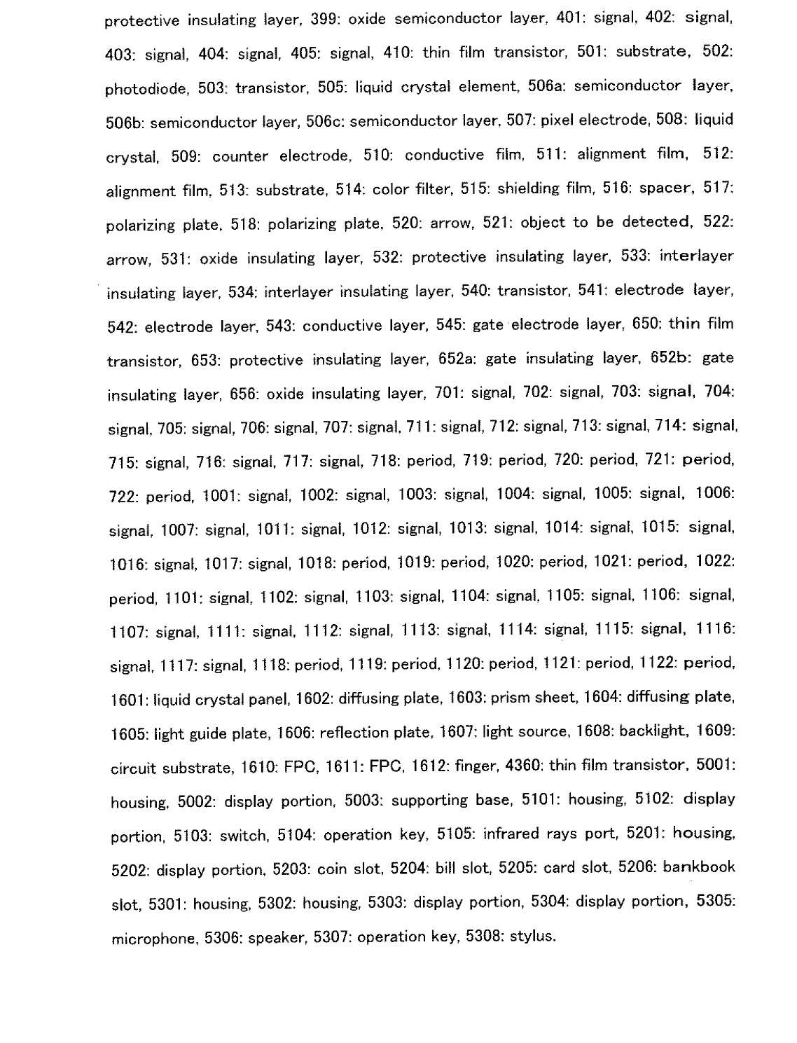

The results of circuit calculation of a frequency of imaging in the photosensor 106 of FIG. 2 are shown in FIG. 22. FIG. 22 shows a relationship between field-effect mobility of the transistor 205 and the transistor 206 which are included in the photosensor 106 and a frame frequency of imaging which is calculated from a reading speed.

The circuit calculation was performed under the following conditions assumed. In a touch panel, which has a 20-inch FHD standard (1920 horizontal RGB pixels and 1080 vertical pixels), each pixel is provided with a photosensor, the parasitic capacitance of the photosensor output signal line 211 is 20 pF (corresponds to the capacitor 302), the transistor 205 and the transistor 206 each have a channel length of 5 μm and a channel width of 16 μm, and the transistor 301 has a channel length of 5 μm and a channel width of 1000 μm. Note that a circuit simulator, Smart Spice (manufactured by Silvaco Data Systems Inc.), was used for the calculation.

The circuit calculation was performed with the following operations assumed. First, an initial state is to be a state immediately after the accumulating operation. Specifically, the potential of the gate signal line 213 is set at 8 V, the potential of the gate signal line 209 is set at 0 V, the potential of the photosensor output signal line 211 is set at 8 V, the potential of the photosensor reference signal line 212 is set at 8 V, and the potential of the precharge signal line 303 is set at 0 V. After the potential of the precharge signal line 303 and the potential of the photosensor output signal line 211 in the initial state are changed to 8 V and 0 V (precharged state) respectively, the potential of the precharge signal line 303 and the potential of the gate signal line 209 are changed to 0 V and 8 V, respectively. In other words, the selecting operation is started. Note that the reference voltage is set at 0 V. After that, a final state is to be the time when the potential of the photosensor output signal line 211 is changed to 2 V, that is, the potential is changed by 2 V from the potential at the precharge operation. The time from the initial state to the final state in the operations described above is to be imaging time per one row.

The time needed for imaging is to be 1080 times as much as the above imaging time per one row, and the inverse of the imaging time is to be a frequency of the imaging. As an example, the frequency of imaging of 60 Hz means that the above imaging time per one row corresponds to the following equation: 1/60 [Hz]/1080 [columns]=15.43 [μs].

According to the results in FIG. 22, it is found that the frequency of imaging is 70 Hz to 100 Hz in the case where the field-effect mobility of each of the transistor 205 and the transistor 206 is set at 10 cm²/Vs to 20 cm²/Vs on the assumption that a transistor formed using an oxide semiconductor is used. On the other hand, in the case where the field-effect mobility of each of the transistor 205 and the transistor 206 is set at 0.5 cm²/Vs on the assumption that a transistor formed using amorphous silicon is used, the frequency of imaging is only about 5 Hz. In other words, it is effective to form a transistor of a photosensor using an oxide semiconductor.

With the above structure, it is possible to secure an operation time and to provide a touch panel including a photosensor capable of high-speed imaging. In addition, it is possible to provide a method for driving a touch panel capable of high-speed imaging with the operation time of the photosensor secured.

In addition, with the above configuration, it is possible to provide a touch panel including a photosensor capable of high-speed imaging with stable operation. In addition, it is possible to provide a method for driving a touch panel capable of high-speed imaging with the stable operation of the photosensor.

Furthermore, it is possible to provide a highly functional touch panel capable of high-speed response with a thin film transistor formed using an oxide semiconductor layer.

### Embodiment 2

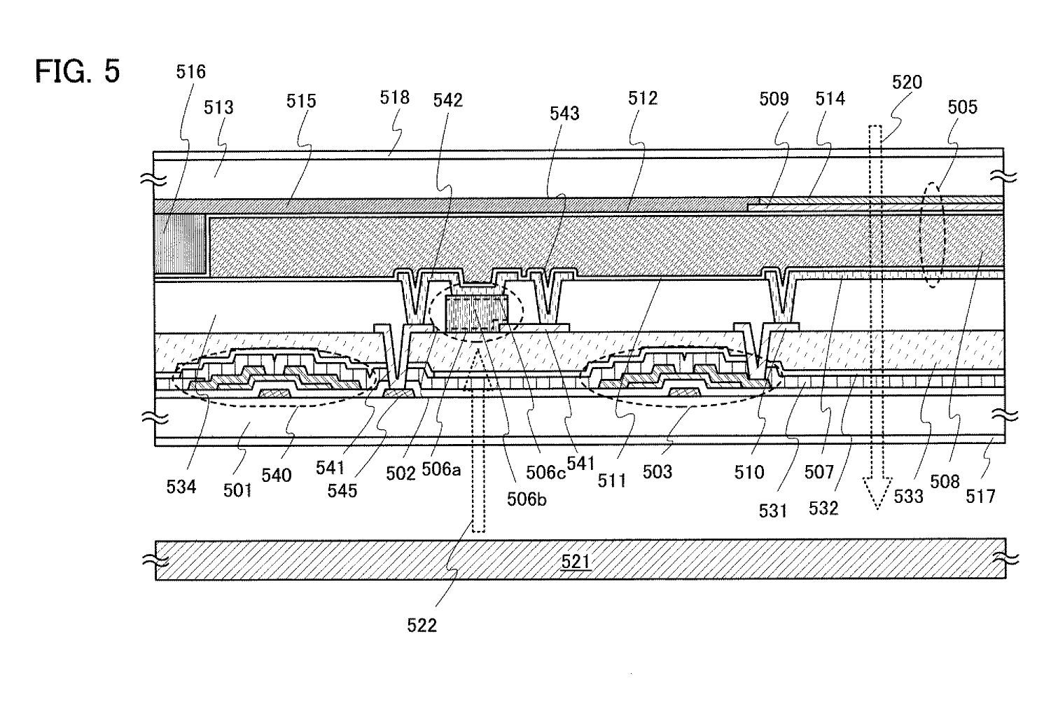

In this embodiment, a structure of a touch panel according to an embodiment of the present invention will be described with reference to FIG. 5.

FIG. 5 illustrates an example of a cross-sectional view of the touch panel. In the touch panel illustrated in FIG. 5, a photodiode 502, a transistor 540, a transistor 503, and a liquid crystal element 505 are formed over a substrate 501 having an insulating surface (a TFT substrate).

An oxide insulating layer 531, a protective insulating layer 532, an interlayer insulating layer 533, and an interlayer insulating layer 534 are provided over the transistor 503 and the transistor 540. The photodiode 502 is provided over the interlayer insulating layer 533. In the photodiode 502, a first semiconductor layer 506a, a second semiconductor layer 506b, and a third semiconductor layer 506c are sacked in that order over the interlayer insulating layer 533 between an electrode layer 541 formed over the interlayer insulating layer 533 and an electrode layer 542 formed over the interlayer insulating layer 534.

The electrode layer 541 is electrically connected to a conductive layer 543 which is formed in the interlayer insulating layer 534, and the electrode layer 542 is electrically connected to a gate electrode layer 545 through the electrode layer 541. The gate electrode layer 545 is electrically connected to a gate electrode layer of the transistor 540, and the photodiode 502 is electrically connected to the transistor 540. The transistor 540 corresponds to the transistor 205 in Embodiment 1.

In order to prevent variation in electric characteristics of the transistor 503 and the transistor 540 each formed using an oxide semiconductor layer, which are included in a touch panel including a photosensor, impurities such as hydrogen, moisture, a hydroxyl group, or a hydride (also referred to as a hydrogen compound) which cause the variation are intentionally removed from the oxide semiconductor layer. Additionally, the oxide semiconductor layer is highly purified to become i-type (intrinsic) by supplying oxygen which is a major component of the oxide semiconductor layer, which is simultaneously reduced in a step of removing impurities.

Therefore, it is preferable that the oxide semiconductor layer contains hydrogen and carriers as little as possible. In the transistor 503 and the transistor 540, a channel formation region is formed in the oxide semiconductor layer, in which hydrogen contained therein is removed as much as possible to be close to 0 so that the hydrogen concentration is less than or equal to 5×10¹⁹/cm³, preferably, less than or equal to 5×10¹⁸/cm³, more preferably, less than or equal to 5×10¹⁷/cm³ or less than 5×/cm³, and the carrier concentration is less than 5×10¹⁴/cm³, preferably, less than or equal to 5×10¹²/cm³.

It is preferable that an off-state current be as small as possible in reverse characteristics of the transistor 503 and the transistor 540. An off-state current is a current that flows between a source and a drain of a thin film transistor in the case where a gate voltage between −1 V to −10 V is applied. A current value per 1 μm in a channel width (w) of a thin film transistor formed using an oxide semiconductor, which is disclosed in this specification, is less than or equal to 100 aA/μm, preferably, less than or equal to 10 aA/μm, more preferably, less than or equal to 1 aA/μm. Further, since there is no pn junction and no hot carrier degradation, electric characteristics of the thin film transistor is not adversely affected.

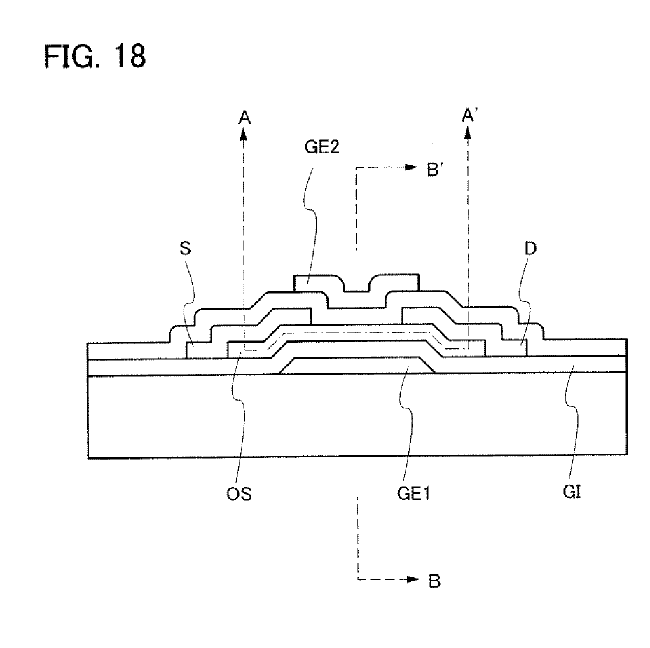

FIG. 18 is a longitudinal cross-sectional view of an inverted staggered thin film transistor formed using an oxide semiconductor. An oxide semiconductor layer (OS) is provided over a gate electrode (GE1) with a gate insulating film (GI) interposed therebetween, and a source electrode (S) and a drain electrode (D) are provided thereover.

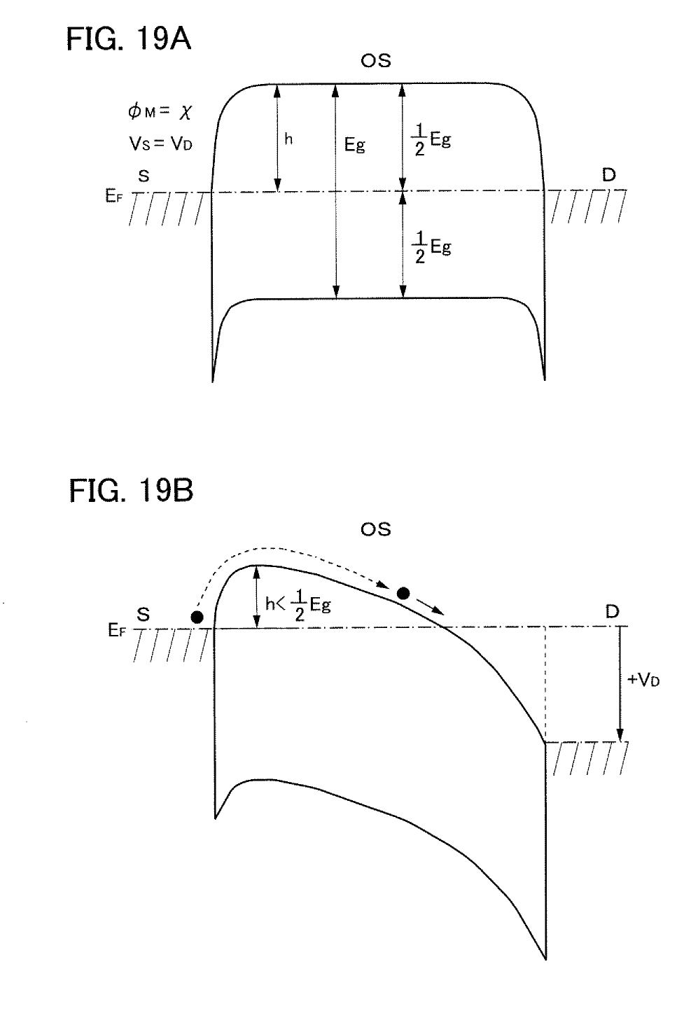

FIGS. 19A and 19B are energy band diagrams (schematic diagrams) of a cross section along A-A′ in FIG. 18. FIG. 19A illustrates the case where the potential applied to the source is equal to the potential applied to the drain (V_{D}=0 V), and FIG. 19B illustrates the case where a positive potential with respect to the source is applied to the drain (V_{D}>0 V).

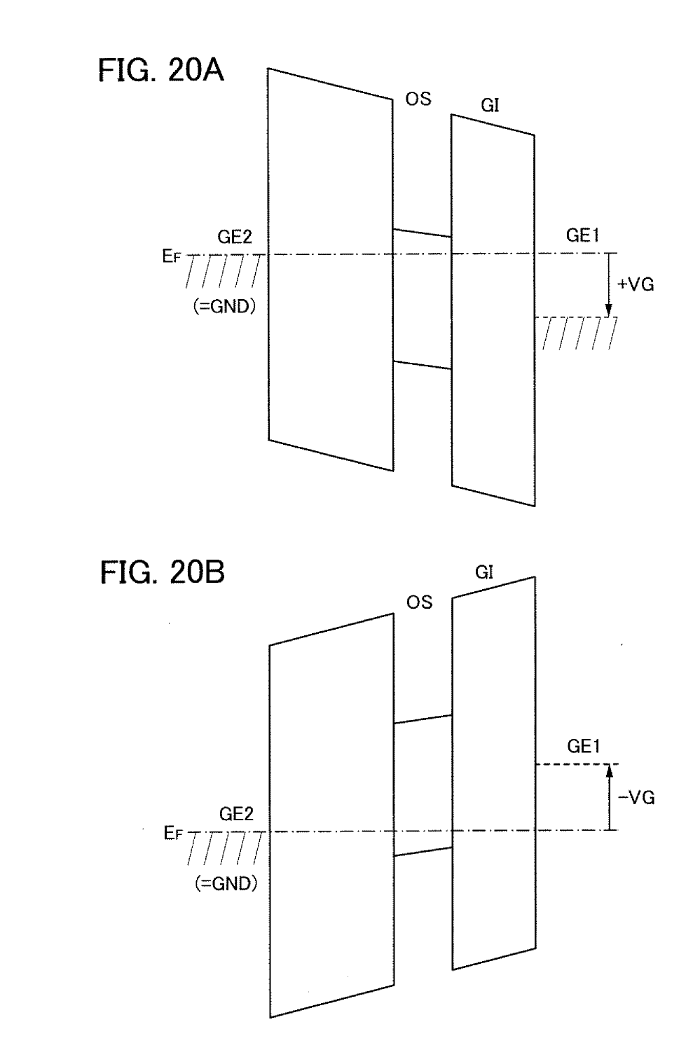

FIGS. 20A and 20B are energy band diagrams (schematic diagrams) of a cross section along B-B′ in FIG. 18. FIG. 20A illustrates an on state in which a positive potential (+VG) is applied to the gate electrode (GE1) and carriers (electrons) flow between the source and the drain. FIG. 20B illustrates an off state in which a negative potential (−VG) is applied to the gate electrode (GE1) and minority carriers do not flow.

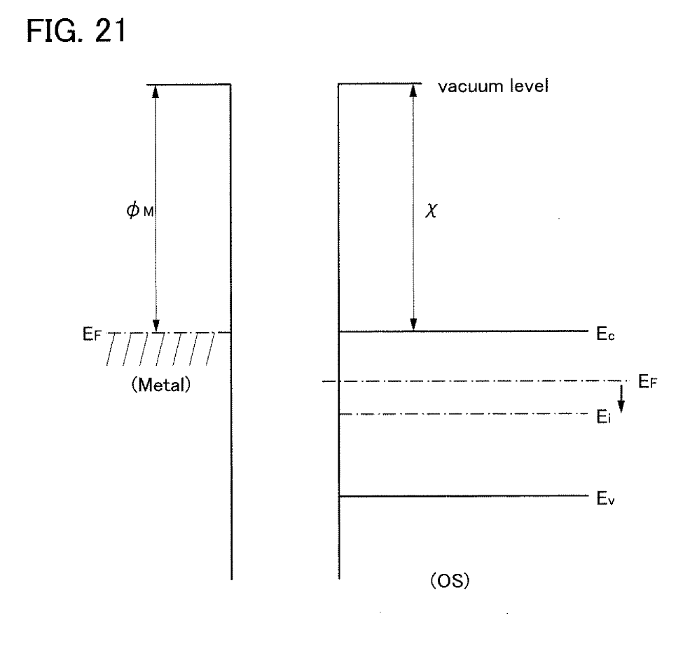

FIG. 21 illustrates the relationships between the vacuum level and the work function of a metal (φM) and between the vacuum level and the electron affinity (χ) of an oxide semiconductor.

A conventional oxide semiconductor is typically an n-type semiconductor, and the Fermi level (E_{F}) is away from the intrinsic Fermi level (Ei) located in the middle of a band gap and is located closer to the conduction band. Note that since hydrogen can serve as a donor, hydrogen is known as a factor to make the oxide semiconductor layer n-type.

On the other hand, an oxide semiconductor according to the present invention is an intrinsic (i-type) or a substantially intrinsic oxide semiconductor which is obtained by removing hydrogen that is an n-type impurity from an oxide semiconductor and highly purifying the oxide semiconductor such that an impurity is prevented from being contained therein as much as possible. In other words, a feature is that a highly purified i-type (intrinsic) semiconductor or a semiconductor close thereto is obtained by removing an impurity such as hydrogen or water as much as possible. This enables the Fermi level (E_{F}) to be at the same level as the intrinsic Fermi level (Ei).

The electron affinity (χ) of an oxide semiconductor is said to be 4.3 eV. The work function of titanium (Ti) included in the source electrode and the drain electrode is substantially equal to the electron affinity (χ) of the oxide semiconductor. In that case, a Schottky barrier to electrons is not formed at an interface between the metal and the oxide semiconductor.

In other words, in the case where the work function of the metal (φM) and the electron affinity (χ) of the oxide semiconductor are equal to each other and the metal and the oxide semiconductor are in contact with each other, an energy band diagram (a schematic diagram) as illustrated in FIG. 19A is obtained.

In FIG. 19B, a black circle () represents an electron, and when a positive potential is applied to the drain electrode, the electron is injected into the oxide semiconductor layer over the barrier (h) and flows toward the drain. In that case, the height of the barrier (h) changes depends on the gate voltage and the drain voltage; in the case where a positive drain voltage is applied, the height of the barrier (h) is smaller than the height of the barrier in FIG. 19A where no voltage is applied, i.e., ½ of the band gap (Eg).

At this time, the electron injected into the oxide semiconductor flows through the oxide semiconductor layer as illustrated in FIG. 20A. In addition, in FIG. 20B, when a negative potential is applied to the gate electrode (GE1), the value of current is as close to zero as possible because holes that are minority carriers do not substantially exist.

For example, even a thin film transistor has a channel width W of 1×10⁴ μm and a channel length of 3 μm, an off-state current is less than or equal to 10⁻¹³ A and a subthreshold swing (S value) is 0.1 V/dec. (the thickness of the gate insulating film: 100 nm).

In this manner, when the oxide semiconductor layer is highly purified so that impurities are contained as little as possible, the operation of the thin film transistor can be favorable.

Therefore, the above transistors 503 and 540 formed using the oxide semiconductor layer are thin film transistors having stable electric characteristics and high reliability.

As the oxide semiconductor layer included in each of the transistor 503 and the transistor 540, any of a four-component metal oxide such as an In—Sn—Ga—Zn—O film, a three-component metal oxide such as an In—Ga—Zn—O film, an In—Sn—Zn—O film, an In—Al—Zn—O film, a Sn—Ga—Zn—O film, an Al—Ga—Zn—O film, and a Sn—Al—Zn—O film, or a two-component metal oxide such as an In—Zn—O film, a Sn—Zn—O film, an Al—Zn—O film, a Zn—Mg—O film, a Sn—Mg—O film, an In—Mg—O film, an In—O film, a Sn—O film, and a Zn—O film can be used. Further, SiO₂ may be contained in the above oxide semiconductor layer.

Note that as the oxide semiconductor layer, a thin film expressed by InMO₃(ZnO)ₘ (m>0) can be used. Here, M represents one or more metal elements selected from Ga, Al, Mn, and Co. For example, M can be Ga, Ga and Al, Ga and Mn, Ga and Co, or the like. An oxide semiconductor layer whose composition formula is represented by InMO₃ (ZnO)ₘ (m>0), which includes Ga as M, is referred to as the In—Ga—Zn—O oxide semiconductor described above, and a thin film of the In—Ga—Zn—O oxide semiconductor is also referred to as an In—Ga—Zn—O-based non-single-crystal film.

Here, a pin photodiode in which a semiconductor layer having p-type conductivity as the first semiconductor layer 506a, a high-resistance semiconductor layer (i-type semiconductor layer) as the second semiconductor layer 506b, and a semiconductor layer having n-type conductivity as the third semiconductor layer 506e are stacked is illustrated as an example.

The first semiconductor layer 506a is a p-type semiconductor layer and can be formed using an amorphous silicon film containing an impurity element imparting p-type conductivity. The first semiconductor layer 506a is formed with a plasma CVD method with the use of a semiconductor source gas containing an impurity element belonging to Group 13 (such as boron (B)). As the semiconductor material gas, silane (SiH₄) may be used. Alternatively, Si₂H₆, SiH₂Cl₂, SiHCl₃, SiCl₄, SiF₄, or the like may be used. Further alternatively, an amorphous silicon film which does not contain an impurity element may be formed, and then, an impurity element may be introduced to the amorphous silicon film with the use of a diffusion method or an ion injecting method. Heating or the like may be performed after introducing the impurity element with an ion injecting method or the like in order to diffuse the impurity element. In this case, as a method of forming the amorphous silicon film, an LPCVD method, a chemical vapor deposition method, a sputtering method, or the like may be used. The first semiconductor layer 506a is preferably formed to have a thickness of greater than or equal to 10 nm and less than or equal to 50 nm.

The second semiconductor layer 506b is an i-type semiconductor layer (intrinsic semiconductor layer) and is formed with an amorphous silicon film. As for formation of the second semiconductor layer 506b, an amorphous silicon film is formed with a plasma CVD method using a semiconductor material gas. As the semiconductor material gas, silane (SiH₄) may be used. Alternatively, Si₂H₆, SiH₂Cl₂, SiHCl₃, SiCl₄, SiF₄, or the like may be used. The second semiconductor layer 506b may be alternatively formed with an LPCVD method, a chemical vapor deposition method, a sputtering method, or the like. The second semiconductor layer 506b is preferably formed to have a thickness of greater than or equal to 200 nm and less than or equal to 1000 nm.

The third semiconductor layer 506c is an n-type semiconductor layer and is formed with an amorphous silicon film containing an impurity element imparting n-type conductivity. The third semiconductor layer 506c is formed with a plasma CVD method using a semiconductor material gas containing an impurity element belonging to Group 15 (such as phosphorus (P)). As the semiconductor material gas, silane (SiH₄) may be used. Alternatively, Si₂H₆, SiH₂Cl₂, SiHCl₃, SiCl₄, SiF₄, or the like may be used. Further alternatively, an amorphous silicon film which does not contain an impurity element may be formed, and then, an impurity element may be introduced to the amorphous silicon film with the use of a diffusion method or an ion injecting method. Heating or the like may be performed after the impurity element is introduced with an ion injecting method or the like in order to diffuse the impurity element. In this case, as a method of forming the amorphous silicon film, an LPCVD method, a chemical vapor deposition method, a sputtering method, or the like may be used. The third semiconductor layer 506c is preferably formed to have a thickness of greater than or equal to 20 nm and less than or equal to 200 nm.

The first semiconductor layer 506a, the second semiconductor layer 506b, and the third semiconductor layer 506c are not necessarily formed using an amorphous semiconductor, and they may be formed using a polycrystalline semiconductor or a microcrystalline semiconductor (a semi-amorphous semiconductor (SAS)).

The microcrystalline semiconductor belongs to a metastable state of an intermediate between amorphous and single crystalline when Gibbs free energy is considered. That is, the microcrystalline semiconductor film is a semiconductor having a third state which is thermodynamically stable and has a short range order and lattice distortion. Columnar-like or needle-like crystals grow in a normal direction with respect to a substrate surface. The Raman spectrum of microcrystalline which is a typical example of a microcrystalline semiconductor, is shifted to a small wavenumber region below 520 cm⁻¹ which represents single-crystalline silicon. That is, the peak of the Raman spectrum of the microcrystalline silicon exists between 520 cm⁻¹ which represents single crystal silicon and 480 cm⁻¹ which represents amorphous silicon. In addition, microcrystalline silicon contains hydrogen or halogen of at least 1 atomic % or more in order to terminate a dangling bond. Moreover, microcrystalline silicon may contain a rare gas element such as helium, argon, krypton, or neon to further promote lattice distortion, so that s and a microcrystalline semiconductor film with high thermodynamic stability can be obtained.

The microcrystalline semiconductor film can be formed with a high-frequency plasma CVD method with a frequency of several tens of MHz to several hundreds of MHz or with a microwave plasma CVD method with a frequency of greater than or equal to 1 GHz. Typically, the microcrystalline semiconductor film can be formed using a silicon hydride such as SiH₄, Si₂H₆, SiH₂Cl₂, or SiHCl₃ or a silicon halide such as SiCl₄ or SiF₄, which is diluted with hydrogen. With a dilution with one or a plural kinds of rare gas elements selected from helium, argon, krypton, or neon in addition to silicon hydride and hydrogen, the microcrystalline semiconductor film can be formed. In that case, the flow ratio of hydrogen to the silicon hydride is 5:1 to 200:1, preferably, 50:1 to 150:1, more preferably, 100:1. Further, a hydrocarbon gas such as CH₄ or C₂H₆, a germanium gas such as GeH₄ or GeF₄, F₂, or the like may be mixed into the gas containing silicon.

In addition, since the field-effect mobility of holes generated by the photoelectric effect is lower than that of electrons, a pin photodiode has better characteristics when a surface on the p-type semiconductor layer side is used as a light-receiving plane. Here, an example where light received by the photodiode 502 from a surface of the substrate 501, over which a pin photodiode is formed, is converted into electric signals will be described. Further, light from the semiconductor layer having a conductivity type opposite to that of the semiconductor layer on the light-receiving plane is disturbance light; therefore, the electrode layer is preferably formed using a light-blocking conductive film. Note that a surface on the n-type semiconductor layer side can alternatively be used as the light-receiving plane.

The liquid crystal element 505 includes a pixel electrode 507, liquid crystal 508, a counter electrode 509, an alignment film 511, and an alignment film 512. The pixel electrode 507 is formed over the substrate 501, and the alignment film 511 is formed over the pixel electrode 507. The pixel electrode 507 is electrically connected to the transistor 503 through a conductive film 510. A substrate 513 (a counter substrate) is provided with the counter electrode 509, the alignment film 512 is formed over the counter electrode 509, and the liquid crystal 508 is interposed between the alignment film 511 and the alignment film 512. The transistor 503 corresponds to the transistor 201 in Embodiment 1.

A cell gap between the pixel electrode 507 and the counter electrode 509 can be controlled by using a spacer 516. In FIG. 5, the cell gap is controlled by using the columnar spacer 516 selectively formed by photolithography. Alternatively, the cell gap can be controlled by dispersing spherical spacers between the pixel electrode 507 and the counter electrode 509.

The liquid crystal 508 is surrounded by a sealing material between the substrate 501 and the substrate 513. The liquid crystal 508 may be injected with a dispenser method (droplet method) or a dipping method (pumping method).

For the pixel electrode 507, a light-transmitting conductive material such as indium tin oxide (ITO), indium tin oxide containing silicon oxide (ITSO), organic indium, organic tin, indium zinc oxide (IZO) containing zinc oxide (ZnO), zinc oxide (ZnO), zinc oxide containing gallium (Ga), tin oxide (SnO₂), indium oxide containing tungsten oxide, indium zinc oxide containing tungsten oxide, indium oxide containing titanium oxide, indium tin oxide containing titanium oxide, or the like can be used. A conductive composition containing a conductive macromolecule (also referred to as a conductive polymer) can be used to form the pixel electrode 507. As the conductive macromolecule, a so-called π-electron conjugated conductive polymer can be used. For example, polyaniline or a derivative thereof, polypyrrole or a derivative thereof, polythiophene or a derivative thereof, a copolymer of two or more kinds of them, and the like can be given.

Since the transparent liquid crystal element 505 is given as an example in this embodiment, the light-transmitting conductive material described above can be used also for the counter electrode 509 as in the case of the pixel electrode 507.

An alignment film 511 is provided between the pixel electrode 507 and the liquid crystal 508, and an alignment film 512 is provided between the counter electrode 509 and the liquid crystal 508. The alignment film 511 and the alignment film 512 can be formed using an organic resin such as a polyimide or poly(vinyl alcohol). Alignment treatment such as rubbing is performed on their surfaces in order to align liquid crystal molecules in certain direction. Rubbing can be performed by rolling a roller wrapped with cloth of nylon or the like while applying pressure on the alignment film so that the surface of the alignment film is rubbed in certain direction. Note that by using an inorganic material such as silicon oxide, the alignment film 511 and the alignment film 512 each having an alignment property can be directly formed with an evaporation method without performing an alignment treatment.

Further, a color filter 514 through which light in a particular wavelength range can pass is formed over the substrate 513 so as to overlap with the liquid crystal element 505. The color filter 514 can be selectively formed by photolithography after application of an organic resin such as an acrylic-based resin in which colorant is dispersed on the substrate 513. Alternatively, the color filter 514 can be selectively formed by etching after application of a polyimide-based resin in which colorant is dispersed on the substrate 513. Alternatively, the color filter 514 can be selectively formed with a droplet discharge method such as an ink-jet method.

Furthermore, a shielding film 515 which can block light is formed over the substrate 513 so as to overlap with the photodiode 502. By providing the shielding film 515, light from a backlight that passes through the substrate 513 and enters the touch panel can be prevented from being directly delivered to the photodiode 502. Further, disclination due to disorder of alignment of the liquid crystal 508 among pixels can be prevented from being viewed. An organic resin containing black colorant such as carbon black or a low-valent titanium oxide can be used for the shielding film 515. Alternatively, a film formed using chromium can be used for the shielding film 515.

Furthermore, a polarizing plate 517 is provided on a surface which is the opposite side of a surface of the substrate 501 over which the pixel electrode 507 is formed, and a polarizing plate 518 is provided on a surface which is the opposite side of a surface of the substrate 513 on which the counter electrode 509 is formed.

With the use of an insulating material, the oxide insulating layer 531, the protective insulating layer 532, the interlayer insulating layer 533, and the interlayer insulating layer 534 can be formed, depending on the material, with a method such as a sputtering method, an SOG method, spin coating, dip coating, spray coating, or a droplet discharge method (e.g., an ink-jet method, screen printing, offset printing, or the like).

As the oxide insulating layer 531, a single layer or a stacked layer of an oxide insulating layer such as a silicon oxide layer, a silicon oxynitride layer, an aluminum oxide layer, an aluminum oxynitride layer, or the like can be used.

As an inorganic insulating material of the protective insulating layer 532, a single layer or a stacked layer of a nitride insulating layer such as a silicon nitride layer, a silicon nitride oxide layer, an aluminum nitride layer, an aluminum nitride oxide layer, or the like can be used. High-density plasma CVD with the use of microwaves (2.45 GHz) is preferably employed because formation of a dense and high-quality insulating layer having high withstand voltage is possible.

For reduction of the surface roughness, an insulating layer functioning as a planarization insulating film is preferably used as the interlayer insulating layers 533 and 534. The interlayer insulating layers 533 and 534 can be formed using an organic insulating material having heat resistance such as a polyimide, an acrylic resin, a benzocyclobutene-based resin, a polyamide, or an epoxy resin. Other than such organic insulating materials, it is possible to use a single layer or stacked layers of a low-dielectric constant material (a low-k material), a siloxane-based resin, phosphosilicate glass (PSG), borophosphosilicate glass (BPSG), or the like.

Light from the backlight passes through the substrate 513 and the liquid crystal element 505 and is delivered to an object 521 to be detected on the substrate 501 side as indicated by an arrow 520. Then, light reflected by the object 521 to be detected enters the photodiode 502 as indicated by an arrow 522.

The liquid crystal element may be a TN (twisted nematic) mode liquid crystal element, a VA (vertical alignment) mode liquid crystal element, an OCB (optically compensated birefringence) mode liquid crystal element, an IPS (in-plane switching) mode liquid crystal element, or the like. Alternatively, liquid crystal exhibiting a blue phase for which an alignment film is unnecessary may be used. The blue phase is one of liquid crystal phases and a phase which appears just before the transition from a cholesteric phase to an isotropic phase when the temperature of cholesteric liquid crystal is increased. A blue phase appears only within a narrow temperature range; therefore, the liquid crystal 508 is formed using a liquid crystal composition containing a chiral agent at 5 wt % or more in order to expand the temperature range. The liquid crystal composition including liquid crystal exhibiting a blue phase and a chiral agent has a short response time of 1 millisecond or less and are optically isotropic; therefore, alignment treatment is unnecessary, and viewing angle dependence is small. In addition, since an alignment film does not need to be provided and rubbing treatment is unnecessary, electrostatic discharge damage caused by the rubbing treatment can be prevented and defects and damage of the touch panel can be reduced in the manufacturing process. Thus, productivity of the touch panel can be increased.

Note that although the liquid crystal element 505 in which the liquid crystal 508 is interposed between the pixel electrode 507 and the counter electrode 509 is described as an example in this embodiment, the touch panel according to an embodiment of the present invention is not limited to this structure. A liquid crystal element in which a pair of electrodes is formed on the substrate 501 side like an IPS mode liquid crystal element may also be employed.

With the above structure, it is possible to provide a touch panel capable of high-speed imaging. In addition, it is possible to provide a method for driving the touch panel capable of high-speed imaging.

Furthermore, it is possible to provide a highly functional touch panel capable of high-speed response with a thin film transistor formed using an oxide semiconductor layer.

### Embodiment 3

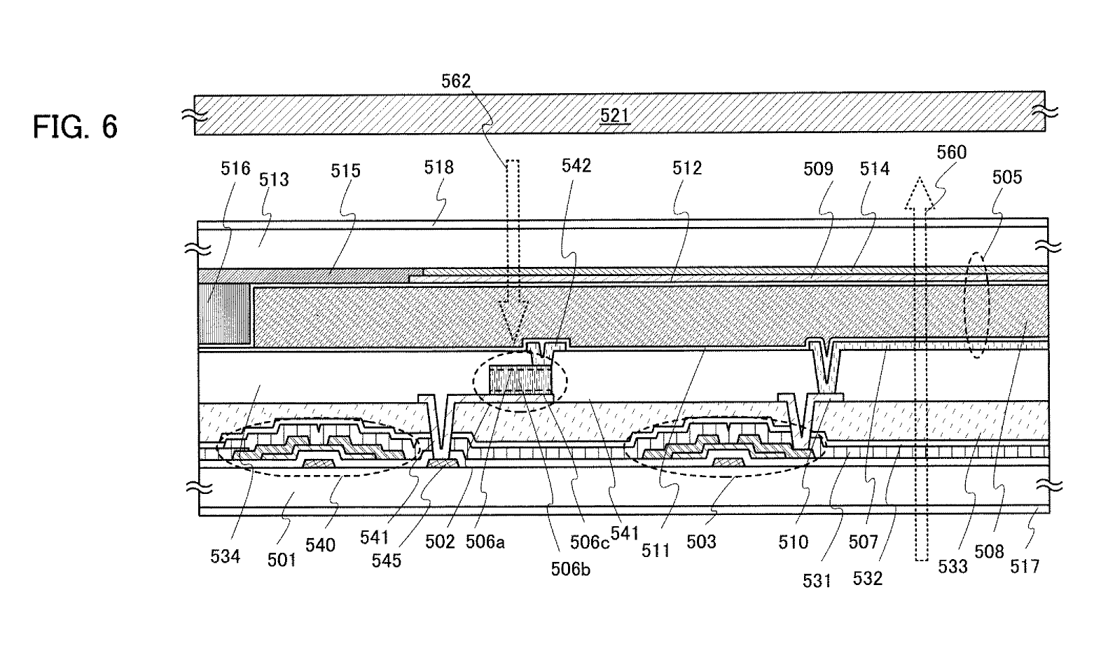

In this embodiment, another structure of a touch panel according to an embodiment of the present invention will be described with reference to FIG. 6.

FIG. 6 illustrates an example of a cross-sectional view of a touch panel which is different from that in Embodiment 2. The touch panel in FIG. 6 illustrates an example where electric signals are obtained by converting light which enters the photodiode 502 through the counter substrate 513 opposed to the substrate 501, over which a pin photodiode is formed, after being reflected on the object 521 to be detected.

Light from the backlight passes through the substrate 501 and the liquid crystal element 505 and is delivered to the object 521 to be detected on the substrate 513 side as indicated by an arrow 560. Then, light reflected by the object 521 to be detected enters the photodiode 502 as indicated by an arrow 562. Note that in this structure, the shielding film 515 is not provided in a region where the light indicated by the arrow 562 passes therethrough. In addition, the color filter 514 is formed using a material through which the light indicated by the arrow 562 passes.

Since the field-effect mobility of holes generated by the photoelectric effect is lower than that of electrons, a pin photodiode has better characteristics when a surface on the p-type semiconductor layer side is used as a light-receiving plane. Here, light which the photodiode 502 receives through the counter substrate 513 is converted into electric signals. Further, light from the semiconductor layer having a conductivity type opposite to that of the semiconductor layer on the light-receiving plane is disturbance light; therefore, the electrode layer 541 is preferably formed using a light-blocking conductive film. Note that a surface on the n-type semiconductor layer side can alternatively be used as the light-receiving plane.

Therefore, in the photodiode 502 of this embodiment, the third semiconductor layer 506c having n-type conductivity, the second semiconductor layer 506b which is a high-resistance semiconductor layer (i-type semiconductor layer), the first semiconductor layer 506a having p-type conductivity, and the electrode layer 542 are stacked in that order over the electrode layer 541 connected to the gate electrode layer 545.

With the above structure, it is possible to provide a touch panel capable of high-speed imaging. In addition, it is possible to provide a method for driving the touch panel capable of high-speed imaging.

Furthermore, it is possible to provide a highly functional touch panel capable of high-speed response with a thin film transistor formed using an oxide semiconductor layer.

### Embodiment 4

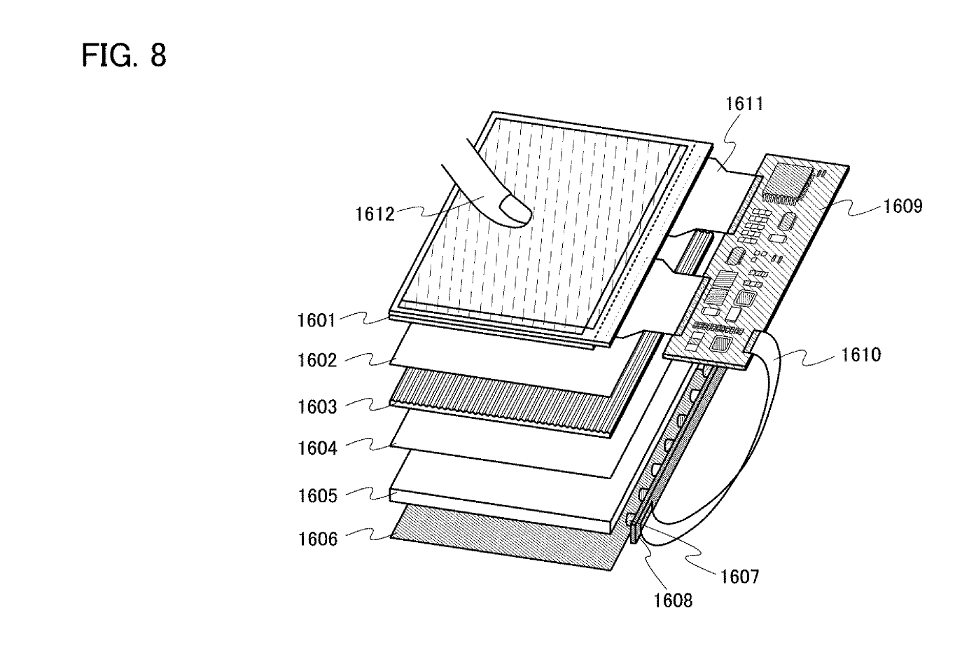

In this embodiment, a structure of a liquid crystal display device provided with a touch panel as an example of a touch panel according to an embodiment of the present invention will be described with reference to FIG. 8.

FIG. 8 illustrates an example of a perspective view showing the structure of a liquid crystal display device provided with a touch sensor which is the touch panel according to an embodiment of the present invention. The liquid crystal display device illustrated in FIG. 8 is provided with a liquid crystal panel 1601 where a pixel including a liquid crystal element, a photodiode, a thin film transistor, and the like is formed between a pair of substrates; a first diffusing plate 1602; a prism sheet 1603; a second diffusing plate 1604; a light guide plate 1605; a reflection plate 1606; a backlight 1608 including a plurality of light sources 1607; and a circuit substrate 1609.

The liquid crystal panel 1601, the first diffusing plate 1602, the prism sheet 1603, the second diffusing plate 1604, the light guide plate 1605, and the reflection plate 1606 are stacked in this order. The light sources 1607 are provided in an end portion of the light guide plate 1605. Light from the light sources 1607 is diffused inside the light guide plate 1605, and passes through the first diffusing plate 1602, the prism sheet 1603, and the second diffusing plate 1604. Thus, the liquid crystal panel 1601 is uniformly irradiated with light from the counter substrate side (one side of the liquid crystal panel 1601, on which the light guide plate 1605 and the like are provided).

Although the first diffusing plate 1602 and the second diffusing plate 1604 are used in this embodiment, the number of diffusing plates is not limited thereto. The number of diffusing plates may be one, or may be three or more. The diffusing plate is acceptable as long as it is provided between the light guide plate 1605 and the liquid crystal panel 1601. Therefore, a diffusing plate may be provided only between the liquid crystal panel 1601 and the prism sheet 1603, or may be provided only between the light guide plate 1605 and the prism sheet 1603.

Further, the cross section of the prism sheet 1603 is not limited to a sawtooth shape illustrated in FIG. 8. The prism sheet 1603 may have a shape with which light from the light guide plate 1605 can be concentrated on the liquid crystal panel 1601 side.

The circuit substrate 1609 is provided with a circuit which generates various kinds of signals inputted to the liquid crystal panel 1601, a circuit which processes the signals, a circuit which processes various signals outputted from the liquid crystal panel 1601, or the like. In FIG. 8, the circuit substrate 1609 and the liquid crystal panel 1601 are connected to each other via a flexible printed circuit (FPC) 1611. Note that the circuit may be connected to the liquid crystal panel 1601 with a chip on glass (COG) method, or part of the circuit may be connected to the FPC 1611 with a chip on film (COF) method.

FIG. 8 illustrates an example in which the circuit substrate 1609 is provided with control circuits which control driving of the light sources 1607, where the control circuits and the light sources 1607 are connected via the FPC 1610. However, the above control circuits may be formed in the liquid crystal panel 1601; in this case, the liquid crystal panel 1601 and the light sources 1607 are connected via an FPC or the like.

Although FIG. 8 illustrates an example of an edge-light type light source in which the light sources 1607 are disposed in an end portion of the liquid crystal panel 1601, a touch panel according to an embodiment of the present invention may be a direct type that includes the light sources 1607 disposed directly below the liquid crystal panel 1601.

When a finger 1612, which is an object to be detected, gets close to the liquid crystal panel 1601 from the TFT substrate side (the side over the liquid crystal panel 1601, which is opposite to the backlight 1608), light from the backlight 1608 passes through the liquid crystal panel 1601, and part of the light is reflected by the finger 1612 and enters the liquid crystal panel 1601 again. Color image data of the finger 1612, which is the object to be detected, can be obtained by the photosensors 106 in the pixels 104 corresponding to individual colors.

This embodiment can be implemented in appropriate combination with any of the above embodiments.

### Embodiment 5

A touch panel according to an embodiment of the present invention has a feature that high-speed imaging can be performed with an operation time of a photosensor secured. In addition, a touch panel according to an embodiment of the present invention has a feature that high-speed imaging can be performed with stable operation of a photosensor. Therefore, an electronic device using the touch panel according to an embodiment of the present invention can be equipped with higher-performance applications by employing the touch panel as its component.

The touch panel according to an embodiment of the present invention can be included in display devices, laptop computers, and image reproducing devices provided with recording media (typically devices which reproduce the content of recording media such as DVDs (digital versatile disc) and have a display for displaying the reproduced images). Other than the above, as an electronic device which can use the touch panel according to an embodiment of the present invention, mobile phones, portable game machines, portable information terminals, e-book readers, video cameras, digital still cameras, goggle-type displays (head mounted displays), navigation systems, audio reproducing devices (e.g., car audio systems and digital audio players), copiers, facsimiles, printers, multifunction printers, automated teller machines (ATM), vending machines, and the like can be given.

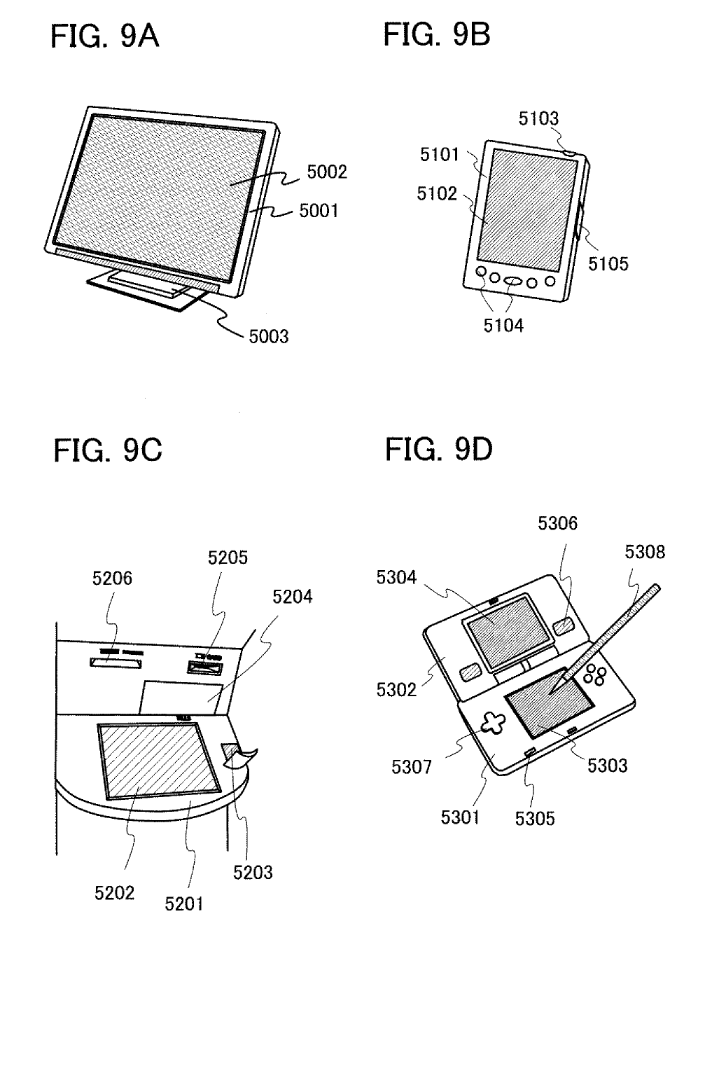

In this embodiment, examples of electronic devices each of which includes a touch panel according to an embodiment of the present invention will be described with reference to FIGS. 9A to 9D.

FIG. 9A illustrates a display device, which includes a housing 5001, a display portion 5002, a supporting base 5003, and the like. The touch panel according to an embodiment of the present invention can be used for the display portion 5002. The use of the touch panel according to an embodiment of the present invention for the display portion 5002 can provide a display device capable of obtaining an image data with high resolution and being equipped with higher-performance applications. Note that a display device includes all display devices for displaying information, such as display devices for personal computers, for receiving television broadcast, and for displaying advertisement, in its category.

FIG. 9B illustrates a portable information terminal, which includes a housing 5101, a display portion 5102, a switch 5103, an operation key 5104, an infrared rays port 5105, and the like. The touch panel according to an embodiment of the present invention can be used for the display portion 5102. The use of the touch panel according to an embodiment of the present invention for the display portion 5102 can provide a portable information terminal capable of obtaining an image data with high resolution and being equipped with higher-performance applications.

FIG. 9C illustrates an automated teller machine, which includes a housing 5201, a display portion 5202, a coin slot 5203, a bill slot 5204, a card slot 5205, a bankbook slot 5206, and the like. The touch panel according to an embodiment of the present invention can be used for the display portion 5202. The use of the touch panel according to an embodiment of the present invention for the display portion 5202 can provide an automated teller machine capable of obtaining an image data with high resolution and being equipped with higher-performance applications. The automated teller machine using the touch panel according to an embodiment of the present invention can read information of living body such as a fingerprint, a face, a handprint, a palm print, a pattern of a hand vein, an iris, and the like which are used for biometrics with higher accuracy. Therefore, a false non-match rate which is false recognition of a person to be identified as a different person and a false acceptance rate which is false recognition of a different person as a person to be identified can be suppressed.

FIG. 9D illustrates a portable game machine, which includes a housing 5301, a housing 5302, a display portion 5303, a display portion 5304, a microphone 5305, a speaker 5306, an operation key 5307, a stylus 5308, and the like. The touch panel according to an embodiment of the present invention can be used for the display portion 5303 or the display portion 5304. The use of a touch panel according to an embodiment of the present invention for the display portion 5303 or the display portion 5304 can provide a portable game machine capable of obtaining an image data with high resolution and being equipped with higher-performance applications. Note that although the portable game machine illustrated in FIG. 9D includes two display portions 5303 and 5304, the number of display portions included in the portable game machine is not limited thereto.

This embodiment can be implemented in appropriate combination with any of the above embodiments.

### Embodiment 6

In this embodiment, an example of a thin film transistor which can be applied to the touch panel disclosed in this specification will be described. A thin film transistor 390 in this embodiment can be used as the thin film transistor formed using an oxide semiconductor layer including a channel formation region in any of the above embodiments (e.g., the transistors 201, 205, 206, and 301 in Embodiment 1, and the transistors 503 and 540 in Embodiments 2 and 3). The same portions as those in the above embodiments and portions having functions similar to those of the portions in the above embodiments and steps similar to those in the above embodiments may be handled as in the above embodiments, and repeated description is omitted. In addition, detailed description of the same portions is also omitted.

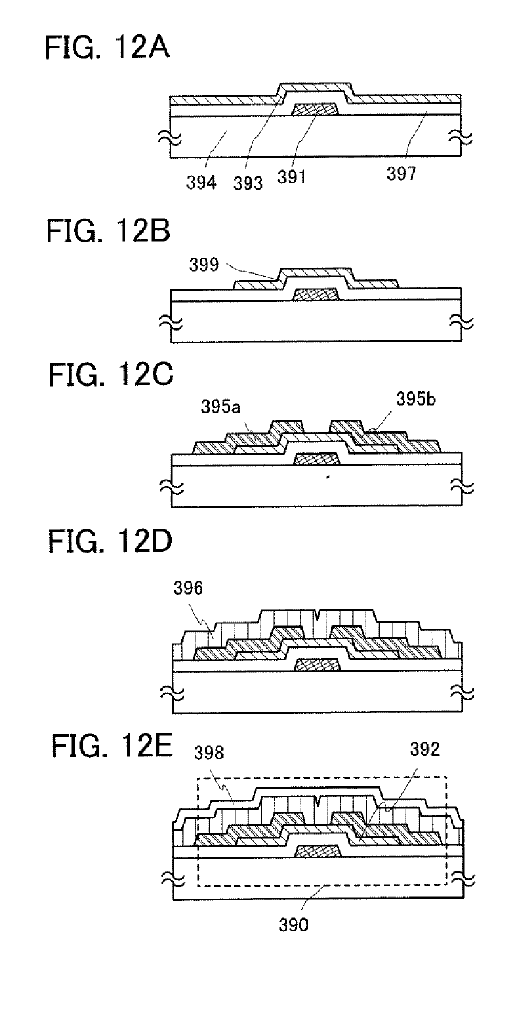

One embodiment of a manufacturing method of the thin film transistor of this embodiment is described with reference to FIGS. 12A to 12E.

FIGS. 12A to 12E illustrate an example of a cross-sectional structure of a thin film transistor. The thin film transistor 390 illustrated in FIGS. 12A to 12E is one of bottom-gate thin film transistors and is also referred to as an inverted staggered thin film transistor.

Although description is given using a single-gate thin film transistor as the thin film transistor 390, a multi-gate thin film transistor including a plurality of channel formation regions may be formed as needed.

A process of manufacturing the thin film transistor 390 over a substrate 394 is described below with reference to FIGS. 12A to 12E.

First, after a conductive film is formed over the substrate 394 having an insulating surface, a gate electrode layer 391 is formed through a first photolithography process. The gate electrode layer preferably has a tapered shape because coverage with a gate insulating layer stacked thereover can be improved. Note that a resist mask may be formed with an ink-jet method. When the resist mask is formed with an ink-jet method, a photomask is not used; therefore, manufacturing costs can be reduced.

There is no particular limitation on a substrate that can be used as the substrate 394 having an insulating surface as long as it has at least heat resistance to withstand heat treatment performed later. A glass substrate formed using barium borosilicate glass, aluminoborosilicate glass, or the like can be used.

When the temperature of the heat treatment performed later is high, a substrate having a strain point of 730° C. or higher is preferably used as the glass substrate. As a material of the glass substrate, a glass material such as aluminosilicate glass, aluminoborosilicate glass, or barium borosilicate glass is used, for example. By containing a larger amount of barium oxide (BaO) than boron oxide, a glass substrate is heat-resistant and of more practical use. Therefore, a glass substrate containing a larger amount of BaO than B₂O₃ is preferably used.

Note that, instead of the glass substrate described above, a substrate formed using an insulator such as a ceramic substrate, a quartz substrate, or a sapphire substrate may be used as the substrate 394. Alternatively, a crystallized glass substrate or the like may be used. Still alternatively, a plastic substrate or the like can be used as appropriate.

An insulating film serving as a base film may be provided between the substrate 394 and the gate electrode layer 391. The base film has a function of preventing diffusion of an impurity element from the substrate 394, and can be formed with a single-layer structure or a stacked structure using any of a silicon nitride film, a silicon oxide film, a silicon nitride oxide film, and a silicon oxynitride film.

The gate electrode layer 391 can be formed with a single-layer structure or a stacked structure using any of metal materials such as molybdenum, titanium, chromium, tantalum, tungsten, aluminum, copper, neodymium, and scandium, and an alloy material including any of these materials as a main component.

As a two-layer structure of the gate electrode layer 391, for example, a two-layer structure in which a molybdenum layer is stacked over an aluminum layer, a two-layer structure in which a molybdenum layer is stacked over a copper layer, a two-layer structure in which a titanium nitride layer or a tantalum nitride layer is stacked over a copper layer, a two-layer structure in which a titanium nitride layer and a molybdenum layer are stacked, or a two-layer structure in which a tungsten nitride layer and a tungsten layer are stacked is preferable. As a three-layer structure, a stack of a tungsten layer or a tungsten nitride layer, an alloy layer of aluminum and silicon or an alloy layer of aluminum and titanium, and a titanium nitride layer or a titanium layer is preferable. Note that the gate electrode layer may be formed using a light-transmitting conductive film. A light-transmitting conductive oxide can be given as an example of the light-transmitting conductive oxide film.

Then, a gate insulating layer 397 is formed over the gate electrode layer 391.

The gate insulating layer 397 can be formed with a single-layer structure or a stacked structure using any of a silicon oxide layer, a silicon nitride layer, a silicon oxynitride layer, a silicon nitride oxide layer, an aluminum oxide layer, an aluminum nitride layer, an aluminum oxynitride layer, an aluminum nitride oxide layer, and a hafnium oxide layer with a plasma CVD method, a sputtering method, or the like. In the case where a silicon oxide film is formed with a sputtering method, a silicon target or a quartz target is used as a target and oxygen or a mixed gas of oxygen and argon is used as a sputtering gas.

Here, an oxide semiconductor that becomes intrinsic or substantially intrinsic by removal of impurities (a highly purified oxide semiconductor) is quite susceptible to the interface level or the interface charge; therefore, the interface with the gate insulating layer is important. Thus, the gate insulating layer 397 that is to be in contact with a highly purified oxide semiconductor layer needs to have high quality.

For example, a high-density plasma CVD method using microwaves (2.45 GHz) is preferably adopted because the formed insulating layer can be dense and have high withstand voltage and high quality. When a highly purified oxide semiconductor and a high-quality gate insulating layer are in contact with each other, the number of the interface levels can be reduced and interface characteristics can be favorable.

It is needless to say that another film formation method such as a sputtering method or a plasma CVD method can be employed as long as a high-quality insulating layer can be formed as a gate insulating layer. Moreover, it is possible to use, as the gate insulating layer, an insulating layer whose quality and characteristics of an interface with an oxide semiconductor are improved with heat treatment performed after the formation of the insulating layer. In any case, an insulating layer that can reduce interface level density with an oxide semiconductor to form a favorable interface, as well as having favorable film quality as the gate insulating layer, is formed.

The gate insulating layer 397 may have a structure where a nitride insulating layer and an oxide insulating layer are stacked over the gate electrode layer 391. For example, a silicon nitride layer (SiN_{y} (y>0)) having a thickness of greater than or equal to 50 nm and less than or equal to 200 nm is formed with a sputtering method as a first gate insulating layer and a silicon oxide layer (SiOₓ(x>0)) having a thickness of greater than or equal to 5 nm and less than or equal to 300 nm is stacked as a second gate insulating layer over the first gate insulating layer. The thickness of the gate insulating layer may be set as appropriate depending on characteristics needed for a thin film transistor and may be approximately 350 nm to 400 nm.

An oxide semiconductor layer 393 is formed over the gate insulating layer 397. Here, if an impurity is included in the oxide semiconductor layer 393, a bond between the impurity and a main component of the oxide semiconductor is cleaved by a stress such as high electric field or high temperature to result in a dangling bond, which causes a shift of the threshold voltage (Vth).

Therefore, the oxide semiconductor layer 393 and the gate insulating layer 397 which contacts with the oxide semiconductor layer 393 are formed so that impurities, particularly hydrogen and water, are included therein as little as possible, which allows formation of the thin layer transistor 390 with stable characteristics.

In order that hydrogen, a hydroxyl group, and moisture might be contained in the gate insulating layer 397 and the oxide semiconductor layer 393 as little as possible, it is preferable that the substrate 394 over which the gate electrode layer 391 is formed or the substrate 394 over which layers up to the gate insulating layer 397 are formed be preheated in a preheating chamber of a sputtering apparatus and the like as pretreatment for film formation so that impurities such as hydrogen and moisture adsorbed to the substrate 394 is eliminated. The temperature for the preheating is higher than or equal to 100° C. and lower than or equal to 400° C., preferably, higher than or equal to 150° C. and lower than or equal to 300° C. Note that a cryopump is preferable as an evacuation unit provided in the preheating chamber. Note that this preheating treatment may be omitted. Further, this preheating may be similarly performed on the substrate 394 over which layers up to a source electrode layer 395a and a drain electrode layer 395b have been formed, before formation of an oxide insulating layer 396.

Then, the oxide semiconductor layer 393 having a thickness of greater than or equal to 2 nm and less than or equal to 200 nm is formed over the gate insulating layer 397 (see FIG. 12A).

Note that before the oxide semiconductor layer 393 is formed with a sputtering method, dust attached to a surface of the gate insulating layer 397 is preferably removed with reverse sputtering in which an argon gas is introduced and plasma is generated. The reverse sputtering refers to a method in which an RF power source is used for application of a voltage to the substrate side in an argon atmosphere so that plasma is generated in the vicinity of the substrate to modify a surface of the substrate. Note that instead of an argon atmosphere, a nitrogen atmosphere, a helium atmosphere, an oxygen atmosphere, or the like may be used.

The oxide semiconductor layer 393 is formed with a sputtering method. The oxide semiconductor layer 393 is formed using an In—Ga—Zn—O-based oxide semiconductor layer, an In—Sn—Zn—O-based oxide semiconductor layer, an In—Al—Zn—O-based oxide semiconductor layer, a Sn—Ga—Zn—O-based oxide semiconductor layer, an Al—Ga—Zn—O-based oxide semiconductor layer, a Sn—Al—Zn—O-based oxide semiconductor layer, an In—Zn—O-based oxide semiconductor layer, a Sn—Zn—O-based oxide semiconductor layer, an Al—Zn—O-based oxide semiconductor layer, an In—O-based oxide semiconductor layer, a Sn—O-based oxide semiconductor layer, or a Zn—O-based oxide semiconductor layer. The oxide semiconductor layer 393 can be formed with a sputtering method in a rare gas (typically, argon) atmosphere, an oxygen atmosphere, or a mixed atmosphere containing a rare gas (typically, argon) and oxygen. In the case of employing a sputtering method, a target containing SiO₂ at greater than or equal to 2 wt % and less than or equal to 10 wt % may be used for film formation. In this embodiment, the oxide semiconductor layer 393 is formed with a sputtering method with the use of an In—Ga—Zn—O-based metal oxide target.

As a target for forming the oxide semiconductor layer 393 with a sputtering method, a metal oxide target containing zinc oxide as its main component can be used. As another example of a metal oxide target, a metal oxide target containing In, Ga, and Zn (in a composition ratio, In₂O₃:Ga₂O₃:ZnO=1:1:1 [molar ratio]) can be used. Alternatively, a metal oxide target containing In, Ga, and Zn (the composition ratio of In₂O₃:Ga₂O₃:ZnO=1:1:2 or 1:1:4 [molar ratio]) may be used. The filling rate of a metal oxide target is greater than or equal to 90% and less than or equal to 100%, preferably, greater than or equal to 95% and less than or equal to 99.9%. A dense oxide semiconductor layer is formed using an oxide semiconductor target with a high filling rate.

The substrate is held in a treatment chamber kept under reduced pressure, and the substrate is heated to a temperature of lower than 400° C. Then, a sputtering gas from which hydrogen and moisture are removed is introduced into the treatment chamber from which moisture is being removed, and the oxide semiconductor layer 393 is formed over the substrate 394 with the use of a metal oxide as a target. In order to remove moisture in the treatment chamber, an entrapment vacuum pump is preferably used. For example, a cryopump, an ion pump, or a titanium sublimation pump is preferably used. Further, an evacuation unit may be a turbo molecular pump provided with a cold trap. In the film formation chamber which is evacuated with the cryopump, a hydrogen atom, a compound containing a hydrogen atom, such as water (H₂O), (more preferably, also a compound containing a carbon atom), and the like are removed, whereby the concentration of an impurity contained in the oxide semiconductor layer formed in the film formation chamber can be reduced. By performing film formation by sputtering while removing moisture in the treatment chamber with the use of a cryopump, a substrate temperature in the formation of the oxide semiconductor layer 393 can be higher than or equal to room temperature and lower than 400° C.

An example of the film formation conditions are as follows: the distance between the substrate and the target is 100 mm, the pressure is 0.6 Pa, the DC power is 0.5 kW, and the atmosphere is an oxygen atmosphere (the flow rate of oxygen is 100%). It is preferable that a pulsed DC power source be used because dust can be reduced and the film thickness can be uniform. The oxide semiconductor layer preferably has a thickness of greater than or equal to 5 nm and less than or equal to 30 nm. Note that the appropriate thickness depends on an oxide semiconductor material used and the thickness may be selected in accordance with a material.

Examples of a sputtering method include an RF sputtering method in which a high-frequency power source is used as a sputtering power source, a DC sputtering method, and a pulsed DC sputtering method in which a bias is applied in a pulsed manner. An RF sputtering method is mainly used in the case where an insulating film is formed, and a DC sputtering method is mainly used in the case where a metal film is formed.

There is also a multi-source sputtering apparatus in which a plurality of targets of different materials can be set. With the multi-source sputtering apparatus, films of different materials can be formed to be stacked in the same chamber, or plural kinds of materials can be discharged for film formation at the same time in the same chamber.

In addition, there are a sputtering apparatus provided with a magnet system inside the chamber and used for a magnetron sputtering method, and a sputtering apparatus used for an ECR sputtering method in which plasma produced with the use of microwaves is used without using glow discharge.

Furthermore, as a film formation method using a sputtering method, there are also a reactive sputtering method in which a target substance and a sputtering gas component are chemically reacted with each other during film formation to form a thin compound film thereof, and a bias sputtering method in which voltage is also applied to a substrate during film formation.

Then, through a second photolithography process, the oxide semiconductor layer is processed into an island-shaped oxide semiconductor layer 399 (see FIG. 12B). A resist mask for forming the island-shaped oxide semiconductor layer 399 may be formed with an ink-jet method. When the resist mask is formed with an ink-jet method, a photomask is not used; therefore, manufacturing costs can be reduced.

At the time of forming the oxide semiconductor layer 399, a contact hole can be formed in the gate insulating layer 397.

Note that the etching of the oxide semiconductor layer 393 may be dry etching, wet etching, or both dry etching and wet etching.

As the etching gas for dry etching, a gas containing chlorine (chlorine-based gas such as chlorine (Cl₂), boron chloride (BCl₃), silicon chloride (SiCl₄), or carbon tetrachloride (CCl₄)) is preferably used.

Alternatively, a gas containing fluorine (fluorine-based gas such as carbon tetrafluoride (CF₄), sulfur hexafluoride (SF₆), nitrogen trifluoride (NF₃), or trifluoromethane (CHF₃)); hydrogen bromide (HBr); oxygen (O₂); any of these gases to which a rare gas such as helium (He) or argon (Ar) is added; or the like can be used.

As the dry etching method, a parallel plate RIE (reactive ion etching) method or an ICP (inductively coupled plasma) etching method can be used. In order to etch the film into a desired shape, the etching conditions (the amount of electric power applied to a coil-shaped electrode, the amount of electric power applied to an electrode on the substrate side, the temperature of the electrode on the substrate side, or the like) are adjusted as appropriate.

As an etchant used for wet etching, a mixed solution of phosphoric acid, acetic acid, and nitric acid, an ammonia hydrogen peroxide mixture (hydrogen peroxide (31 wt % in water):ammonia water of 28 wt %:water=5:2:2), or the like can be used. Alternatively, ITO07N (produced by Kanto Chemical Co., Inc.) may be used.

The etchant used in the wet etching is removed by cleaning together with the material which is etched off. The waste liquid of the etchant containing the material etched off may be purified and the material may be reused. When a material such as indium included in the oxide semiconductor layer is collected from the waste liquid after the etching and reused, the resources can be efficiently used and the cost can be reduced.

The etching conditions (such as an etchant, etching time, and temperature) are adjusted as appropriate depending on the material so that the oxide semiconductor film can be etched to have a desired shape.

Note that it is preferable to perform reverse sputtering before formation of a conductive film in the following step so that a resist residue and the like attached to surfaces of the oxide semiconductor layer 399 and the gate insulating layer 397 can be removed.

Next, a conductive film is formed over the gate insulating layer 397 and the oxide semiconductor layer 399. The conductive film may be formed with a sputtering method or a vacuum evaporation method. As the material of the conductive film to be the source and drain electrode layers (including a wiring formed in the same layer as the source and drain electrode layers), there are an element selected from Al, Cr, Cu, Ta, Ti, Mo, or W; an alloy including any of the above elements as its component; an alloy including a combination of any of the above elements; and the like. Alternatively, a structure may be employed in which a high-melting-point metal layer of Cr, Ta, Ti, Mo, W, or the like is stacked over one of or both of metal layers of Al, Cu, and the like. Still alternatively, when an Al material to which an element preventing generation of hillocks and whiskers in an Al film, such as Si, Ti, Ta, W, Mo, Cr, Nd, Sc, or Y, is added is used, heat resistance can be increased.

The conductive film may have a single-layer structure or a stacked structure of two or more layers. For example, a single-layer structure of an aluminum film containing silicon, a two-layer structure in which a titanium film is stacked over an aluminum film, a three-layer structure in which a titanium film, an aluminum film, and a titanium film are stacked in the order presented, and the like can be given.

Alternatively, the conductive film to be the source and drain electrode layers (including a wiring formed in the same layer as the source and drain electrode layers) may be formed using a conductive metal oxide. As the conductive metal oxide, indium oxide (In₂O₃), tin oxide (SnO₂), zinc oxide (ZnO), a mixed oxide of indium oxide and tin oxide (In₂O₃—SnO₂, abbreviated to ITO), a mixed oxide of indium oxide and zinc oxide (In₂O₃—ZnO), or any of the metal oxides containing silicon or silicon oxide can be used.

A third photolithography process is performed. A resist mask is formed over the conductive film and selective etching is performed, so that the source electrode layer 395a and the drain electrode layer 395b are formed. Then, the resist mask is removed (see FIG. 12C).

Ultraviolet, a KrF laser beam, or an ArF laser beam is used for light exposure for forming the resist mask in the third photolithography process. A channel length L of the thin film transistor to be formed later depends on a width of an interval between a bottom portion of the source electrode layer 395a and a bottom portion of the drain electrode layer 395b which are adjacent to each other over the oxide semiconductor layer 399. Note that when light exposure is performed in the case where the channel length L is shorter than 25 nm, extreme ultraviolet with extremely short wavelengths of several nanometers to several tens of nanometers is used for light exposure for forming the resist mask in the third photolithography process. Light exposure with extreme ultraviolet leads to a high resolution and a large depth of field. Accordingly, the channel length L of the thin film transistor to be formed later can be set to greater than or equal to 10 nm and less than or equal to 1000 nm. Thus, the operation speed of a circuit can be increased. Further, since an off-state current is significantly small for the thin film transistors of this embodiment, low power consumption can be achieved.

Note that materials and etching conditions are adjusted as appropriate so that the oxide semiconductor layer 399 is not completely removed when the conductive film is etched.

In this embodiment, a titanium film is used as the conductive film, an In—Ga—Zn—O-based oxide semiconductor is used as the oxide semiconductor layer 399, and an ammonia hydrogen peroxide mixture (hydrogen peroxide 31 wt % in water:ammonia water of 28 wt %:water=5:2:2) is used as an etchant.

Note that in the third photolithography process, part of the oxide semiconductor layer 399 may be etched, whereby an oxide semiconductor layer having a groove (a depressed portion) may be formed. The resist mask used for forming the source electrode layer 395a and the drain electrode layer 395b may be formed with an ink-jet method. When the resist mask is formed with an ink-jet method, a photomask is not used; therefore, manufacturing costs can be reduced.

In order to reduce the number of photomasks and steps in a photolithography step, etching may be performed with the use of a resist mask formed using a multi-tone mask which is a light-exposure mask through which light is transmitted so as to have a plurality of intensities. Since a resist mask formed using a multi-tone mask has a plurality of thicknesses and can be further changed in shape by performing etching, the resist mask can be used in a plurality of etching steps to provide different patterns. Thus, a resist mask corresponding to at least two kinds of different patterns can be formed by using a multi-tone mask. Accordingly, the number of light-exposure masks can be reduced and the number of corresponding photolithography steps can be also reduced, whereby simplification of a process can be realized.

With plasma treatment with a gas such as N₂O, N₂, or Ar, water adsorbed to a surface of an exposed portion of the oxide semiconductor layer may be removed. Alternatively, plasma treatment may be performed using a mixed gas of oxygen and argon.

In the case where the plasma treatment is performed, the oxide insulating layer 396 is sequentially formed without exposure of the substrate 394 to the air (see FIG. 12D). Note that the oxide insulating layer 396 is in contact with part of the oxide semiconductor layer 399 and serves as a protective insulating film. In this embodiment, the oxide insulating layer 396 is formed in contact with the oxide semiconductor layer 399 in a region where the oxide semiconductor layer 399 does not overlap with the source electrode layer 395a and the drain electrode layer 395b.

In this embodiment, a silicon oxide layer having a defect is formed as the oxide insulating layer 396 with the use of a silicon target at a room temperature or a temperature lower than 100° C. under a sputtering gas atmosphere from which hydrogen and moisture are removed and which contains high-purity oxygen.

For example, a silicon oxide film is formed with a pulsed DC sputtering method in which the purity of a sputtering gas is 6N, a boron-doped silicon target (the resistivity is 0.01 Ωcm) is used, the distance between the substrate and the target (T-S distance) is 89 mm, the pressure is 0.4 Pa, the DC power source is 6 kW, and the atmosphere is an oxygen atmosphere (the proportion of the oxygen flow is 100%). The thickness of the silicon oxide film is 300 nm. Note that instead of a silicon target, quartz (preferably, synthetic quartz) can be used as a target for forming the silicon oxide film. As a sputtering gas, oxygen or a mixed gas of oxygen and argon is used.

In that case, the oxide insulating layer 396 is preferably formed after removing moisture in the treatment chamber. This is for preventing hydrogen, a hydroxyl group, and moisture from being contained in the oxide semiconductor layer 399 and the oxide insulating layer 396.

In order to remove moisture in the treatment chamber, an entrapment vacuum pump is preferably used. For example, a cryopump, an ion pump, or a titanium sublimation pump is preferably used. Further, an evacuation unit may be a turbo molecular pump provided with a cold trap. In the film formation chamber which is evacuated with the cryopump, a hydrogen atom, a compound containing a hydrogen atom, such as water (H₂O), and the like are removed, whereby the concentration of an impurity contained in the oxide semiconductor layer 396 formed in the film formation chamber can be reduced.

Note that as the oxide insulating layer 396, a silicon oxynitride layer, an aluminum oxide layer, an aluminum oxynitride layer, or the like may be used instead of the silicon oxide layer.

Further, heat treatment may be performed at 100° C. to 400° C. while the oxide insulating layer 396 and the oxide semiconductor layer 399 are in contact with each other. Since the oxide insulating layer 396 in this embodiment has many defects, with this heat treatment, an impurity such as hydrogen, moisture, a hydroxyl group, or a hydride contained in the oxide semiconductor layer 399 can be diffused to the oxide insulating layer 396 so that the impurity contained in the oxide semiconductor layer 399 can be further reduced.

Through the above steps, the thin film transistor 390 including an oxide semiconductor layer 392 in which the concentration of hydrogen, moisture, a hydroxyl group, or a hydride is reduced can be formed (see FIG. 12E).

Moisture in a reaction atmosphere is removed as described above at the time of forming the oxide semiconductor layer, whereby the concentration of hydrogen and hydride in the oxide semiconductor layer can be reduced. Accordingly, the oxide semiconductor layer can be stable.

A protective insulating layer may be provided over the oxide insulating layer. In this embodiment, a protective insulating layer 398 is formed over the oxide insulating layer 396. As the protective insulating layer 398, a silicon nitride film, a silicon nitride oxide film, an aluminum nitride film, an aluminum nitride oxide film, or the like is used.

The substrate 394 over which layers up to the oxide insulating layer 396 have been formed is heated to a temperature of 100° C. to 400° C., a sputtering gas from which hydrogen and moisture are removed and which contains high-purity nitrogen is introduced, and a silicon target is used, whereby a silicon nitride film is formed as the protective insulating layer 398. In this case, the protective insulating layer 398 is preferably formed after removing moisture in a treatment chamber, in a manner similar to that of the oxide insulating layer 396.

In the case where the protective insulating layer 398 is formed, the substrate 394 is heated to 100° C. to 400° C. at the time of forming the protective insulating layer 398, whereby hydrogen or water contained in the oxide semiconductor layer 392 can be diffused to the oxide insulating layer 396. In that ease, heat treatment is not necessarily performed after formation of the oxide insulating layer 396.

In the case where the silicon oxide layer is formed as the oxide insulating layer 396 and the silicon nitride layer is stacked thereover as the protective insulating layer 398, the silicon oxide layer and the silicon nitride layer can be formed with the use of a common silicon target in the same treatment chamber. After a sputtering gas containing oxygen is introduced first, a silicon oxide layer is formed using a silicon target provided in the treatment chamber, and then, the sputtering gas is switched to nitrogen and the same silicon target is used to form a silicon nitride layer. Since the silicon oxide layer and the silicon nitride layer can be formed successively without exposing the oxide insulating layer 396 to the air, impurities such as hydrogen and moisture can be prevented from adsorbing onto a surface of the oxide insulating layer 396. After the protective insulating layer 398 is formed, heat treatment (at a temperature of 100° C. to 400° C.) for diffusing hydrogen or moisture contained in the oxide semiconductor layer to the oxide insulating layer may be performed.

After the protective insulating layer is formed, heat treatment may be further performed at a temperature of higher than or equal to 100° C. and lower than or equal to 200° C. for longer than or equal to one hour and shorter than or equal to 30 hours in the air. This heat treatment may be performed at a fixed heating temperature. Alternatively, the following change in the heating temperature may be performed plural times repeatedly: the heating temperature is increased from a room temperature to a temperature of higher than or equal to 100° C. and lower than or equal to 200° C. and then decreased to room temperature. Further, this heat treatment may be performed under a reduced pressure. Under a reduced pressure, the heating time can be shortened. With this heat treatment, reliability of a touch panel can be further improved.

As mentioned above, moisture in a reaction atmosphere is removed at the time of forming the oxide semiconductor layer to be a channel formation region over the gate insulating layer, whereby the concentration of hydrogen and hydride in the oxide semiconductor layer can be reduced.

The above steps can be used for manufacture of backplanes (substrates over which thin film transistors are formed) of liquid crystal display panels, electroluminescent display panels, display devices using electronic ink, or the like. Since the above steps can be performed at a temperature of 400° C. or lower, they can also be applied to manufacturing steps where a glass substrate with a thickness of 1 mm or smaller and a side of longer than 1 m is used. In addition, all of the above steps can be performed at a treatment temperature of 400° C. or lower; therefore, display panels can be manufactured without consuming much energy.

This embodiment can be implemented in appropriate combination with any of the other embodiments.

Thus, with a thin film transistor formed using an oxide semiconductor layer, a large touch panel having stable electric characteristics and high reliability can be provided.

### Embodiment 7

In this embodiment, an example of a thin film transistor which can be applied to the touch panel disclosed in this specification will be described. A thin film transistor 310 in this embodiment can be used as the thin film transistor formed using an oxide semiconductor layer including a channel formation region in any of the above embodiments (e.g., the transistors 201, 205, 206, and 301 in Embodiment 1, and the transistors 503 and 540 in Embodiments 2 and 3). The same portions as those in the above embodiments and portions having functions similar to those of the portions in the above embodiments and steps similar to those in the above embodiments may be handled as in the above embodiments, and repeated description is omitted. In addition, detailed description of the same portions is also omitted.

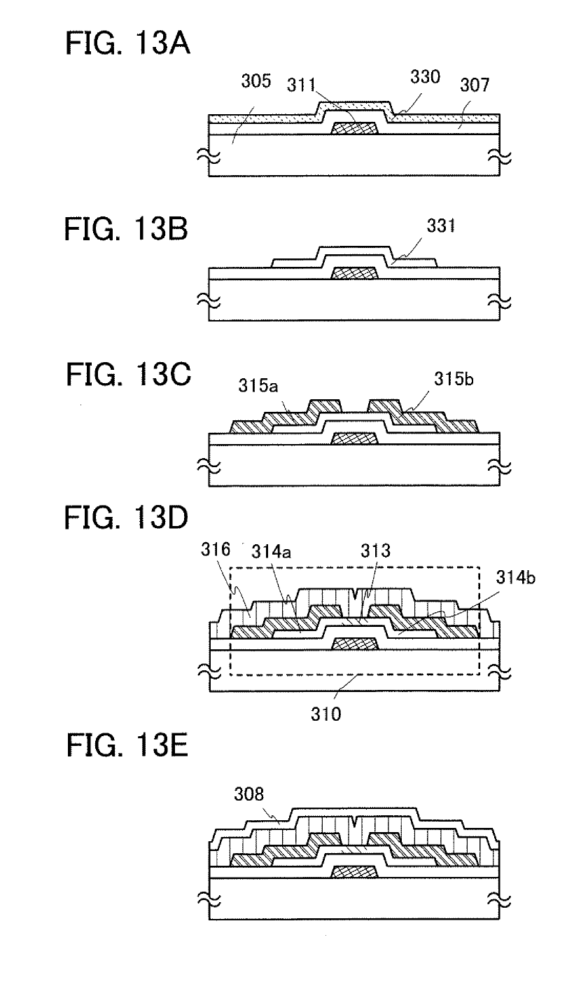

One embodiment of a manufacturing method of the thin film transistor of this embodiment is described with reference to FIGS. 13A to 13E.

FIGS. 13A to 13E illustrate an example of a cross-sectional structure of a thin film transistor. The thin film transistor 310 illustrated in FIGS. 13A to 13E is one of bottom-gate thin film transistors and is also referred to as an inverted staggered thin film transistor.

Although description is given using a single-gate thin film transistor as the thin film transistor 310, a multi-gate thin film transistor including a plurality of channel formation regions may be formed as needed.

A process of manufacturing the thin film transistor 310 over a substrate 305 is described below with reference to FIGS. 13A to 13E.

First, after a conductive film is formed over the substrate 305 having an insulating surface, a gate electrode layer 311 is formed through a first photolithography process. Note that a resist mask may be formed with an ink jet method. When the resist mask is formed with an ink-jet method, a photomask is not used; therefore, manufacturing costs can be reduced.

There is no particular limitation on a substrate that can be used as the substrate 305 having an insulating surface as long as it has at least heat resistance to withstand heat treatment performed later. A glass substrate formed using barium borosilicate glass, aluminoborosilicate glass, or the like can be used.

When the temperature of the heat treatment performed later is high, a substrate having a strain point of 730° C. or higher is preferably used as the glass substrate. As a material of the glass substrate, a glass material such as aluminosilicate glass, aluminoborosilicate glass, or barium borosilicate glass is used, for example. By containing a larger amount of barium oxide (BaO) than boron oxide, a glass substrate is heat-resistant and of more practical use. Therefore, a glass substrate containing a larger amount of BaO than B₂O₃ is preferably used.

Note that, instead of the glass substrate described above, a substrate formed using an insulator such as a ceramic substrate, a quartz substrate, or a sapphire substrate may be used as the substrate 305. Alternatively, a crystallized glass substrate or the like may be used.

An insulating film serving as a base film may be provided between the substrate 305 and the gate electrode layer 311. The base film has a function of preventing diffusion of an impurity element from the substrate 305, and can be formed with a single-layer structure or a stacked structure using any of a silicon nitride film, a silicon oxide film, a silicon nitride oxide film, and a silicon oxynitride film.

The gate electrode layer 311 can be formed with a single-layer structure or a stacked structure using any of metal materials such as molybdenum, titanium, chromium, tantalum, tungsten, aluminum, copper, neodymium, and scandium, and an alloy material including any of these materials as a main component.

As a two-layer structure of the gate electrode layer 311, for example, a two-layer structure in which a molybdenum layer is stacked over an aluminum layer, a two-layer structure in which a molybdenum layer is stacked over a copper layer, a two-layer structure in which a titanium nitride layer or a tantalum nitride layer is stacked over a copper layer, a two-layer structure in which a titanium nitride layer and a molybdenum layer are stacked, or a two-layer structure in which a tungsten nitride layer and a tungsten layer are stacked is preferable. As a three-layer structure, a stack of a tungsten layer or a tungsten nitride layer, an alloy layer of aluminum and silicon or an alloy layer of aluminum and titanium, and a titanium nitride layer or a titanium layer is preferable.

Then, a gate insulating layer 307 is formed over the gate electrode layer 311.

The gate insulating layer 307 can be formed with a single-layer structure or a stacked structure using any of a silicon oxide layer, a silicon nitride layer, a silicon oxynitride layer, a silicon nitride oxide layer, or an aluminum oxide layer with a plasma CVD method, a sputtering method, or the like. For example, a silicon oxynitride layer may be formed with a plasma CVD method with SiH₄, oxygen, and nitrogen for a film formation gas. The thickness of the gate insulating layer 307 is greater than or equal to 100 nm and less than or equal to 500 nm. In the case where the gate insulating layer 307 has a stacked structure, a second gate insulating layer having a thickness of greater than or equal to 5 nm and less than or equal to 300 nm is stacked over a first gate insulating layer having a thickness of greater than or equal to 50 nm and less than or equal to 200 nm inclusive, for example.

In this embodiment, a silicon oxynitride layer having a thickness of 100 nm is formed as the gate insulating layer 307 with a plasma CVD method.

Then, an oxide semiconductor layer 330 having a thickness of greater than or equal to 2 nm and less than or equal to 200 nm is formed over the gate insulating layer 307.

Note that before the oxide semiconductor layer 330 is formed with a sputtering method, dust attached to a surface of the gate insulating layer 307 is preferably removed with reverse sputtering in which an argon gas is introduced and plasma is generated. Note that instead of an argon atmosphere, a nitrogen atmosphere, a helium atmosphere, an oxygen atmosphere, or the like may be used.

The oxide semiconductor layer 330 is formed using an In—Ga—Zn—O-based oxide semiconductor layer, an In—Sn—Zn—O-based oxide semiconductor layer, an In—Al—Zn—O-based oxide semiconductor layer, a Sn—Ga—Zn—O-based oxide semiconductor layer, an Al—Ga—Zn—O-based oxide semiconductor layer, a Sn—Al—Zn—O-based oxide semiconductor layer, an In—Zn—O-based oxide semiconductor layer, a Sn—Zn—O-based oxide semiconductor layer, an Al—Zn—O-based oxide semiconductor layer, an In—O-based oxide semiconductor layer, a Sn—O-based oxide semiconductor layer, or a Zn—O-based oxide semiconductor layer. The oxide semiconductor layer 330 can be formed with a sputtering method in a rare gas (typically, argon) atmosphere, an oxygen atmosphere, or a mixed atmosphere containing a rare gas (typically, argon) and oxygen. In the case of employing a sputtering method, a target containing SiO₂ at greater than or equal to 2 wt % and less than or equal to 10 wt % may be used for film formation. In this embodiment, the oxide semiconductor layer 330 is formed with a sputtering method with the use of an In—Ga—Zn—O-based oxide semiconductor target. FIG. 13A corresponds to a cross-sectional view at this stage.

As a target for forming the oxide semiconductor layer 330 with a sputtering method, a metal oxide target containing zinc oxide as its main component can be used. As another example of a metal oxide target, a metal oxide target containing In, Ga, and Zn (in a composition ratio, In₂O₃:Ga₂O₃:ZnO=1:1:1 [molar ratio]) can be used. Alternatively, a metal oxide target containing in, Ga, and Zn (the composition ratio of In₂O₃:Ga₂O₃:ZnO=1:1:2 or 1:1:4 [molar ratio]) may be used. The filling rate of a metal oxide target is greater than or equal to 90% and less than or equal to 100%, preferably, greater than or equal to 95% and less than or equal to 99.9%. A dense oxide semiconductor layer is formed using an oxide semiconductor target with a high filling rate.

It is preferable to use a high-purity gas from which an impurity such as hydrogen, water, a substance having a hydroxyl group, or a hydride is removed to a concentration of several ppm or several ppb, as a sputtering gas when the oxide semiconductor layer 330 is formed.

The substrate is held in a treatment chamber kept under reduced pressure, and the substrate temperature is set to greater than or equal to 100° C. and less than or equal to 600° C., preferably, greater than or equal to 200° C. and less than or equal to 400° C. Film formation is performed while the substrate is heated, whereby the concentration of an impurity contained in the formed oxide semiconductor layer can be reduced. Further, damages due to sputtering can be reduced. Then, a sputtering gas from which hydrogen and moisture are removed is introduced into the treatment chamber from which moisture is being removed, and the oxide semiconductor layer 330 is formed over the substrate 305 with the use of a metal oxide as a target. In order to remove moisture in the treatment chamber, an entrapment vacuum pump is preferably used. For example, a cryopump, an ion pump, or a titanium sublimation pump is preferably used. Further, an evacuation unit may be a turbo molecular pump provided with a cold trap. In the film formation chamber which is evacuated with the cryopump, a hydrogen atom, a compound containing a hydrogen atom, such as water (H₂O), (more preferably, also a compound containing a carbon atom), and the like are removed, whereby the concentration of an impurity contained in the oxide semiconductor layer formed in the film formation chamber can be reduced.

An example of the film formation conditions are as follows: the distance between the substrate and the target is 100 mm, the pressure is 0.6 Pa, the DC power is 0.5 kW, and the atmosphere is an oxygen atmosphere (the flow rate of oxygen is 100%). It is preferable that a pulsed DC power source be used because dust can be reduced and the film thickness can be uniform. The oxide semiconductor layer preferably has a thickness of greater than or equal to 5 nm and less than or equal to 30 nm. Note that the appropriate thickness depends on an oxide semiconductor material used and the thickness may be selected in accordance with a material.

Then, through a second photolithography process, the oxide semiconductor layer 330 is processed into an island-shaped oxide semiconductor layer. A resist mask for forming the island-shaped oxide semiconductor layer may be formed with an ink-jet method. When the resist mask is formed with an ink-jet method, a photomask is not used; therefore, manufacturing costs can be reduced.

Next, the oxide semiconductor layer is subjected to first heat treatment. With the first heat treatment, dehydration or dehydrogenation of the oxide semiconductor layer can be performed. The temperature of the first heat treatment is higher than or equal to 400° C. and lower than or equal to 750° C., preferably, higher than or equal to 400° C. and lower than the strain point of the substrate. Here, the substrate is introduced into an electric furnace which is one of heat treatment apparatuses, and heat treatment is performed on the oxide semiconductor layer in a nitrogen atmosphere at 450° C. for one hour; thus, an oxide semiconductor layer 331 is obtained (see FIG. 13B).

The apparatus for the heat treatment is not limited to the electric furnace and may be the one provided with a device for heating an object to be processed using heat conduction or heat radiation from a heating element such as a resistance heating element. For example, an RTA (rapid thermal anneal) apparatus such as a GRTA (gas rapid thermal anneal) apparatus or an LRTA (lamp rapid thermal anneal) apparatus can be used. An LRTA apparatus is an apparatus for heating an object to be processed by radiation of light (an electromagnetic wave) emitted from a lamp such as a halogen lamp, a metal halide lamp, a xenon arc lamp, a carbon arc lamp, a high pressure sodium lamp, or a high pressure mercury lamp. A GRTA apparatus is an apparatus for heat treatment using a high-temperature gas. As the gas, an inert gas which does not react with an object to be processed in heat treatment, such as nitrogen or a rare gas such as argon is used.

For example, as the first heat treatment, GRTA may be performed as follows. The substrate is transferred and put in an inert gas which has been heated to a high temperature of 650° C. to 700° C., heated for several minutes, and transferred and taken out of the inert gas which has been heated to a high temperature. GRTA enables high-temperature heat treatment in a short time.

Note that in the first heat treatment, it is preferable that water, hydrogen, and the like be not included in nitrogen or a rare gas such as helium, neon, or argon. Alternatively, it is preferable that nitrogen or a rare gas such as helium, neon, or argon introduced into an apparatus for the heat treatment have a purity of 6N (99.9999%) or more, preferably, 7N (99.99999%) or more (that is, an impurity concentration is set to 1 ppm or lower, preferably, 0.1 ppm or lower).

Alternatively, the first heat treatment of the oxide semiconductor layer may be performed on the oxide semiconductor layer 330 which has not yet been processed into the island-shaped oxide semiconductor layer. In that case, after the first heat treatment, the substrate is taken out of the heating apparatus and a photolithography process is performed.

The heat treatment having an effect of dehydration or dehydrogenation on the oxide semiconductor layer may be performed at any of the following timings: after the oxide semiconductor layer is formed; after a source electrode layer and a drain electrode layer are formed over the oxide semiconductor layer; and after a protective insulating film is formed over the source electrode layer and the drain electrode layer.

In the case where a contact hole is formed in the gate insulating layer 307, the step may be performed either before or after dehydration or dehydrogenation of the oxide semiconductor layer 330.

Note that the etching of the oxide semiconductor layer is not limited to wet etching and may be dry etching.

The etching conditions (such as an etchant, etching time, and temperature) are adjusted as appropriate depending on the material so that the oxide semiconductor film can be etched to have a desired shape.

Next, a conductive film to be the source and drain electrode layers (including a wiring formed in the same layer as the source and drain electrode layers) is formed over the gate insulating layer 307 and the oxide semiconductor layer 331. The conductive film may be formed with a sputtering method or a vacuum evaporation method. As the material of the conductive film to be the source and drain electrode layers (including a wiring formed in the same layer as the source and drain electrode layers), there are an element selected from Al, Cr, Cu, Ta, Ti, Mo, or W; an alloy including any of the above elements as its component; an alloy film including a combination of any of the above elements; and the like. Alternatively, a structure may be employed in which a high-melting-point metal layer of Cr, Ta, Ti, Mo, W, or the like is stacked over one of or both of metal layers of Al, Cu, and the like. Still alternatively, when an Al material to which an element preventing generation of hillocks and whiskers in an Al film, such as Si, Ti, Ta, W, Mo, Cr, Nd, Sc, or Y, is added is used, heat resistance can be increased.

The conductive film may have a single-layer structure or a stacked structure of two or more layers. For example, a single-layer structure of an aluminum film containing silicon, a two-layer structure in which a titanium film is stacked over an aluminum film, a three-layer structure in which a titanium film, an aluminum film, and a titanium film are stacked in the order presented, and the like can be given.

Alternatively, the conductive film to be the source and drain electrode layers (including a wiring formed in the same layer as the source and drain electrode layers) may be formed using a conductive metal oxide. As the conductive metal oxide, indium oxide (In₂O₃), tin oxide (SnO₂), zinc oxide (ZnO), a mixed oxide of indium oxide and tin oxide (In₂O₃—SnO₂, abbreviated to ITO), a mixed oxide of indium oxide and zinc oxide (In₂O₃—ZnO), or any of the metal oxides containing silicon or silicon oxide can be used.

If heat treatment is performed after formation of the conductive film, it is preferable that the conductive film have heat resistance enough to withstand the heat treatment.

A third photolithography process is performed. A resist mask is formed over the conductive film and selective etching is performed, so that a source electrode layer 315a and the drain electrode layer 315b are formed. Then, the resist mask is removed (see FIG. 13C).

Ultraviolet, a KrF laser beam, or an ArF laser beam is used for light exposure for forming the resist mask in the third photolithography process. A channel length L of the thin film transistor to be formed later depends on a width of an interval between a bottom portion of the source electrode layer 315a and a bottom portion of the drain electrode layer 315b which are adjacent to each other over the oxide semiconductor layer 331. Note that when light exposure is performed in the case where the channel length L is shorter than 25 nm, extreme ultraviolet with extremely short wavelengths of several nanometers to several tens of nanometers is used for light exposure for forming the resist mask in the third photolithography process. Light exposure with extreme ultraviolet leads to a high resolution and a large depth of field. Accordingly, the channel length L of the thin film transistor to be formed later can be set to greater than or equal to 10 nm and less than or equal to 1000 nm. Thus, the operation speed of a circuit can be increased. Further, an off-state current is significantly small for the thin film transistors of this embodiment, so that low power consumption can be achieved.

Note that materials and etching conditions are adjusted as appropriate so that the oxide semiconductor layer 331 is not completely removed when the conductive film is etched.

In this embodiment, a titanium film is used as the conductive film, an In—Ga—Zn—O-based oxide semiconductor is used as the oxide semiconductor layer 331, and an ammonia hydrogen peroxide mixture (hydrogen peroxide 31 wt % in water:ammonia water of 28 wt %:water=5:2:2) is used as an etchant.

Note that in the third photolithography process, part of the oxide semiconductor layer 331 may be etched, whereby an oxide semiconductor layer having a groove (a depressed portion) may be formed. The resist mask used for forming the source electrode layer 315a and the drain electrode layer 315b may be formed with an ink-jet method. When the resist mask is formed with an ink-jet method, a photomask is not used; therefore, manufacturing costs can be reduced.

Further, an oxide conductive layer may be formed between the oxide semiconductor layer 331 and the source and drain electrode layers 315a and 315b. The oxide conductive layer and the metal layer for forming the source and drain electrode layers can be formed successively. The oxide conductive layer can function as a source region and a drain region.

When the oxide conductive layer is provided as the source region and the drain region between the oxide semiconductor layer 331 and the source and drain electrode layers 315a and 315b, the source region and the drain region can have lower resistance and the transistor can operate at high speed.

In order to reduce the number of photomasks and steps in a photolithography step, etching may be performed with the use of a resist mask formed using a multi-tone mask which is a light-exposure mask through which light is transmitted so as to have a plurality of intensities. Since a resist mask formed using a multi-tone mask has a plurality of thicknesses and can be further changed in shape by performing etching, the resist mask can be used in a plurality of etching steps to provide different patterns. Thus, a resist mask corresponding to at least two kinds of different patterns can be formed by using a multi-tone mask. Accordingly, the number of light-exposure masks can be reduced and the number of corresponding photolithography steps can be also reduced, whereby simplification of a process can be realized.

Next, plasma treatment with a gas such as N₂O, N₂, or Ar is performed. With this plasma treatment, water adsorbed to a surface of an exposed portion of the oxide semiconductor layer is removed. Alternatively, plasma treatment may be performed using a mixed gas of oxygen and argon.

After the plasma treatment is performed, an oxide insulating layer 316 which serves as a protective insulating film and is in contact with part of the oxide semiconductor layer is formed without exposure of the oxide semiconductor layer to the air.

The oxide insulating layer 316 can be formed to a thickness of greater than or equal to 1 nm with a sputtering method or the like as appropriate, which inhibits an impurity such as water or hydrogen from entering the oxide insulating layer 316. If hydrogen is contained in the oxide insulating layer 316, entry of the hydrogen to the oxide semiconductor layer or abstract of oxygen in the oxide semiconductor layer by the hydrogen might be caused, whereby a back channel of the oxide semiconductor layer might decrease in resistance (to be n-type) and thus a parasitic channel might be formed. Therefore, it is important that a formation method in which hydrogen is not used is employed so that the oxide insulating layer 316 is formed containing as little hydrogen as possible.

The oxide insulating layer 316 which is formed in contact with the oxide semiconductor layer is formed using an inorganic insulating film that does not contain impurities such as moisture, a hydrogen ion, and OH⁻ and blocks entry of such impurities from the outside, typically, a silicon oxide film, a silicon oxynitride film, an aluminum oxide film, or an aluminum oxynitride film. In this embodiment, a silicon oxide film is formed to a thickness of 200 nm as the oxide insulating layer 316 with a sputtering method. The substrate temperature at the time of film formation may be higher than or equal to room temperature and lower than or equal to 300° C. and in this embodiment, is 100° C. The silicon oxide film can be formed with a sputtering method in a rare gas (typically, argon) atmosphere, an oxygen atmosphere, or an atmosphere containing a rare gas (typically, argon) and oxygen. Further, a silicon oxide target or a silicon target can be used as a target. For example, the silicon oxide film can be formed using a silicon target with a sputtering method in an atmosphere containing oxygen and nitrogen.

In that case, the oxide insulating layer 316 is preferably formed while removing moisture in the treatment chamber. This is for preventing hydrogen, a hydroxyl group, and moisture from being contained in the oxide semiconductor layer 331 and the oxide insulating layer 316.

In order to remove moisture remaining in the treatment chamber, an entrapment vacuum pump is preferably used. For example, a cryopump, an ion pump, or a titanium sublimation pump is preferably used. Further, an evacuation unit may be a turbo molecular pump provided with a cold trap. In the film formation chamber which is evacuated with the cryopump, a hydrogen atom, a compound containing a hydrogen atom, such as water (H₂O), and the like are removed, whereby the concentration of an impurity in the oxide insulating layer 316 formed in the film formation chamber can be reduced.

It is preferable to use a high-purity gas from which an impurity such as hydrogen, water, a substance having a hydroxyl group, or a hydride is removed to a concentration of several ppm or several ppb, as a sputtering gas when the oxide semiconductor layer 316 is formed.

Next, second heat treatment (preferably, greater than or equal to 200° C. and less than or equal to 400° C., for example, greater than or equal to 250° C. and less than or equal to 350° C.) is performed in an inert gas atmosphere or an oxygen gas atmosphere. For example, the second heat treatment is performed in a nitrogen atmosphere at 250° C. for one hour. In the second heat treatment, the oxide semiconductor layer is heated while part of the oxide semiconductor layer (a channel formation region) is in contact with the oxide insulating layer 316.

Through the above steps, the initially formed oxide semiconductor layer is decreased in resistance by the first heat treatment for dehydration or dehydrogenation, and then part of the oxide semiconductor layer which is in contact with the oxide insulating layer 316 is selectively changed to be in an oxygen excess state by the second heat treatment. As a result, a channel formation region 313 which overlaps with the gate electrode layer 311 becomes intrinsic, and a high-resistance source region 314a and a high-resistance drain region 314b which overlap with the source electrode layer 315a and the drain electrode layer 315b, respectively, are formed in a self-aligned manner. Thus, the thin film transistor 310 is formed through the above steps (see FIG. 13D).

When a silicon oxide layer having many defects is used as the oxide insulating layer 316, the heat treatment after formation of the silicon oxide layer has an effect in diffusing an impurity such as hydrogen, moisture, a substance having a hydroxyl group, or a hydride contained in the oxide semiconductor layer to the oxide insulating layer so that the impurity contained in the oxide semiconductor layer can be further reduced.

Note that by forming the high-resistance drain region 314b (and the high-resistance source region 314a) in the oxide semiconductor layer which overlaps with the drain electrode layer 315b (and the source electrode layer 315a), reliability of the thin film transistor can be improved. Specifically, by forming the high-resistance drain region 314b, the structure can be obtained in which conductivities of the drain electrode layer 315b, the high-resistance drain region 314b, and the channel formation region 313 vary in that order. Therefore, in the case where the thin film transistor operates with the drain electrode layer 315b connected to a wiring for supplying a high power source potential VDD, the high-resistance drain region serves as a buffer and a high electric field is not applied locally even if a high electric field is applied between the gate electrode layer 311 and the drain electrode layer 315b; thus, the withstand voltage of the thin film transistor can be increased.

The high-resistance source region 314a or the high-resistance drain region 314b in the oxide semiconductor layer 331 is formed in the entire thickness direction in the case where the thickness of the oxide semiconductor layer 331 is less than or equal to 15 nm. However, in the case where the thickness of the oxide semiconductor layer 331 is greater than or equal to 30 nm, they are formed only in part of the oxide semiconductor layer 331, that is, in a region, which is in contact with the source electrode layer 315a or the drain electrode layer 315b, and the vicinity thereof. Therefore, a region which is close to the gate insulating film 311 can be made to be i-type.

A protective insulating layer 308 may be additionally formed over the oxide insulating layer 316. The protective insulating layer 308 is formed using an inorganic insulating film which does not contain impurities such as moisture, a hydrogen ion, and OH⁻ and blocks entry of these from the outside. For example, a silicon nitride film, an aluminum nitride film, a silicon nitride oxide film, an aluminum nitride oxide film, or the like is used. For example, a silicon nitride film is formed with an RF sputtering method. An RF sputtering method is preferable as a formation method of the protective insulating layer because of high productivity. In this embodiment, a protective insulating layer 308 is formed using a silicon nitride film (see FIG. 13E).

In this embodiment, the substrate 305 over which layers up to the oxide insulating layer 316 have been formed is heated to a temperature of 100° C. to 400° C., a sputtering gas from which hydrogen and moisture are removed and which contains high-purity nitrogen is introduced, and a silicon target is used, whereby a silicon nitride layer is formed as the protective insulating layer 308. In this case, the protective insulating layer 308 is preferably formed after removing moisture in a treatment chamber in a manner similar to that of the oxide insulating layer 316.

After the protective insulating layer 308 is formed, heat treatment may be further performed at a temperature of higher than or equal to 100° C. and lower than or equal to 200° C. for longer than or equal to one hour and shorter than or equal to 30 hours in the air. This heat treatment may be performed at a fixed temperature. Alternatively, the following change in the heating temperature may be performed plural times repeatedly: the heating temperature is increased from a room temperature to a temperature of higher than or equal to 100° C. and lower than or equal to 200° C. and then decreased to room temperature. Further, this heat treatment may be performed under a reduced pressure. Under a reduced pressure, the heating time can be shortened.

Note that a planarization insulating layer for planarization may be provided over the protective insulating layer 308.

This embodiment can be implemented in appropriate combination with any of the other embodiments.

Thus, with a thin film transistor formed using an oxide semiconductor layer, a large touch panel having stable electric characteristics and high reliability can be provided.

### Embodiment 8

In this embodiment, an example of a thin film transistor which can be applied to the touch panel disclosed in this specification will be described. A thin film transistor 360 in this embodiment can be used as the thin film transistor formed using an oxide semiconductor layer including a channel formation region in any of the above embodiments (e.g., the transistors 201, 205, 206, and 301 in Embodiment 1, and the transistors 503 and 540 in Embodiments 2 and 3). The same portions as those in the above embodiments and portions having functions similar to those of the portions in the above embodiments and steps similar to those in the above embodiments may be handled as in the above embodiments, and repeated description is omitted. In addition, detailed description of the same portions is also omitted.

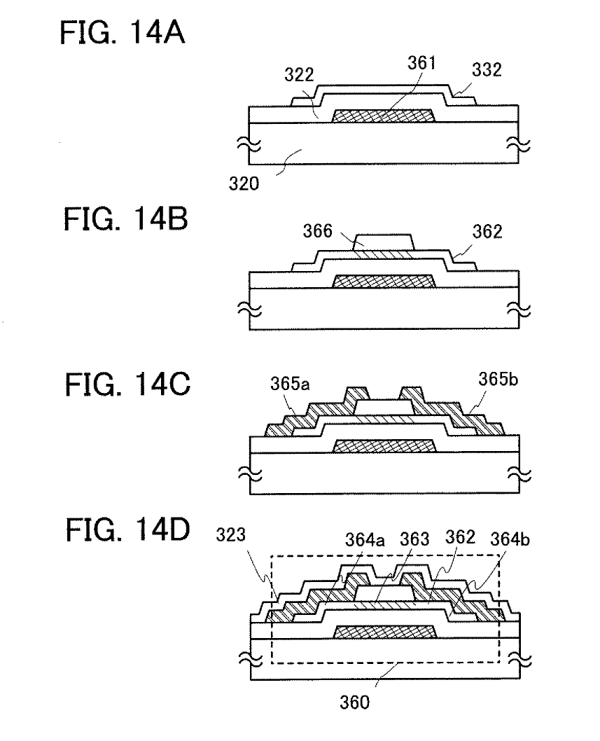

One embodiment of a manufacturing method of the thin film transistor of this embodiment is described with reference to FIGS. 14A to 14D.

FIGS. 14A to 14D illustrate an example of a cross-sectional structure of a thin film transistor. The thin film transistor 360 illustrated in FIGS. 14A to 14D is one of bottom gate thin film transistors, which is called a channel protective thin film transistor (also referred to as a channel-stop thin film transistor), and is also referred to as an inverted staggered thin film transistor

Although description is given using a single-gate thin film transistor as the thin film transistor 360, a multi-gate thin film transistor including a plurality of channel formation regions may be formed as needed.

A process of manufacturing the thin film transistor 360 over a substrate 320 is described below with reference to FIGS. 14A to 14D.

First, after a conductive film is formed over the substrate 320 having an insulating surface, a gate electrode layer 361 is formed through a first photolithography process. Note that a resist mask may be formed with an ink-jet method. When the resist mask is formed with an ink-jet method, a photomask is not used; therefore, manufacturing costs can be reduced.

Further, the gate electrode layer 361 can be formed with a single-layer structure or a stacked structure using any of metal materials such as molybdenum, titanium, chromium, tantalum, tungsten, aluminum, copper, neodymium, and scandium, and an alloy material including any of these materials as a main component.

Then, a gate insulating layer 322 is formed over the gate electrode layer 361.

In this embodiment, a silicon oxynitride layer having a thickness of 100 nm is formed as the gate insulating layer 322 with a plasma CVD method.

Then, an oxide semiconductor film having a thickness of greater than or equal to 2 nm and less than or equal to 200 nm is formed over the gate insulating layer 322 and processed into an island-shaped oxide semiconductor layer through a second photolithography process. In this embodiment, the oxide semiconductor film is formed with a sputtering method with the use of an In—Ga—Zn—O-based metal oxide target.

In that case, the oxide semiconductor film is preferably formed while removing moisture remaining in the treatment chamber. This is for preventing hydrogen, a hydroxyl group, and moisture from being contained in the oxide semiconductor film.

In order to remove moisture remaining in the treatment chamber, an entrapment vacuum pump is preferably used. For example, a cryopump, an ion pump, or a titanium sublimation pump is preferably used. Further, an evacuation unit may be a turbo molecular pump provided with a cold trap. In the film formation chamber which is evacuated with the cryopump, a hydrogen atom, a compound containing a hydrogen atom, such as water (H₂O), and the like are removed, whereby the concentration of an impurity contained in the oxide semiconductor layer formed in the film formation chamber can be reduced.

It is preferable to use a high-purity gas from which an impurity such as hydrogen, water, a hydroxyl group, or hydride is removed to a concentration of several ppm or several ppb, as a sputtering gas used when the oxide semiconductor layer is formed.

Next, the oxide semiconductor layer is subjected to dehydration or dehydrogenation. The temperature of the first heat treatment is higher than or equal to 400° C. and lower than or equal to 750° C., preferably, higher than or equal to 400° C. and lower than the strain point of the substrate. Here, the substrate is introduced into an electric furnace which is one of heat treatment apparatuses, heat treatment is performed on the oxide semiconductor layer in a nitrogen atmosphere at 450° C. for one hour, and then, the oxide semiconductor layer is not exposed to the air so that entry of water and hydrogen into the oxide semiconductor layer is prevented; thus, an oxide semiconductor layer 332 is obtained (see FIG. 14A).

Next, plasma treatment with a gas such as N₂O, N₂, or Ar is performed. With this plasma treatment, water adsorbed to a surface of an exposed portion of the oxide semiconductor layer is removed. Alternatively, plasma treatment may be performed using a mixed gas of oxygen and argon.

Next, an oxide insulating layer is formed over the gate insulating layer 322 and the oxide semiconductor layer 332 and a third photolithography process is performed. A resist mask is formed and selective etching is performed, so that the oxide insulating layer 366 is formed. Then, the resist mask is removed.

In this embodiment, a silicon oxide film is formed to a thickness of 200 nm as the oxide insulating layer 366 with a sputtering method. The substrate temperature at the time of film formation may be higher than or equal to room temperature and lower than or equal to 300° C. and in this embodiment, is 100° C. The silicon oxide film can be formed with a sputtering method in a rare gas (typically, argon) atmosphere, an oxygen atmosphere, or an atmosphere containing a rare gas (typically, argon) and oxygen. Further, a silicon oxide target or a silicon target can be used as a target. For example, the silicon oxide film can be formed using a silicon target with a sputtering method in an atmosphere containing oxygen and nitrogen. The oxide insulating layer 366 which is formed in contact with the oxide semiconductor layer in a region which has a lower resistance is formed using an inorganic insulating film that does not contain impurities such as moisture, a hydrogen ion, and OH⁻ and blocks entry of such impurities from the outside, typically, a silicon oxide film, a silicon oxynitride film, an aluminum oxide film, or an aluminum oxynitride film.

In that case, the oxide insulating layer 366 is preferably formed while removing moisture remaining in the treatment chamber. This is for preventing hydrogen, a hydroxyl group, and moisture from being contained in the oxide semiconductor layer 332 and the oxide insulating layer 366.

In order to remove moisture remaining in the treatment chamber, an entrapment vacuum pump is preferably used. For example, a cryopump, an ion pump, or a titanium sublimation pump is preferably used. Further, an evacuation unit may be a turbo molecular pump provided with a cold trap. In the film formation chamber which is evacuated with the cryopump, a hydrogen atom, a compound containing a hydrogen atom, such as water (H₂O), and the like are removed, whereby the concentration of an impurity contained in the oxide semiconductor layer 366 formed in the film formation chamber can be reduced.

It is preferable to use a high-purity gas from which an impurity such as hydrogen, water, a hydroxyl group, or hydride is removed to a concentration of several ppm or several ppb, as a sputtering gas used when the oxide semiconductor layer 366 is formed.

Next, second heat treatment (preferably, greater than or equal to 200° C. and less than or equal to 400° C., for example, greater than or equal to 250° C. and less than or equal to 350° C.) is performed in an inert gas atmosphere or an oxygen gas atmosphere. For example, the second heat treatment is performed in a nitrogen atmosphere at 250° C. for one hour. With the second heat treatment, heat is applied while part of the oxide semiconductor layer (a channel formation region) is in contact with the oxide insulating layer 366.

In this embodiment, heat treatment is further performed on the oxide semiconductor layer 332 over which the oxide insulating layer 366 is provided and part of the oxide semiconductor layer 332 is exposed, in an inert gas atmosphere such as nitrogen or under reduced pressure. By performing heat treatment in an inert gas atmosphere such as nitrogen or under reduced pressure, the resistance of regions of the oxide semiconductor layer 332, which are not covered with the oxide insulating layer 366 and are thus exposed, can be reduced. For example, heat treatment is performed under a nitrogen atmosphere at 250° C. for one hour.

With the heat treatment for the oxide semiconductor layer 332 provided with the oxide insulating layer 366 under a nitrogen atmosphere, the resistance of the exposed regions of the oxide semiconductor layer 332 is reduced. Thus, an oxide semiconductor layer 362 including regions with different resistances (indicated as shaded regions and white regions in FIG. 14B) are formed.

Next, after a conductive film is formed over the gate insulating layer 322, the oxide semiconductor layer 362, and the oxide insulating layer 366, a fourth photolithography process is performed. A resist mask is formed and selective etching is performed, so that a source electrode layer 365a and a drain electrode layer 365b are formed. Then, the resist mask is removed (see FIG. 14C).

As the material of the source electrode layer 365a and the drain electrode layer 365b, there are an element selected from Al, Cr, Cu, Ta, Ti, Mo, or W; an alloy including any of the above elements as its component; an alloy film including a combination of any of the above elements; and the like. Alternatively, a structure may be employed in which a high-melting-point metal layer of Cr, Ta, Ti, Mo, W, or the like is stacked over one of or both of metal layers of Al, Cu, and the like. Still alternatively, when an Al material to which an element preventing generation of hillocks and whiskers in an Al film, such as Si, Ti, Ta, W, Mo, Cr, Nd, Sc, or Y, is added is used, heat resistance can be increased.

The source electrode layer 365a and the drain electrode layer 365b may have a single-layer structure or a stacked structure of two or more layers. For example, a single-layer structure of an aluminum film containing silicon, a two-layer structure in which a titanium film is stacked over an aluminum film, a three-layer structure in which a titanium film, an aluminum film, and a titanium film are stacked in the order presented, and the like can be given.

Alternatively, the source electrode layer 365a and the drain electrode layer 365b may be formed using a conductive metal oxide. As the conductive metal oxide, indium oxide (In₂O₃), tin oxide (SnO₂), zinc oxide (ZnO), an alloy of indium oxide and tin oxide (In₂O₃—SnO₂, abbreviated to ITO), an alloy of indium oxide and zinc oxide (In₂O₃—ZnO), or any of the metal oxide materials containing silicon or silicon oxide can be used.

Through the above steps, the formed oxide semiconductor layer is decreased in resistance by the heat treatment for dehydration or dehydrogenation, and then part of the oxide semiconductor layer is selectively changed to be in an oxygen excess state. As a result, a channel formation region 363 which overlaps with the gate electrode layer 361 becomes intrinsic, and a high-resistance source region 364a and a high-resistance drain region 364b which overlap with the source electrode layer 365a and the drain electrode layer 365b, respectively, are formed in a self-aligned manner. Thus, the thin film transistor 360 is formed through the above steps.

Note that by forming the high-resistance drain region 364b (and the high-resistance source region 364a) in the oxide semiconductor layer which overlaps with the drain electrode layer 365b (and the source electrode layer 365a), reliability of the thin film transistor can be improved. Specifically, by forming the high-resistance drain region 364b, the structure can be obtained in which conductivities of the drain electrode layer 365b, the high-resistance drain region 364b, and the channel formation region 363 vary. Therefore, in the case where the thin film transistor operates with the drain electrode layer 365b connected to a wiring for supplying a high power source potential VDD, the high-resistance drain region serves as a buffer and a high electric field is not applied locally even if a high electric field is applied between the gate electrode layer 361 and the drain electrode layer 365b; thus, the withstand voltage of the thin film transistor can be increased.

A protective insulating layer 323 is formed over the source electrode layer 365a, the drain electrode layer 365b, and the oxide insulating layer 366. In this embodiment, the protective insulating layer 323 is formed using a silicon nitride film (see FIG. 14D).

Note that an oxide insulating layer may be further formed over the source electrode layer 365a, the drain electrode layer 365b, and the oxide insulating layer 366, and the protective insulating layer 323 may be stacked over the oxide insulating layer.

This embodiment can be implemented in appropriate combination with any of the other embodiments.

Thus, with a thin film transistor formed using an oxide semiconductor layer, a large touch panel having stable electric characteristics and high reliability can be provided.

### Embodiment 9

In this embodiment, an example of a thin film transistor which can be applied to the touch panel disclosed in this specification will be described. A thin film transistor 350 in this embodiment can be used as the thin film transistor formed using an oxide semiconductor layer including a channel formation region in any of the above embodiments (e.g., the transistors 201, 205, 206, and 301 in Embodiment 1, and the transistors 503 and 540 in Embodiments 2 and 3). The same portions as those in the above embodiments and portions having functions similar to those of the portions in the above embodiments and steps similar to those in the above embodiments may be handled as in the above embodiments, and repeated description is omitted. In addition, detailed description of the same portions is also omitted.

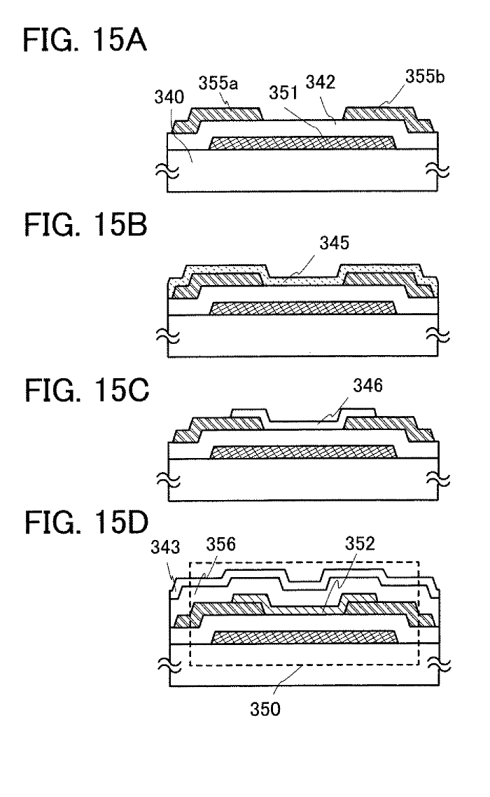

One embodiment of a manufacturing method of the thin film transistor of this embodiment is described with reference to FIGS. 15A to 15D.

Although description is given using a single-gate thin film transistor as the thin film transistor 350, a multi-gate thin film transistor including a plurality of channel formation regions may be formed as needed.

A process of manufacturing the thin film transistor 350 over a substrate 340 is described below with reference to FIGS. 15A to 15D.

First, after a conductive film is formed over the substrate 340 having an insulating surface, a gate electrode layer 351 is formed through a first photolithography process. In this embodiment, a tungsten film having a thickness of 150 nm is formed as the gate electrode layer 351 with a sputtering method.

Then, a gate insulating layer 342 is formed over the gate electrode layer 351. In this embodiment, a silicon oxynitride layer having a thickness of 100 nm is formed as the gate insulating layer 342 by a plasma CVD method.

Next, after a conductive film is formed over the gate insulating layer 342, a second photolithography process is performed. A resist mask is formed and selective etching is performed, so that a source electrode layer 355a and a drain electrode layer 355b are formed. Then, the resist mask is removed (see FIG. 15A).

Then, an oxide semiconductor layer 345 is formed (see FIG. 15B). In this embodiment, the oxide semiconductor layer 345 is formed with a sputtering method with the use of an In—Ga—Zn—O-based metal oxide target. The oxide semiconductor layer 345 is processed into an island-shaped oxide semiconductor layer through a third photolithography process.

In that case, the oxide insulating layer 345 is preferably formed while removing moisture remaining in the treatment chamber. This is for preventing hydrogen, a hydroxyl group, and moisture from being contained in the oxide semiconductor layer 345.

In order to remove moisture remaining in the treatment chamber, an entrapment vacuum pump is preferably used. For example, a cryopump, an ion pump, or a titanium sublimation pump is preferably used. Further, an evacuation unit may be a turbo molecular pump provided with a cold trap. In the film formation chamber which is evacuated with the cryopump, a hydrogen atom, a compound containing a hydrogen atom, such as water (H₂O), and the like are removed, whereby the concentration of an impurity contained in the oxide semiconductor layer 345 formed in the film formation chamber can be reduced.

It is preferable to use a high-purity gas from which an impurity such as hydrogen, water, a hydroxyl group, or hydride is removed to a concentration of several ppm or several ppb, as a sputtering gas used when the oxide semiconductor layer 345 is formed.

Next, the oxide semiconductor layer is subjected to dehydration or dehydrogenation. The temperature of the first heat treatment is higher than or equal to 400° C. and lower than or equal to 750° C., preferably, higher than or equal to 400° C. and lower than the strain point of the substrate. Here, the substrate is introduced into an electric furnace which is one of heat treatment apparatuses, heat treatment is performed on the oxide semiconductor layer in a nitrogen atmosphere at 450° C. for one hour, and then, the oxide semiconductor layer is not exposed to the air so that entry of water and hydrogen into the oxide semiconductor layer is prevented; thus, an oxide semiconductor layer 346 is obtained (see FIG. 15C).

For example, as the first heat treatment, GRTA may be performed as follows. The substrate is transferred and put in an inert gas which has been heated to a high temperature of 650° C. to 700° C., heated for several minutes, and transferred and taken out of the inert gas which has been heated to a high temperature. GRTA enables high-temperature heat treatment in a short time.

Then, an oxide insulating layer 356 which serves as a protective insulating film and is in contact with the oxide semiconductor layer 346 is formed.

The oxide insulating layer 356 can be formed to a thickness of greater than or equal to 1 nm with a sputtering method or the like as appropriate, which is a method with which an impurity such as water or hydrogen does not enter the oxide insulating layer 356. When hydrogen is contained in the oxide insulating layer 356, entry of the hydrogen to the oxide semiconductor layer or extraction of oxygen in the oxide semiconductor layer by the hydrogen is caused, whereby a back channel of the oxide semiconductor layer comes to have a lower resistance (to be n-type) and thus a parasitic channel might be formed. Therefore, it is important that a formation method in which hydrogen is not used is employed so that the oxide insulating layer 356 is formed containing as little hydrogen as possible.

In this embodiment, a silicon oxide film is formed to a thickness of 200 nm as the oxide insulating layer 356 with a sputtering method. The substrate temperature at the time of film formation may be higher than or equal to room temperature and lower than or equal to 300° C. and in this embodiment, is 100° C. The silicon oxide film can be formed with a sputtering method in a rare gas (typically, argon) atmosphere, an oxygen atmosphere, or an atmosphere containing a rare gas (typically, argon) and oxygen. Further, a silicon oxide target or a silicon target can be used as a target. For example, the silicon oxide film can be formed using a silicon target with a sputtering method under an atmosphere containing oxygen and nitrogen. The oxide insulating layer 356 which is formed in contact with the oxide semiconductor layer in a region which has a lower resistance is formed using an inorganic insulating film that does not contain impurities such as moisture, a hydrogen ion, and OH⁻ and blocks entry of such impurities from the outside, typically, a silicon oxide film, a silicon oxynitride film, an aluminum oxide film, or an aluminum oxynitride film.

In that case, the oxide insulating layer 356 is preferably formed while removing moisture remaining in the treatment chamber. This is for preventing hydrogen, a hydroxyl group, and moisture from being contained in an oxide semiconductor layer 352 and the oxide insulating layer 356.

In order to remove moisture remaining in the treatment chamber, an entrapment vacuum pump is preferably used. For example, a cryopump, an ion pump, or a titanium sublimation pump is preferably used. Further, an evacuation unit may be a turbo molecular pump provided with a cold trap. In the film formation chamber which is evacuated with the cryopump, a hydrogen atom, a compound containing a hydrogen atom, such as water (H₂O), and the like are removed, whereby the concentration of an impurity in the oxide semiconductor layer 356 formed in the film formation chamber can be reduced.

It is preferable to use a high-purity gas from which an impurity such as hydrogen, water, a hydroxyl group, or hydride is removed to a concentration of several ppm or several ppb, as a sputtering gas used when the oxide semiconductor layer 356 is formed.

Next, second heat treatment (preferably, greater than or equal to 200° C. and less than or equal to 400° C., for example, greater than or equal to 250° C. and less than or equal to 350° C.) is performed under an inert gas atmosphere or an oxygen gas atmosphere. For example, the second heat treatment is performed under a nitrogen atmosphere at 250° C. for one hour. With the second heat treatment, heat is applied while part of the oxide semiconductor layer (a channel formation region) is in contact with the oxide insulating layer 356.

Through the above steps, the formed oxide semiconductor layer is decreased in resistance by the heat treatment for dehydration or dehydrogenation, and then part of the oxide semiconductor layer is selectively changed to be in an oxygen excess state. As a result, the i-type oxide semiconductor layer 352 is formed. Thus, the thin film transistor 350 is formed through the above steps.

A protective insulating layer may be additionally formed over the oxide insulating layer 356. For example, a silicon nitride film is formed with an RF sputtering method. In this embodiment, as the protective insulating layer, a protective insulating layer 343 is formed using a silicon nitride film (see FIG. 15D).

Note that a planarization insulating layer for planarization may be provided over the protective insulating layer 343.

This embodiment can be implemented in appropriate combination with any of the other embodiments.

Thus, with a thin film transistor formed using an oxide semiconductor layer, a large touch panel having stable electric characteristics and high reliability can be provided.

### Embodiment 10

In this embodiment, an example of a thin film transistor which can be applied to the touch panel disclosed in this specification will be described. A thin film transistor 380 in this embodiment can be used as the thin film transistor formed using an oxide semiconductor layer including a channel formation region in any of the above embodiments (e.g., the transistors 201, 205, 206, and 301 in Embodiment 1, and the transistors 503 and 540 in Embodiments 2 and 3).

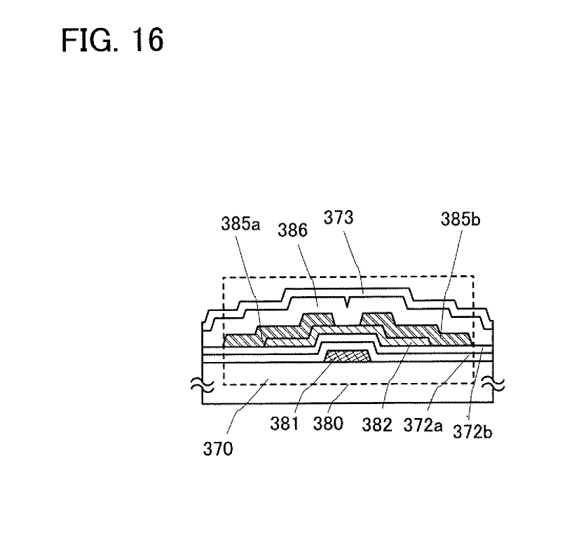

In this embodiment, an example which is partly different from Embodiment 7 in the manufacturing process of a thin film transistor will be described with reference to FIG. 16. Since FIG. 16 is the same as FIGS. 13A to 13E except for part of the steps, common reference numerals are used for the same portions, and detailed description of the same portions is omitted.

According to Embodiment 7, a gate electrode layer 381 is formed over a substrate 370, and a first gate insulating layer 372a and a second gate insulating layer 372b are stacked thereover. In this embodiment, a gate insulating layer has a two-layer structure in which a nitride insulating layer and an oxide insulating layer are used as the first gate insulating layer 372a and the second gate insulating layer 372b, respectively.

As the oxide insulating layer, a silicon oxide layer, a silicon oxynitride layer, an aluminum oxide layer, an aluminum oxynitride layer, a hafnium oxide layer, or the like may be used. As the nitride insulating layer, a silicon nitride layer, a silicon nitride oxide layer, an aluminum nitride layer, an aluminum nitride oxide layer, or the like may be used.

In this embodiment, the gate insulating layer may have a structure where a silicon nitride layer and a silicon oxide layer are stacked over the gate electrode layer 381. For example, a silicon nitride layer (SiN_{y}(y>0)) having a thickness of greater than or equal to 50 nm and less than or equal to 200 nm (in this embodiment, 50 nm) is formed with a sputtering method as the first gate insulating layer 372a and a silicon oxide layer (SiOₓ (x>0)) having a thickness of greater than or equal to 5 nm and less than or equal to 300 nm (in this embodiment, 100 nm) is stacked as the second gate insulating layer 372b over the first gate insulating layer 372a; thus, the gate insulating layer having a thickness of 150 nm may be formed.

Next, the oxide semiconductor film is formed and then processed into an island-shaped oxide semiconductor layer through a photolithography process. In this embodiment, the oxide semiconductor film is formed with a sputtering method with the use of an In—Ga—Zn—O-based metal oxide target.

In that case, the oxide semiconductor film is preferably formed while removing moisture remaining in the treatment chamber. This is for preventing hydrogen, a hydroxyl group, and moisture from being contained in the oxide semiconductor film.

In order to remove moisture remaining in the treatment chamber, an entrapment vacuum pump is preferably used. For example, a cryopump, an ion pump, or a titanium sublimation pump is preferably used. Further, an evacuation unit may be a turbo molecular pump provided with a cold trap. In the film formation chamber which is evacuated with the cryopump, a hydrogen atom, a compound containing a hydrogen atom, such as water (H₂O), and the like are removed, whereby the concentration of an impurity contained in the oxide semiconductor layer formed in the film formation chamber can be reduced.

It is preferable to use a high-purity gas from which an impurity such as hydrogen, water, a hydroxyl group, or hydride is removed to a concentration of several ppm or several ppb, as a sputtering gas used when the oxide semiconductor layer is formed.

Next, the oxide semiconductor layer is subjected to dehydration or dehydrogenation. The temperature of first heat treatment for dehydration or dehydrogenation is higher than or equal to 400° C. and lower than or equal to 750° C., preferably, higher than or equal to 425° C. Note that in the case of the temperature that is 425° C. or higher, the heat treatment time may be one hour or less, whereas in the case of the temperature lower than 425° C., the heat treatment time is longer than one hour. Here, the substrate is introduced into an electric furnace which is one of heat treatment apparatuses, heat treatment is performed on the oxide semiconductor layer under a nitrogen atmosphere, and then, the oxide semiconductor layer is not exposed to the air so that entry of water and hydrogen into the oxide semiconductor layer is prevented. Thus, the oxide semiconductor layer is obtained. After that, a high-purity oxygen gas, a high-purity N₂O gas, or an ultra-dry air (with a dew point of −40° C. or lower, preferably, −60° C. or lower) is introduced into the same furnace and cooling is performed. It is preferable that water, hydrogen, and the like be not contained in the oxygen gas or the N₂O gas. Alternatively, the purity of the oxygen gas or the N₂O gas which is introduced into the heat treatment apparatus is preferably 6N (99.9999%) or more, more preferably, 7N (99.99999%) or more (i.e., the impurity concentration of the oxygen gas or the N₂O gas is preferably 1 ppm or lower, more preferably, 0.1 ppm or lower).

Note that the heat treatment apparatus is not limited to the electric furnace, and for example, may be an RTA (rapid thermal annealing) apparatus such as a GRTA (gas rapid thermal annealing) apparatus or an LRTA (lamp rapid thermal annealing) apparatus. An LRTA apparatus is an apparatus for heating an object to be processed by radiation of light (electromagnetic waves) emitted from a lamp such as a halogen lamp, a metal halide lamp, a xenon arc lamp, a carbon arc lamp, a high pressure sodium lamp, or a high pressure mercury lamp. An LRTA apparatus may be provided with not only a lamp but also a device for heating an object to be processed, using heat conduction or heat radiation from a heating element such as resistance heating element. GRTA is a method for performing heat treatment using a high-temperature gas. As the gas, an inert gas which does not react with an object to be processed due to heat treatment, such as nitrogen or a rare gas such as argon is used. Alternatively, the heat treatment may be performed at 600° C. to 750° C. for several minutes with an RTA method.

Moreover, after the first heat treatment for dehydration or dehydrogenation, heat treatment may be performed at a temperature of greater than or equal to 200° C. and less than or equal to 400° C., preferably, a temperature of greater than or equal to 200° C. and less than or equal to 300° C., under an oxygen gas atmosphere or a N₂O gas atmosphere.

Alternatively, the first heat treatment of the oxide semiconductor layer may be performed on the oxide semiconductor film which has not yet been processed into the island-shaped oxide semiconductor layer. In that case, after the first heat treatment, the substrate is taken out of the heating apparatus and a photolithography process is performed.

Through the above process, an entire region of the oxide semiconductor layer is made to be in an oxygen excess state; thus, the oxide semiconductor layer has higher resistance, that is, the oxide semiconductor layer becomes i-type. Accordingly, an oxide semiconductor layer 382 whose entire region is i-type is formed.

Next, a conductive film is formed over the oxide semiconductor layer 382, and a photolithography process is performed. A resist mask is formed over the conductive film and the conductive film is etched selectively, whereby a source electrode layer 385a and a drain electrode layer 385b are formed. Then, an oxide insulating layer 386 is formed over the second gate insulating layer 372b, the oxide semiconductor layer 382, the source electrode layer 385a, and the drain electrode layer 385b with a sputtering method.

In that case, the oxide insulating layer 386 is preferably formed while removing moisture remaining in the treatment chamber. This is for preventing hydrogen, a hydroxyl group, and moisture from being contained in the oxide semiconductor layer 382 and the oxide insulating layer 386.

In order to remove moisture remaining in the treatment chamber, an entrapment vacuum pump is preferably used. For example, a cryopump, an ion pump, or a titanium sublimation pump is preferably used. Further, an evacuation unit may be a turbo molecular pump provided with a cold trap. In the film formation chamber which is evacuated with the cryopump, a hydrogen atom, a compound containing a hydrogen atom, such as water (H₂O), and the like are removed, whereby the concentration of an impurity contained in the oxide semiconductor layer 386 formed in the film formation chamber can be reduced.

It is preferable to use a high-purity gas from which an impurity such as hydrogen, water, a hydroxyl group, or hydride is removed to a concentration of several ppm or several ppb, as a sputtering gas used when the oxide semiconductor layer 386 is formed.

Through the above steps, the thin film transistor 380 can be formed.

Next, in order to reduce variation in electric characteristics of the thin film transistors, heat treatment (preferably, at a temperature of higher than or equal to 150° C. and lower than 350° C.) may be performed under an inert gas atmosphere such as a nitrogen gas atmosphere. For example, the heat treatment is performed in a nitrogen atmosphere at 250° C. for one hour.

A protective insulating layer 373 is formed over the oxide insulating layer 386. In this embodiment, a silicon nitride film having a thickness of 100 nm is formed as the protective insulating layer 373 with a sputtering method.

The protective insulating layer 373 and the first gate insulating layer 372a each formed using a nitride insulating layer do not contain impurities such as moisture, hydrogen, hydride, and hydroxide and has an effect of blocking entry of these from the outside.

Therefore, in a manufacturing process after formation of the protective insulating layer 373, entry of an impurity such as moisture from the outside can be prevented. Further, even after a device is completed as a semiconductor device having a touch panel, such as a liquid crystal display device, entry of an impurity such as moisture from the outside can be prevented in the long term; therefore, long-term reliability of the device can be achieved.

Further, part of the second gate insulating layer 372b between the first gate insulating layer 372a and the protective insulating layer 373 each formed using a nitride insulating layer may be removed so that the protective insulating layer 373 and the first gate insulating layer 372a are in contact with each other.

Accordingly, impurities such as moisture, hydrogen, hydride, and hydroxide in the oxide semiconductor layer are reduced as much as possible and entry of such impurities is prevented, so that the concentration of impurities in the oxide semiconductor layer can be maintained to be low.

This embodiment can be implemented in appropriate combination with any of the other embodiments.

Thus, with a thin film transistor formed using an oxide semiconductor layer, a large touch panel having stable electric characteristics and high reliability can be provided.

### Embodiment 11

In this embodiment, another example of a thin film transistor which can be applied to a touch panel, which is disclosed in this specification, will be described. A thin film transistor described in this embodiment can be applied to the thin film transistor in any of Embodiments 1 to 10.

In this embodiment, an example of using a conductive material having a light-transmitting property for a gate electrode layer, a source electrode layer, and a drain electrode layer will be described. Therefore, part of this embodiment can be performed in a manner similar to that of the above embodiments, and repetitive description of the same portions as or portions having functions similar to those in the above embodiments and steps for manufacturing such portions will be omitted. In addition, detailed description of the same portions is not repeated.

For example, materials of the gate electrode layer, the source electrode layer, and the drain electrode layer can be a conductive material that transmits visible light, and any of the following metal oxides can be applied for example: an In—Sn—O-based metal oxide, an In—Sn—Zn—O-based metal oxide; an In—Al—Zn—O-based metal oxide; a Sn—Ga—Zn—O-based metal oxide; an Al—Ga—Zn—O-based metal oxide; a Sn—Al—Zn—O-based metal oxide; an In—Zn—O-based metal oxide; a Sn—Zn—O-based metal oxide; an Al—Zn—O-based metal oxide; an In—O-based metal oxide; a Sn—O-based metal oxide; and a Zn—O-based metal oxide. The thickness thereof can be set in the range of greater than or equal to 50 nm and less than or equal to 300 nm, as appropriate. As a film formation method of the metal oxide used for the gate electrode layer, the source electrode layer, and the drain electrode layer, a sputtering method, a vacuum evaporation method (an electron beam evaporation method or the like), an arc discharge ion plating method, or a spray method is used. When a sputtering method is employed, film formation may be performed using a target including SiO₂ at a concentration of greater than or equal to 2 wt % and less than or equal to 10 wt %.

Note that the unit of the percentage of components in a conductive film having a light-transmitting property with respect to visible light is atomic percent, and the percentage of components is evaluated by analysis using an electron probe X-ray microanalyzer (EPMA).

In a pixel provided with a thin film transistor, when a pixel electrode layer, another electrode layer (such as a capacitor electrode layer), or another wiring layer (such as a capacitor wiring layer) is formed using the conductive film having a light-transmitting property with respect to visible light, a display device having high aperture ratio can be realized. Needless to say, it is preferable that a gate insulating layer, an oxide insulating layer, a protective insulating layer, and a planarization insulating layer in the pixel be also each formed using a conductive film that transmits visible light.

In this specification, a film having a light-transmitting property with respect to visible light means a film having such a thickness as to have transmittance of visible light between 75% and 100%. In the case where the film has conductivity, the film is also referred to as a transparent conductive film. Further, a conductive film which is semi-transmissive with respect to visible light may be used for metal oxide applied to the gate electrode layer, the source electrode layer, the drain electrode layer, the pixel electrode layer, another electrode layer, or another wiring layer. The conductive film which is semi-transmissive with respect to visible light indicates a film having transmittance of visible light between 50% and 75%.

When a thin film transistor has a light-transmitting property, the aperture ratio can be increased because light is transmitted even when the thin film transistor is provided so as to overlap with a display region or a photosensor and thus display or detection of light is not interfered. In addition, by using a film having a light-transmitting property for components of a thin film transistor, a high aperture ratio can be achieved even when one pixel is divided into a plurality of sub-pixels in order to realize a wide viewing angle. That is, a high aperture ratio can be maintained even when a group of high-density thin film transistors is provided, so that a sufficient area of a display region can be secured. For example, in the case where one pixel includes two to four sub-pixels, an aperture ratio can be improved because the thin film transistor has a light-transmitting property. Further, when a storage capacitor is formed using the same steps and the same materials as the component of the thin film transistor, the storage capacitor can also have a light-transmitting property; therefore, the aperture ratio can be further increased.

This embodiment can be implemented in appropriate combination with any of the other embodiments.

### Embodiment 12

In this embodiment, an example of a thin film transistor which can be applied to the touch panel disclosed in this specification will be described. A thin film transistor 650 in this embodiment can be used as the thin film transistor formed using an oxide semiconductor layer including a channel formation region in any of the above embodiments (e.g. the transistors 201, 205, 206, and 301 in Embodiment 1, and the transistors 503 and 540 in Embodiments 2 and 3).

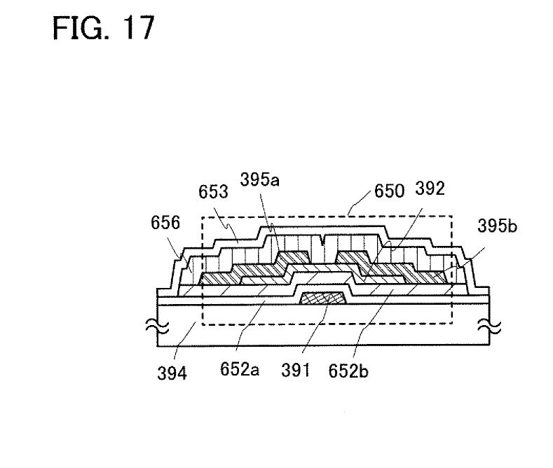

In this embodiment, an example in which an oxide semiconductor layer is surrounded by a nitride insulating film when seen in a cross section thereof will be shown with reference to FIG. 17. Since FIG. 17 is the same as FIGS. 12A to 12E except that there is differences in the top surface shape and the position of the end portion of an oxide insulating layer and in the structure of a gate insulating layer, common reference numerals are used for the same portions, and detailed description of the same portions is omitted.

The thin film transistor 650 illustrated in FIG. 17 is a bottom-gate thin film transistor, and includes, over a substrate 394 having an insulating surface, a gate electrode layer 391, a gate insulating layer 652a which is formed using a nitride insulating layer, a gate insulating layer 652b which is formed using an oxide insulating layer, an oxide semiconductor layer 392, a source electrode layer 395a, and a drain electrode layer 395b. Further, an oxide insulating layer 656 which covers the thin film transistor 650 and is stacked over the oxide semiconductor layer 392 is provided. Further, a protective insulating layer 653 which is formed using a nitride insulating layer is provided over the oxide insulating layer 656. The protective insulating layer 653 is in contact with the gate insulating layer 652a which is formed using a nitride insulating layer.

In the thin film transistor 650 in this embodiment, the gate insulating layer has a stacked structure in which the nitride insulating layer and the oxide insulating layer are stacked over the gate electrode layer. Further, before the protective insulating layer 653 which is formed using a nitride insulating layer is formed, the oxide insulating layer 656 and the gate insulating layer 652b are selectively removed to expose the gate insulating layer 652a which is formed using a nitride insulating layer.

At least the top surface of the oxide insulating layer 656 and the gate insulating layer 652b are larger than the top surface of the oxide semiconductor layer 392, and the top surface shapes of the oxide insulating layer 656 and the gate insulating layer 652b preferably covers the thin film transistor 650.

Further, the protective insulating layer 653 which is formed using a nitride insulating layer covers the top surface of the oxide insulating layer 656 and the side surfaces of the oxide insulating layer 656 and the gate insulating layer 652b, and is in contact with the gate insulating layer 652a which is formed using a nitride insulating layer.

For the protective insulating layer 653 and the gate insulating layer 652a which are each formed using a nitride insulating layer, an inorganic insulating film which does not contain impurities such as moisture, a hydrogen ion, and OH⁻ and blocks entry of the impurities from the outside is used: for example, a silicon nitride film, a silicon oxynitride film, an aluminum nitride film, or an aluminum oxynitride film obtained with a sputtering method or a plasma CVD method is used.

In this embodiment, as the protective insulating layer 653 which is formed using a nitride insulating layer, a silicon nitride layer having a thickness of 100 nm is provided with an RF sputtering method so as to cover the bottom surface, the top surface, and the side surface of the oxide semiconductor layer 392.

With the structure illustrated in FIG. 17, an impurity such as hydrogen, moisture, hydroxyl, or hydride in the oxide semiconductor layer is reduced due to the gate insulating layer 652b and the oxide insulating layer 656 which are provided to surround and be in contact with the oxide semiconductor layer, and entry of moisture from the outside in a manufacturing process after formation of the protective insulating layer 653 can be prevented because the oxide semiconductor layer is surrounded by the gate insulating layer 652a and the protective insulating layer 653 which are each formed using a nitride insulating layer. Further, even after a device is completed as a touch panel, such as a display device, entry of an impurity such as moisture from the outside can be prevented in the long term; therefore, long-term reliability of the device can be achieved.

In this embodiment, one thin film transistor is covered with a nitride insulating layer; however, an embodiment of the present invention is not limited to this structure. Alternatively, a plurality of thin film transistors may be covered with a nitride insulating layer, or a plurality of thin film transistors in a pixel portion may be collectively covered with a nitride insulating layer. A region where the protective insulating layer 653 and the gate insulating layer 652a are in contact with each other may be formed so that at least the pixel portion of the active matrix substrate is surrounded.

This embodiment can be implemented in appropriate combination with any of the other embodiments.

The present application is based on Japanese Patent Application serial No. 2009-255461 filed with the Japan Patent Office on Nov. 6, 2009, the entire contents of which are hereby incorporated by reference.

1. A touch panel comprising;
a pixel comprising a display element and a photosensor,
wherein the photosensor comprises a photodiode and a first transistor which are electrically connected to each other, and
wherein the first transistor comprises an oxide semiconductor layer in which a channel formation region is formed.

2. The touch panel according to claim 1,
wherein the photosensor further comprises a second transistor,
wherein the photodiode is electrically connected to a gate of the first transistor,
wherein a first terminal of the first transistor is electrically connected to a first terminal of the second transistor, and
wherein the second transistor comprises an oxide semiconductor layer in which a channel formation region is formed.

3. The touch panel according to claim 1,
wherein the oxide semiconductor layer of the first transistor contains indium, gallium, and zinc.

4. The touch panel according to claim 2,
wherein the oxide semiconductor layer of the second transistor contains indium, gallium, and zinc.

5. The touch panel according to claim 1,
wherein a hydrogen concentration of the oxide semiconductor layer of the first transistor is less than or equal to 5×10¹⁹/cm³.

6. The touch panel according to claim 2,
wherein a hydrogen concentration of the oxide semiconductor layer of the second transistor is less than or equal to 5×10¹⁹/cm³.

7. The touch panel according to claim 1,
wherein the display element is selected from a liquid crystal element and a light emitting diode.

8. The touch panel according to claim 2,
wherein the photosensor further comprises:
a first signal line;
a second signal line;
a third signal line; and
a fourth signal line,
wherein the first signal line is electrically connected to the photodiode,
wherein the second signal line is electrically connected to a second terminal of the second transistor,
wherein the third signal line is electrically connected to a gate of the second transistor, and
wherein the fourth signal line is electrically connected to a second terminal of the first transistor.

9. A driving method of a touch panel comprising a plurality of pixels,
wherein the plurality of pixels are arranged in a matrix form having a plurality of rows,
wherein at least one of the plurality of pixels comprises a display element and a photosensor,
wherein the photosensor comprises a photodiode and a first transistor which are electrically connected to each other, and
wherein the first transistor comprises an oxide semiconductor layer in which a channel formation region is formed,
the driving method comprising a step of performing a reset operation, an accumulating operation, and a selection operation in that order for each of the plurality of rows,
wherein the reset operation of one of the plurality of rows and the selection operation of another one of the plurality of rows are performed simultaneously.

10. The driving method according to claim 9,
wherein the oxide semiconductor layer of the first transistor contains indium, gallium, and zinc.

11. The driving method according to claim 9,
wherein the photodiode is electrically connected to a gate of the first transistor,
wherein the photosensor further comprises:
a first signal line electrically connected to the photodiode;
a second transistor whose first terminal is electrically connected to a first terminal of the first transistor; and
a second signal line electrically connected to a second terminal of the second transistor,
wherein the second transistor comprises an oxide semiconductor layer, in which a channel formation region is formed, and
wherein the reset operation includes the steps of:
setting a potential of the first signal line to a first potential so that a forward bias is applied to the photodiode, and
precharging the second signal line.

12. The driving method according to claim 11,
wherein the oxide semiconductor layer of the second transistor contains indium, gallium, and zinc.

13. The driving method according to claim 11,
wherein the accumulating operation includes a step of setting the potential of the first signal line to a second potential to allow a potential of the gate of the first transistor to be decreased.

14. The driving method according to claim 11,
wherein the photosensor further comprises a third signal line electrically connected to a gate of the second transistor,
wherein the selection operation includes a step of setting a potential of the third signal line to a third potential so that the second transistor exists in a conduction state, which is followed by a step of setting the potential of the third signal line to a fourth potential so that the second transistor exists in an off state.

15. The driving method according to claim 9,
wherein a hydrogen concentration of the oxide semiconductor layer of the first transistor is less than or equal to 5×10¹⁹/cm³.

16. The driving method according to claim 11,
wherein a hydrogen concentration of the oxide semiconductor layer of the second transistor is less than or equal to 5×10¹⁹/cm³.

17. The driving method according to claim 9,
wherein the display element is selected from a liquid crystal element and a light emitting diode.

18. A driving method of a touch panel comprising a plurality of pixels,
wherein the plurality of pixels are arranged in a matrix form having first to n^{th} rows where n is a natural number larger than 2,
wherein at least one of the plurality of pixels comprises a display element and a photosensor,
wherein the photosensor comprises a photodiode and a first transistor which are electrically connected to each other, and
wherein the first transistor comprises an oxide semiconductor layer in which a channel formation region is formed,
the driving method comprising a step of performing a reset operation, an accumulating operation, and a selection operation in that order for each of the first to n^{th} rows,
wherein, in a period between an end of the reset operation of the m^{th} row and a start of the sequential reset operation of the (m+1)th row, the selection operation of another one of the first to n^{th} rows is performed, and
wherein m is a natural number less than n.

19. The driving method according to claim 18,
wherein the oxide semiconductor layer of the first transistor contains indium, gallium, and zinc.

20. The driving method according to claim 18,
wherein the photodiode is electrically connected to a gate of the first transistor,
wherein the photosensor further comprises:
a first signal line electrically connected to the photodiode;
a second transistor whose first terminal is electrically connected to a first terminal of the first transistor; and
a second signal line electrically connected to a second terminal of the second transistor,
wherein the second transistor comprises an oxide semiconductor layer in which a channel formation region is formed, and
wherein the reset operation includes the steps of:
setting a potential of the first signal line to a first potential so that a forward bias is applied to the photodiode, and
precharging the second signal line.

21. The driving method according to claim 20,
wherein the oxide semiconductor layer of the second transistor contains indium, gallium, and zinc.

22. The driving method according to claim 20,
wherein the accumulating operation includes a step of setting the potential of the first signal line to a second potential to allow a potential of the gate of the first transistor to be decreased.

23. The driving method according to claim 20,
wherein the photosensor further comprises a third signal line electrically connected to a gate of the second transistor,
wherein the selection operation includes a step of setting a potential of the third signal line to a third potential so that the second transistor exists in a conduction state, which is followed by a step of setting the potential of the third signal line to a fourth potential so that the second transistor exists in an off state.

24. The driving method according to claim 18,
wherein a hydrogen concentration of the oxide semiconductor layer of the first transistor is less than or equal to 5×10¹⁹/cm³.

25. The driving method according to claim 20,
wherein a hydrogen concentration of the oxide semiconductor layer of the second transistor is less than or equal to 5×10¹⁹/cm³.

26. The driving method according to claim 18,
wherein the display element is selected from a liquid crystal element and a light emitting diode.
